(19) United States
(12) Patent Application Publication
(10) Pub. No.: US 2017/0032016 A1
(43) Pub. Date: Feb. 2, 2017

(54) REAL-TIME INFORMATION SYSTEMS AND METHODOLOGY BASED ON CONTINUOUS HOMOMORPHIC PROCESSING IN LINEAR INFORMATION SPACES

(71) Applicant: SYSTEMA Systementwicklung Dip. -inf. Manfred Austen GmbH, Dresden (DE)

(72) Inventors: Martin Zinner, Dresden (DE); Gerhard Luhn, Radebeul (DE); Michael Ertelt, Dresden (DE); Manfred Austen, Klipphausen (DE)

(21) Appl. No.: 15/124,256

(22) PCT Filed: Jun. 13, 2014
(86) PCT No.: PCT/EP2014/062373

§ 371 Date: Sep. 7, 2016

Related U.S. Application Data
(60) Provisional application No. 61/949,429, filed on Mar. 7, 2014.

(51) Int. Cl. G06F 17/30

(52) U.S. Cl. CPC G06F 17/30592

(57) ABSTRACT

The present invention relates to the field of information system technology. More particularly, the present invention relates to methods and systems for Real-Time information processing, including Real-Time Data Warehousing, using Real-Time in-formation aggregation (including calculation of the performance indicators and the like) based on continuous homomorphic processing, thus preserving the linearity of the underlying structures. The present invention further relates to a computer program product adapted to perform the method of the invention, to a computer-readable storage medium comprising said computer program product and a data processing system, which enables Real-Time information processing according to the methods of the invention.

### FIELD OF THE INVENTION

The present invention relates to the field of information system technology. More particularly, the present invention relates to methods and systems for Real-Time information processing, including Real-Time Data Warehousing, using Real-Time information aggregation (including calculation of the performance indicators and the like) based on continuous homomorphic processing, thus preserving the linearity of the underlying structures.

### BACKGROUND OF THE INVENTION

Within the last decade, the usage of computers and computing systems has evolved towards an ubiquitous computing paradigm, while the volume of data is dramatically increasing every year (towards the so-called “Big Data”). This leads, with growing intensity, to a major requirement of having Real-Time access to up-to-date business information on multiple hierarchical levels, i.e. strategic, tactical and operational level (Thiele et al., 2009; Santos et al., 2008). Real-Time systems should respond within strict time constrains to any interrogation or demand for information. Furthermore, the user requests also additional and/or enriched functionalities to actively influence all ongoing processes (business processes, industrial processes and the like). Thus, there exists an overall tendency, that such Real-Time capability is becoming a critical requirement. People may require access to up-to-date flight plans through their hand-helds, to select and book flights immediately. Or they may require immediate access to the state of their business, including drill down capability on multiple hierarchical levels; and including the capability for ad-hoc request of up-to-date data in Real Time under various aggregation levels and views, which can be agreed and defined spontaneously. Additionally, the system should respond in Real Time; that is, if the deadline to respond is not met, the business process may be degraded or may even get transformed into a critical state.

Real-Time

Within the state of the art of the production technology and methodology, manufacturing systems tend towards fully automated production systems. This has led and still leads to an ever-growing amount of data, which gets collected during the manufacturing process. Control systems and methods use this information as input in order to setup, to monitor, and to steer the business and the production process. The state of the art in computer integrated manufacturing (CIM) is currently given by the integration of enterprise resource planning (ERP) and manufacturing execution systems (MES), and may include other modules like advanced process control/statistical process control (APC/SPC), equipment integration (EI), and others. This integration aspect demands by its own evidence, the capability to combine data of different hierarchical levels (i.e. strategic/planning, tactical and operational level) and different data sources in different and flexible aggregation views in order to present competitive and important information to different kinds of decision makers, executors, and the like. The aim is to guarantee and to improve the quality and timeliness of different kinds of processes (i.e. business process, production process, and the like). Nowadays, the terminus technicus “Business Intelligence” serves to identify such systems and methods.

Many attempts have been made to support Real-Time data aggregation in different application domains. But all those attempts are restricted to single application domains, and are of restricted performance and flexibility. Exemplary attempts are disclosed for example in US 2012/0290594, US 2005/0071320, US 2004/0059701, US 2011/0227754, U.S. Pat. No. 7,558,784, US20040059701, and US 20110166912.

Consequently, further aggregation on corporate business level of different data sources is required, generating an ever growing amount of aggregation processes in order to support the managerial decision process and numerous other business related activities from or within a highly integrative, flexible and performant perspective. Such summarized and compressed data are typically calculated through aggregation mechanisms provided by Data Warehouse architectures and systems. Such data may be aggregated automatically for example based on timely scheduled aggregation jobs. Additionally, there is a growing demand for ad-hocly requested Real-Time aggregation.

Moreover, such aggregated data support monitoring functionalities regarding the business processes, production process, financial process or other processes. As business processes may change or evolve, there is a need to provide and enable flexible, Real-Time information aggregation, namely including ad-hocly defined aggregates, comparisons, relationships and multi-hierarchical aggregation levels, from and/or including multiple data sources. These data may also be used as a direct input in terms of additional control parameters or structural evolvement of the overall system. Such kinds of activities may take place in business intelligence (BI) systems, which may be used to guide and to improve the decision making process at all levels, strategic, tactical and operational (Coman, Duica, Radu, & Stefan, 2010). For example,—based on Real-Time aggregated information about the state of the business and production process, including customer oriented inputs—existing rules for dispatching and/or scheduling might require a Real-Time update. This may include re-routing, re-specification, re-grouping, re-pricing activities regarding desired products and materials. The same applies for financial processes or informational aggregation functions in the financial sector or any other business oriented process.

There is a need to reduce the huge amount of raw data (typically through aggregation) and to represent the actual state of the production or business process with regard to all different kinds of levels through the usage of performance indicators, or other kinds of measures.

Within the last years a number of attempts have been made in order to support the definition and storage of KPI data in different kind of systems. Centralized databases and frameworks may support such process (U.S. Pat. No. 7,716,253 B2, Microsoft).

Other, more specific systems and methods support the evaluation of KPIs in a manufacturing execution system (MES) (US2010/0249978 A1, Siemens). In this case, a plant performance analyzer tool for calculating the key production indicators on the plant floor equipment is executed. Still other inventions are related to a “method for providing a plurality of aggregated KPI-values of a plurality of different KPIs to one or more views of a client processing device” (Patent EP 2487869 A1).

Definitions

A “business process” or “industrial process” consists of a structured, measured set of activities designed to produce a specific output for a particular customer or market (Davenport, 1993). Business processes are made of a sequence of activities with interleaving decision points; each activity may be further decomposed into unit or atomic activities. For example, the production process of a product is subdivided into a series of single and interlinked atomic process steps. Any such atomic activity creates the fundament for any further aggregation of information concerning the current state of the business process or industrial process. Typically, there is a distinction made between three types of business processes:
(i) management processes, which govern the operation of a system and which are quantified by corporate Key Performance Indicators (KPIs) (for example: aggregation of all produced goods of a time period, its costs and revenues);
(ii) operational processes, which create the primary value stream (operational KPIs; for example: the production process, the purchase process, etc.); and
(iii) supporting processes (supporting KPIs; for example technical support, recruitment, etc.).

Within “business intelligence (BI) systems”, an industrial KPI is a measurement of how well the industrial process (i.e. an operational activity that is critical for the current and future success of that organization) performs within the organization (Peng, 2008).

As used throughout the specification and claims of the present invention, a “performance indicator” (including “key performance indicators”) will be used synonymously to an embodiment of an “Information Function” as further described below. Such Information Functions are providing the desired information on the higher aggregational level. Accordingly, any performance indicator is an interpretation of the defined Information Function with regard to any business and its structure, targets, and goals.

Typically, “performance indicators” and the like are defined—as embodiments of Information Functions—on sets with regard to following dimensions or fields of application: metric information, ordinal information, cardinal information (Müller-Merbach, 2001).

“Metric information” is defined through numerical values and corresponding mathematical function; for example: length measured in mm; time measured in sec, weight measured in kg, money measured in $.

“Ordinal information” is defined in terms of a finite number of ordinals by a first order formula; example: a set of chairs, whereas the chairs are ordered by their selling price (another ordering could be the production cost).

“Cardinal information” is typically defined as the number of elements of a set; for example the number of chairs.

All “performance indicators” and the like are defined as embodiments of specific Information Functions on properties of sets. In the prior art, these Information Functions are typically called “aggregate functions”. The “performance indicators” and the like may also include statistical function, for example the mean price of the chairs. Accordingly, the present invention also pertains to a system and method for statistical functions.

As an example, an “Information Function” may be defined as the cardinality (number of elements) of a set; this performance indicator may represent, within the context of this example, the numbers of customers in a waiting queue, etc.

A “key performance indicator (KPI)” is a measure of performance, commonly used to help an organization define and evaluate how successful it is, typically in terms of making progress towards its long-term organizational goals (Rafal Los, 2011). Key performance indicators provide consciously, aggregated information about the complex reality regarding economic issues, which can be expressed numerically (Weber, J., 1999).

Let X be finite set, let P(X) be the set of all subsets of X, let R be the set of the real numbers and let nihil ∉ R. Generally, measurement (from Old French, mesurement) is the assignment of numbers to objects or events. Accordingly, a measure of performance is a function F from P(X) into R∪{nihil}. Usually F({Ø})=nihil or F({Ø})=0, but there are no restrictions regarding the value of F({Ø}).

Furthermore, a key performance indicator is characterized in terms of name, definition, and calculation (http://www.aicpa.org/interestareas/frc/accountingfinancialreporting/enhancedbusinessreporting/downloadabledocuments/industry%20key%20performance%20indicators.pdf; retrieved Nov. 5, 2013), for example:
Name: Target Market Index
Definition: Target Market Index reflects the organization's decision regarding the size and growth definition rates of the markets it participates in.
Calculation: Target Market Index=Relative Market Size*(1+Relative Market Growth Rate)

KPIs vary between companies and industries, depending on their priorities or performance criteria. KPIs are sometimes also referred to as “key success indicators (KSI)”. KPIs serve to reduce the complex nature of organizational performance to a small number of key indicators in order to make performance more understandable. KPIs and the like should enable decisions about important facts and states, should be quantifiable and should represent simple as well as complex processes in an easily understandable manner. Goal is that the customer uses those inputs in order to gather an extensive and comprehensive overview. In order to be evaluated, KPIs are linked to target values, so that the value of the measure can be assessed as meeting expectation or not.

Many different surveys and performance indicators for further control, evaluation and management of business processes, manufacturing processes, financial processes, and the like can be found in literature, industrial documentation—including company-specific definitions of performance indicators, including also products which support the definition and management of performance indicators in information systems—and also in national and international standards, patent applications, and the like. Performance indicators may also be interrelated, for example financial and non-financial performance reporting. A common industrial definition is provided by the international standard ANSI/ISA-95 (Enterprise-Control System Integration), and IEC 62264, respectively; another example is ISO/DIS 22400-2 (Automation Systems and Integration—Key Performance Indicators for Manufacturing Operations Management). In the field of manufacturing industry (semiconductor manufacturing) standards are defined by the SEMI organization (Semiconductor Equipment and Materials International). Examples for standards are SEMI E10-0304 (Specification for Definition and Measurement of Equipment Reliability, Availability, and Maintainability); SEMI E105-0701 (Provisional Specification for CIM Framework Scheduling Component); SEMI E124-1107 (Guide for Definition and Calculation of Overall Factory Efficiency (OFE) and Other Associated Factory-Level Productivity Metrics). Examples from literature include Hopp and Spearman (2001), Pinedo (2008).

Within the common industrial and business areas (i) absolute KPIs and (ii) relative KPIs can be distinguished.

“Absolute KPIs” represent single measuring parameters (for example stock value, temperature value, cycle time); sums, differences or averages of these single parameters and other similar mathematical functions.

“Relative KPIs” represent a part of a single measure in comparison to the whole (for example part of the stock in comparison to the entire stock); relations between different parameters and/or dimensions (for example transport costs of a part in relation to the product or product group); index numbers (similar, but timely varying parameters are put into relationship to a base value; for example the stock value at time t₁ in relation to the stock value at time t₂).

Within the context of the present invention, the more general meaning of the terminus technicus “isomorphism” (as used in logic, philosophy, and information theory) will be broken down into the specific concepts—homomorphism and isomorphism in terms of mathematical definitions as further specified herein.

“Continuous”, as used throughout the specification and claims of the present invention, declares that all information required to be analyzed, will be captured and processed as soon as it is created (for example an event, which includes the up-to-date value of the cycle time of a process step, which has been executed on an equipment, or an event, which updates the sales and revenues of a sales district; such values can be required for further aggregation).

“Homomorphic” as used herein means that there exists a structure-preserving linear map (bijective map for isomorphism); which preserves the linearity of the underlying informational structures (“linear informational framework”).

“Isomorphic” as used herein stands accordingly for the existence of a structure-immanent and unique relationship (i.e. mapping) between any production model, or business model and corresponding components within the information system and/or Data Warehouse.

In general, a “set of objects” as used herein is specified by certain properties or attributes of such objects. Sets of objects are for example a set of chairs; a set of brown objects; a set of wooden objects, etc. The elements of such sets have identical properties (attributes), whereas any such property holds a well-defined value, which is based on the structure of such property; examples: length of each leg of a chair; specific measure of the brownness of an object; chemical or biological characterization of the wood of an object. Such elements may also represent processes, like business processes, purchasing processes, and financial processes, but not restricted to the enumeration above. Additional examples for such elements may be: the set of all production steps of a specific product; the set of all production steps of a group of products; a set of products, etc. Sets may also be hierarchically organized as sets of sets, etc., for example: a set of products, which may belong to another set of product groups, which may belong to another set of a technology, etc.

“Knowledge discovery” is understood as the flexible, multi-hierarchical creation of new sets, including the definition of the Information Functions on such newly created sets.

“Ontological and physical foundation” of the present invention is defined by a core model, which is called “information model” and which is based on the analysis of the immanent relationship between the structure of the objects of the real-world system and the corresponding model. This analysis provides the deep structure of the information system of the present invention, whereas this analysis results in the herein described multi-level model and corresponding foundational ontology. The deep structure of an information system comprises those properties that manifest the meaning of the real-world system that the information system is intended to model (Wand and Weber, 1995). With regard to business analysis and knowledge engineering, models have to be as precise as possible and easy-to-understand at the same time (Atkinson et al., 2006). Nowadays, there is a main focus on the growth of data volumes and data sources, etc. Accordingly, in view of “big data” and “ubiquitous computing”, the analysis of the deep structure of information systems is gaining importance.

An “ad-hoc query” (ad hoc is Latin for “for this purpose”) is an unplanned, improvised, on-the-fly interrogation responding to spur-of-the-moment requirements, which has not yet been issued to the system before. It is created in order to get a new kind of information out of the system.

The terms “algorithmic efficiency” and “algorithmic performance” identify a detailed analysis of algorithms, which relate to the amount of system resources used by those algorithms. It is understood that the efficiency of algorithms relates to one of the most important research fields in computer science (Gal-Ezer, 2004). It is also understood that algorithmic concepts are lying at the heart of the computing strategies and represent the scope of computing in a more general way. In practice, it is distinguished between two main aspects of algorithmic efficiency: (i) computational time and (ii) storage space (it is also understood that those topics relate to each other and those relationships have to be laid down as well). Computational time efficiency is typically measured by the number of significant operations carried out during execution of the algorithm. It has to be noted that prior art systems may have calculated performance indicators in a mathematically correct manner. But as aforementioned, such algorithms are inefficiently designed and are not implemented within a more overall perspective and scope.

Through the specification and claims of the present invention, the term “aggregation” and “pre-aggregation” (from Latin aggregare meaning to join together or group) shall be understood as the process (drill up) of the composition of more individual data (with lower level of granularity), enhanced by additional attributes to data with higher level of granularity. This is the process of consolidating one or more data values into a single value. The data can then be referred to as aggregate data. Aggregation is synonymous with summarization and aggregated data is synonymous with summary data.

A “Data Warehouse” is a secondary data storage system, i.e. data is loaded from primary storage systems (OLTP-systems and the like) into the Data Warehouse (typically done by ETL procedures). Within the context of the present invention, the datasets as generated by such ETL procedures are called basic atomic datasets (BADSs). The basic atomic datasets contain all the information necessary for reporting and data mining, they refer to the lowest level of granularity required for effective decision making and knowledge discovery in databases. In contrast to basic atomic datasets, the fundamental atomic datasets (FADSs) contain summarized information from a well-defined subset of the basic atomic datasets which are regarded as an entity (transaction) from the relevant processing/reporting point of view (including ad-hoc analysis and data mining/knowledge discovery in databases).

In temporal databases, “temporal grouping” is performed over partitions of the time line, and aggregation is performed over those groups. In general, temporal grouping is done by two types of grouping, span grouping and instant grouping. Span grouping is based on a defined length in time, such as working shifts, days, weeks, etc. On the other hand, instant grouping is performed over chronons i.e. the time line is partitioned into instants/chronons. A special case of span grouping is the “moving window” grouping where the difference between the upper and lower bound of the partition considered is fix (for example always grouping over the last eight hours or seven days, etc.). Aggregations performed on span and instant groupings are called span (“moving window”) aggregations and instant aggregations, respectively. Instant temporal aggregation computes an aggregate at each point in time.

“Large-scale aggregation” is meant to be the computation where the proposed algorithms deal with data that is substantially larger than the size of the available memory. On the other hand, “small-case aggregation” is performed entirely in memory.

It should be noted that the present invention is not limited to temporal aggregations. In effect, the present invention can be applied to any aggregation whatsoever, using any linear Information Function. Non-temporal aggregates do not have a primary timely attribute, for example the bill of material. Typically, a bill of material contains information about all parts, which are required to manufacture a product (including additional materials, like consumables, etc.). For such kinds of aggregations, other, typically non-temporal categories are used, for example versions, types, manufacturer, employees, and the like. Nevertheless, it may be assumed that temporal aggregations represent the most important type of aggregation in complexity as well as volume usage in Data Warehouses, because they map to the temporality of the production/business processes.

### SUMMARY OF THE INVENTION

The present invention is grounded on a basic information model. Given are different kind of objects or processes (like business processes, financial processes, engineering processes), which are characterized through specific and well defined figures. Typically, such figures are given as performance indicators, engineering measurements (for example: physical measurements (within semiconductor industry termed inline-data), functional measurements (within semiconductor industry termed test-data), derived measures (example from the semiconductor industry: yield)), or logical associations/attributions in a most general and abstract sense (including financial and/or business related figures, like return of invest, financial forecasting etc.). It is within the scope of the present invention that any such figure will be embodied throughout most generic Information Functions. These generic Information Functions will be specified in more detail with regard to the desired operation which needs to be performed (i.e. engineering measurements, aggregation of values required for performance indicators, logical values with regard to specific definitions, for example the logical state of an equipment (“unscheduled down”), of a lot, a (sub-)product (“on hold”); in general: of all kinds of material parts (product parts, equipment parts etc.) and/or processes and sub-processes (business processes, physical processes in production, equipment, etc.) and many other such contributions, including combinations of the like. (see FIG. 2)

In more detail, any such Information Function delivers the desired information in a most effective and advantageous manner, because those Information Functions are based on a systematic and structural analysis of the entire problem domain, unblocking existing barriers in order to enable and realize such Information Functions under newly developed, immanent Real-Time characteristics. The problem domain is to be described as the disposability of any information (in a most general logical, qualitative and quantitative sense) in order to monitor, supervise, and qualify any kind of industrial/business/financial process, including any kind of information required as further inputs to steer, control, drive and optimize such processes. It is outside of the primary scope of the present invention to deal with new kinds of control or analysis of specific processes (like specific factory control rules, or specific material dispatching strategies). The spirit of the present invention captures the inherent structure of any such process in a new and most advantageous manner, which is based on a proved minimal and redundancy-free description of the fundamental model to guarantee best overall performance and Real-Time behavior of the overall systems and solutions. This overall system and methodology is grounded on the provision of the envisaged calculation, which defines the desired Information Function, and which further embodies any figure as introduced above.

Common methods of Data Warehousing will be replaced by a through-going, consistent and most effective methodology and system of inherently structured and mathematically justified Real-Time information systems.

Let S and V be arbitrary sets. The set V may include the real numbers, logical states (“true”, “false”, “valid”, “running”, “error”, etc.), equipment states (like “up”, “down”, etc.), but not restricted to the enumeration above.

From a mathematical point of view an Information Function I is a function defined on S with values in V.

I:S→V

Let s ∈ S and v ∈ V elements of S and V, respectively. There are no restrictions regarding the definition of S or V. As a remark, any element of a set is also a set within the usual mathematical sense. Any groupings of elements (i.e. subsets) are also sets. In FIG. 2, elements s ∈ S are called data values, elements v ∈ V are called measures, and the correspondence between elements s ∈ S and elements v ∈ V are defined via appropriate Information Functions.

Such sets and elements are to be managed and operated by known embodiments. One preferred embodiment is made of computing systems (hardware) and preferred operating systems, database systems middleware systems (communication systems) and/or other systems capable to manage and operate sets and elements). It is within the core competence of the preferred embodiments to define, access, store, update, and delete any element s ∈ S and v ∈ V of any sets S, V, including the property to define and operate any kinds of groupings of such elements, and/or sets, respectively. Within the spirit of the present invention, the appropriate sets will be defined in terms of an optimal mapping to the proposed embodiment. This will be shown in all detail herein.

The desired Information Function maps any element s ∈ S into an element v ∈ V. One preferred embodiment is made of data base systems, and corresponding data mappings (examples are database query languages, like SQL, but not restricted to). There are no limitations with regard to use or to build any kind of system, which is capable to define, execute and manage the desired mappings. A specific intention of the present intention is given to a most generic and optimal processing of information. Given this, an intrinsically new and consequently thoroughgoing methodology has been developed. Given this, very heterogeneous and diverse looking methods—as used within prior art—are replaced and newly designed on a new level of abstraction, providing the required framework in order to design and realize any required information processing task within a new, uniform, straightforward, simplified and intrinsically optimized most generic functions, based on a unified structure. Those functions are termed Information Functions, which will be designed in a most advantageous manner in order to provide any kind of information which could be required.

Given these foundations, the methodology of the present invention will define systems in a most advantageous manner, such that those systems will operate with best characteristics in a strictly mathematical sense, and with maximum performance, reliability, effectiveness and maintainability in a practical sense, including preferred embodiments.

The present invention relates to a novel Real-Time information system and method for the calculation, storage and retrieval of performance indicators and the like, based on fundamental data structures and associated computational rules (linear information framework containing linear information spaces and linear Information Functions) using newly defined continuous Real-Time transformation and aggregation methodology, while enabling structure-inherent design principles for Data Warehousing and the like in order to provide Real-Time data analysis (including ad-hoc reporting and knowledge discovery in databases). As a consequence of the new structure-inherent design principles, the envisaged embodiments can be optimized in a most advantageous and fundamental manner (including parallelization and load reduction), resulting in significant reduction of energy consumption, and enabling Real-Time capability of the system and method. The system and method of the invention are built on the principles of continuous homomorphic processing. Embodiments of the present invention include Real-Time and energy-efficient processing of information with regard to a given linear information framework on von Neumann computing architectures and systems. The present invention supports a paradigm shift from a more subjectively oriented kind of “artwork strategy” in software engineering towards an objectively grounded methodological approach, which is capable to deliver objectively-anchored best solutions to customers.

The fundaments of the methodology according to the invention are based on continuous Real-Time aggregation and calculation of the linear Information Functions materialized by performance indicators and the like. The present invention thus supports and preludes a paradigm shift in the fundamental design of information systems towards structure-immanent, highly effective, straightforward, performant, and at the same time energy-efficient mechanisms, systems and methods, supported by appropriate embodiments and deployments.

The impetus for such a paradigm shift is based on the aforementioned new approach delivering a significant reduction, i.e. of order of magnitude, of the complexity and sophisticatedness of prior art systems. The fundamentals of the invention are achieved through continuous Real-Time homomorphic processing, grounded on a fundamental decompositional base model. As a result of the application of structure inherent properties, Real-Time Data Warehousing (including Real-Time information aggregation) will be achieved. Consequentely, this refutes and contradicts the general prejudice of the priort that adding Real-Time capabilities to Data Warehousing would result in higher system load and complexity. The present invention thus overcomes the aforementioned prejudice of the prior art and fulfills a so-far unmet need, while it demonstrates that the opposite is true.

The present invention pertains to novel systems and methodology, which is grounded on generic linear information framework containing linear information spaces and linear Information Functions. The linear Information Framework defines the data aggregation methodology, including the calculation of the Information Functions—materialized by the performance indicators—comprising statistical calculations and the like. In more detail, the claimed information systems are materializations with regard to the described information framework. The linearity of the overall system and methodology enables and guarantees the desired Real-Time capability of the system, because all desired transformations, summarizations, and calculations are executable, in linear spaces, with minimum computational effort.

The embodiments of the present invention are defined with respect to the aggregation of the information in Real Time, including, but not restricted to the calculation of performance indicators and the like. The system and method are based on a continuous homomorphic processing concept, which is grounded on a fundamental decompositional base model. Input raw-datasets are captured and transformed, creating a linear vector space in a mathematical sense; any further processing takes place within the linear information framework.

The timeliness of the Real-Time Data Warehousing is solved by the present invention as follows: given any flow of input components, which represent raw-datasets or already transformed and/or aggregated datasets, an output vector (which represents new or updated sets of transformed datasets and/or aggregates) will continuously be kept up to date, such that intermediate disk storage, reload, additional data processing and update cycles are kept at a minimum. The aforementioned approach of the invention is practicable, since the corresponding information is relatively small and is being processed—within a newly designed ETL (extract, transform and load), but not restricted to—as soon as it is available. Such minimized computational effort is not possible within prior art even in approaches which use small-scale aggregation strategies (i.e. data to be aggregated is split into small batches, which fit in memory).

As a consequence, according to the present invention, the efficiency of such an approach can be maximized in a strictly mathematical sense in an abstract computational model, and optimized in a real-world environment. The claimed methodology contains the required steps in order to map the abstract computational model to computing architectures, as well as the steps, which are required to optimize the overall system efficiency. In detail, preferred embodiments for the present invention are built on the basis of von Neumann computing architectures. Two dimensions, which characterize the efficiency of a computing system and its implementation, are considered:
(i) amount of required resources (mainly: storage and the like), and
(ii) amount of significant operations required (CPU cycles and the like).

According to the present invention, the amount of required resources are minimized in a strictly mathematical sense, because any input data component is processed instantly, i.e. as soon as it is known to the system, and immediately generates the target data without any necessity for further temporary storage or intermediate data manipulation. This holds true, because all input data is captured and immediately transformed into an ontologically fundamental structure (basic atomic datasets, fundamental atomic datasets), which is based on the inherent linearity of information, as defined according to the present invention (i.e. decompositional base model and corresponding multi-level deep structure). The amount of required significant operations minimizes dramatically, because the operations involved (i.e. grouping of data, further aggregation of data through summations and the like) map directly to fundamental operations of computing systems based on the von Neumann architecture: all such fundamental operations are part of or map directly to basic instruction sets and the like of von Neumann computers. For this reason, no alternative system and methodology can be identified, which delivers the functionally and efficiency described throughout the present invention. The aforementioned methodology enables the usage of different kinds of embodiments and data management systems. Within the scope of the present invention, data management systems are generally referred to as “databases”, but shall not be restricted thereto. For this reason, no alternative system and methodology can be identified, which delivers the functionality and efficiency described throughout the present invention.

There is an isomorphic relationship between the business part of the production process and/or business process (suitable abstraction model for reporting) and a part of the reporting layer, which is termed “fundamental atomic dataset layer” and which contains fundamental atomic datasets. The fundamental atomic dataset layer is enabled by structure-immanent evidence of the production process and/or business process organization (“fundamental decompositional base model”) and materialized by correspondent data structures.

Such fundamental atomic datasets are calculated continuously during the associated production process and/or business process, and are immanently grounded on the corresponding information, which describes the progress or change of the business process. Hence, the classical off-hours (i.e. batch) aggregation is no longer necessary, since the corresponding aggregated values for the target data (which are aggregates based on linear Information

Functions materialized by performance indicators and the like), are becoming continuously available already during the reporting period. The main purpose of the present invention is to enable and support the creation of information in Real Time—thus making complex aggregation batch procedures obsolete—focused on continuous aggregation processes, enabling ad-hoc queries on new aggregates, and knowledge discovery in databases.

A generic application (GUI) can interact with, and display aggregated data by performing sums, averages, or more complex mathematical functions, etc., on data components of the respective aggregates, including performance indicators and the like. At the same time, ad-hoc user requests—including retrieval of Real-Time values—are processed, and the capability to calculate statistical values in Real Time (including standard deviation and the like) is provided.

Due to the aforementioned novel methodology of the present invention, the load related to data transformation and aggregation becomes fully controllable in terms of system parallelization and timely scheduling. The overall linearity of the system model of the invention guarantees and enables faster and more energy efficient data access and aggregation compared to models existing in the prior art.

Additionally, there is an important informational and quality benefit, since up-to-date values for the target data, i.e. aggregates including performance indicators and the like, are already available simultaneously with the production process and/or business process execution.

An additional crucial aspect of this invention is that it mimics the structure of human thinking by breaking data into small portions that can be controlled independently and managed through a set of basic functions and properties.

The present invention further relates to arbitrary Information Functions defined on arbitrary sets of objects.

Accordingly, the key objective of the present invention is to support and enable value creation processes based on flexible data structures and aggregated information, in Real Time from multiple sources and on different hierarchical levels and granularity.

The present invention further relates to a system and method with regard to Information Functions on the aforementioned sets. A typical Information Function is the cardinality (number of elements) of such sets. Another Information Function may be based on fundamental properties of such sets. Such an Information Function may be defined through the summation of values of such fundamental properties. Summation may be used in the usual sense, but there are no restrictions to other possible definitions of summation. Other calculations are also included, for example averages, percentages, and the like. The present invention relates also to any statistical Information Function on such sets, for example mean of the length of the legs of the chairs; standard deviation of such length, etc. A further embodiment pertains to ordinal Information Function, for example the ordering of the elements of a set with regard to the value of specific properties, etc.

In another embodiment, the present invention relates additionally to a system and method with regard to a more general Information Function on such sets, which instantiates the capability of dynamic creation of new sets. It is within the scope of the present invention to remember Cantor's definition of a set: “By a set we mean any collection M into a whole of definite, distinct objects m (which are called the elements of M) of our perception or of our thought” (Yu. I. Manin). Within this definition, Cantor describes the creation of new information, which becomes instantiated through such newly aggregated sets. It is, however, not within the scope of the present invention to analyze the relationship between set theory and the standard query language. Instead, the scope of the present invention is based on the pragmatic approach, that the meaning of such new information comes out of the operations which are performed (by the user) in concrete situations within this context (i.e. within information systems and the like).

The present invention supports the capabilities to use SQL tools or SQL-like tools, including no-SQL tools, in order to dynamically create new sets. Additionally, the capability to support and enable operations between the elements of a set needs to be considered. That is, the present invention generates an Information Function in terms of considering the linearity of the underlying datasets. As a consequence of the linearity, different elements of an arbitrary set can be treated independently.

Consequently, any application, which is installed upon a typical data management system can be modeled, designed and implemented in accordance with the linear system model of the present invention. It is within the scope of the present invention to build the information system of the present invention on the fundaments of the linearity of the information, which supports and enables parallel and singular treatment of the data elements. The claimed methodology incorporates consequently the mapping of such linear system design to corresponding computer architectures and embodiments in order to enable and guarantee best usage of modern, parallelized computer architectures.

Thus, in a most preferred embodiment, the present invention supports and enables in a fundamental and optimized manner the parallel treatment of many, preferably of huge amounts of elements, in order to create as an output new information, which is based on the results of such parallel treatment. This may also be used in terms of further support for knowledge discovery in databases according to the present invention.

Additionally, the present invention provides interfaces in order to support available tools in the domain of knowledge discovery in databases (KDD).

As an entry point to the multi-level deep structure of the information system of the invention, the present invention defines basic atomic datasets (BADSs); the first level of the deep structure of the system model. A major characteristic of the structure of BADSs is its linearity, holding an isomorphic relationship to the underlying production model, and guaranteeing and enabling at the same time the linearity of the information framework. New sets of data—as for example using ad-hoc queries—can be created on the BADSs level. For this reason, the present invention enables—through a guaranteed overall linear system structure—the creation of new and relevant information in a most advantageous manner. On a succeeding level of the deep structure of the information system of the present invention, such BADSs are used as input data in order to create and/or update fundamental atomic datasets (FADSs), which represent the second level of the deep structure of the system model, and which are required for the calculation of the Information Functions materialized by performance indicators and the like. The corresponding data will be processed periodically and automatically and stored in Real-Time aggregated datasets (RTADSs) as the third level of the deep structure of the system model.

Accordingly, the present invention supports two main functionalities:
a) automated and Real-Time, continuous processing of predefined performance indicators and the like, based on basic atomic datasets (BADSs), fundamental atomic datasets (FADSs), and Real-Time aggregated datasets (RTADSs); and
b) required interfaces in order to process basic atomic datasets (BADSs) directly with regard to ad-hoc request of the user, also with regard for further knowledge discovery in databases. This functionality includes also the capability to include FADSs, RTDASs and other data sources into such ad-hoc interrogations.

As defined above, the ontological and physical foundation of the present invention is defined by a core model, which is called “information model” and which is based on the analysis of the immanent relationship between the structure of the objects of the real-world system and the corresponding model. This analysis provides the deep structure of the information system of the present invention, whereas this analysis results in the herein described multi-level model and corresponding foundational ontology.

In a further embodiment, the usage and development of a foundational ontology of the present invention aims to support data aggregation mechanisms (e.g. as commonly used in Data Warehouses) in an optimal manner. The current approach is motivated through the immanent relationship between the logical descriptions of objects of the real-world system and the claimed information system. The real-world system includes physical components, having and/or including technical properties and/or business properties of such systems, and the like. For example, a specific movement of a part of a machine may correspond to the engineering concept “process start”. Another movement or event may correspond to an engineering concept called “cycle time”. Even another set of events may correspond to the concept “production costs”. Such concepts may be used in different kinds of systems (MES, ERP, and the like). But all those different kind of systems share the same foundational ontology with regard to the intentions of the present invention. For this reason, the foundational ontology (and corresponding deep structure of the model) of the present invention is grounded on a strategic basement. This basement is in a first step given by the “state tracking model” and the “decomposition model”, as described by Wand and Weber (1995).

Real-world objects are represented as hierarchical systems, whereas such systems are characterized through a set of finite states, and the capability of sending and receiving of external (or internal) events on all hierarchical levels. External (or internal) events may cause state changes of systems, or subsystems, respectively. A production machine can be in the state “productive” or “down”, etc. Secondly, the correspondence between the model of Wand and Weber (1995), and the real world is to be extracted out of Luhn (Luhn, 2011). Luhn shows that information is a fundamental category in real-world systems, whereas the model as introduced by Wand and Weber can be mapped to such systems.

The present invention is further based on a “decompositional base system model”. According to the invention the decompositional system model can be grouped hierarchically in a multitude of levels, whereas each grouping creates a new subsystem. Such systems can also be chained, whereas any chain creates a new system. The transformation structure of any system is holding the form of
a) input vector(s)/input-event(s),
b) physical state system model (systems of finest granularity are finite state, linear quantum systems) and transformation structure (transformation rule), and
c) output vector(s)/output-event(s). Additionally, spontaneous activities may appear (including stochastic influences),

and may cause the appearance of events in an unplanned manner. Consequently, state changes might appear in an unpredicted manner and might raise the necessity to create historical records of such system state changes.

Based on the decompositional base system model according to the invention, the wide range of simple, linear systems up to complicated systems, including nondeterministic behavior, can be modeled, because the characteristics of nondeterministic behavior are immanently kept in historical records, pertaining informational completeness of the claimed system. Typically, all target systems within the scope of the present invention show such nondeterministic behavior, and corresponding domain applications are keeping historical records, respectively.

The decompositional system model of the invention is consistently defining linear spaces of information. For practical reasons, it is not always possible to construct a model of a system only from physical laws. Usually, system identification methods are used to solve such kinds of problems. As an example, a movement of a part of a machine may be a complicated process, which gets mapped to a simplified, abstracted system model. Such a movement gets initiated through forces of electric motors (input vector), gets controlled by a controller (transformation rule), and acts towards other mechanisms and forces (output vector, maybe including measurement indicators of the movement). Other examples are physical, chemical or financial processes. It is to note that it is not within the scope of the present invention to provide and define such different models with regard to different domains and different applications (like MES, ERP, etc.). Instead, the basic idea of the present invention is that the described decompositional base system model is holding the capability to model complicate real-world systems. In this regard, it is an advantage of the present invention that even complicate and nondeterministic systems can be successfully mapped to the decompositional system models, because the historical records may carry required information about the complicatedness (and non-determinacy) of the real-world system behavior.

Out of the analysis of the mathematical structure of performance indicators in all different kind of industrial and public domains is to be concluded, that any corresponding system model in all those different domains and applications incorporates the structure of the decompositional system model, as defined above. That is, because of the compositional characteristics, any parameter or data component, which describes the behavior of subsystems on the lowest level of granularity, can be grouped and aggregated with corresponding parameters using historical records. The decompositional system model preserves the linearity of the overall model, and defines the corresponding linear relations of the historical records.

The embodiments of the present invention support any kind of classical database environment, up to new systems and methods like OLAP/MOLAP and In-Memory databases. It is not even required to use relational databases. Any kind of structured data storage system may be suitable as an adequate embodiment; for example NoSQL database and storage systems and the like. Nevertheless, all such data management systems and methods rely on a more fundamental relational methodology, even when in some cases explicit schemata are not used. The fundamental relational model is one of the most stable concepts in computer science, which is also inherent part of the linear system model. The reason is that all such methods are grounded on the fundaments of set theory, as already introduced by Frege. Sets are defined as ensembles of elements, and relationships between sets and elements are defining in a fundamental manner the relational model, which is still used in modern computer science. In a broader sense, relations are non-reducible structures in nature, as laid down in quantum physics. They are overlaid by statistical and other influences, presenting many interesting phenomena on microphysical levels. Some relations are explicitly given; others are given from within an implicit perspective. This also holds true for relational representations (i.e. explicit and/or implicit) of information in texts, pictures, schemata, or other kinds of artifacts. Such kind of information is of high importance for the different processes in companies (even in art and literature). Within the scope of the present invention, such kind of information can also be extracted and summarized out of documents, which do not explicitly rely on database oriented schemata (as for example in unstructured texts). While defining and implementing any desired Information Function, the present invention supports in the same advantageous manner further analysis and knowledge discovery with regard to “non-relational” or NoSQL databases or document storage systems.

Accordingly, the present invention provides a new methodology and systems for enabling overall on-the-fly data roll-up capability of the aggregation server—which is based on the linear information spaces—as presented in this invention, thus enabling methodologically enhanced Real-Time information retrieval and knowledge discovery in databases.

In another embodiment, the present invention provides an improved method of and system for managing data elements within a novel (multidimensional) database (MDDB) using data aggregation servers, thus achieving a significant increase in system performance (e.g. decreased access and/or search time and/or aggregation time) and a more advantageous temporal evolvement using scalable data aggregation servers.

The present invention further provides such systems, wherein the aggregation servers include an aggregation engine that is integrated with an MDDB, and can communicate with virtually any conventional server, including MOLAP/ROLAP server.

The present invention further provides such a data aggregation server whose computational tasks includes—in specific embodiments—data aggregation, while the MOLAP/ROLAP server preserves its non-aggregational, remaining functionalities.

In yet a further embodiment, the present invention provides a system, wherein the aggregation server (“transformation and aggregation engine”—MDDB handler—MDDB; FIG. 16) carries out an improved method of data aggregation within the MDDB, which provides Real-Time capabilities to the MDDB.

The present invention also provides an aggregation server, wherein the transformation and aggregation engine supports high-performance aggregation (i.e. data roll-up) processes to maximize query performance of large data volumes, and to reduce the time of ad-hoc interrogations (including knowledge discovery in databases).

The present invention further provides a scalable aggregation server, wherein its integrated data aggregation engine distributes the aggregation process uniformly over the entire data loading period, inherently enabling an optimized usage of all server components (CPUs, memory, disks, etc.).

A further embodiment of the present invention is to provide such a novel and scalable aggregation server for use in OLAP operations, wherein the scalability of the aggregation server enables the speed of the aggregation processes carried out therewithin to be substantially increased by distributing the computationally intensive tasks associated with the data aggregation among multiple processors.

The present invention further provides a novel and scalable aggregation server, with a uniform load balancing among processors for high efficiency and best performance, allowing scalability by adding processors.

In a preferred embodiment, the present invention provides a novel and scalable aggregation server, which is suitable to support OLAP systems (including MOLAP, ROLAP) with improved aggregation capabilities, and similar system architecture.

In a further preferred embodiment, the present invention provides a novel and scalable aggregation server, which can be used as a complementary aggregation plug-in to existing OLAP (including MOLAP, ROLAP) and similar system architectures.

In a yet preferred embodiment, the present invention provides a novel and scalable aggregation server, which uses the novel continuous Real-Time aggregation methodology of the present invention.

The present invention further provides a novel and scalable aggregation server, which includes an integrated MDDB and aggregation engine and which carries out full pre-aggregation and/or on-demand aggregation process within the MDDB on the RTADS layer.

In another embodiment, the present invention provides a novel methodology to aggregate multidimensional data by using fundamental atomic datasets (FADSs), originating from different sources, including MES, other Data Warehouse systems, equipment data, and other end user applications domains (i.e. ERP, financial sector and the like).

The present invention further provides a novel and scalable data aggregation engine, which dramatically expands the boundaries of OLAP (including MOLAP, ROLAP) applications into large-scale Real-Time applications.

Moreover, the present invention provides a generic data aggregation component, suitable for all OLAP (including MOLAP, ROLAP) systems of different vendors.

Another object of the present invention is to provide a novel and scalable aggregation engine, which replaces the batch-type aggregations by uniformly distributed continuous Real-Time aggregation during the entire operational and/or production and/or business time.

In a further embodiment, the present invention provides an improved method and system for transforming large-scale aggregation into continuous Real-Time aggregation, achieving a significant increase in the overall system performance (e.g. decreased aggregation/computation time), reduced overall energy consumption, and further enabling new functionalities at the same time, based on the linearity of the information spaces.

The present invention further provides methods for adapting the Information Functions such that linear structures can be achieved, thus enabling simple and efficient aggregation/computation methodology and knowledge discovery in databases.

In a further preferred embodiment, the present invention provides an improved method of and system for enabling ad-hoc information retrieval (thus facilitating knowledge discovery in databases) due to novel information structures (basic atomic datasets, fundamental atomic datasets, Real-Time aggregated datasets), as introduced in this invention.

In a further embodiment, the present invention relates to a method for operating a data processing system, comprising data structures, transformation and aggregation processes and corresponding multidimensional databases, characterized in that the transformation and aggregation is based on homomorphic processing—which is grounded on a linear decompositional base system model—thus preserving the linearity of the underlying structures and enabling real-Time information processing.

In further embodiments, the invention relates to a computer program product adapted to perform the method according to the present invention; to a computer program product comprising software code to perform the method according to the present invention. In a preferred embodiment, said computer program product comprising software code performs the method according to the present invention when executed on a data processing apparatus.

The present invention relates further to a computer-readable storage medium comprising a computer program product adapted to perform the method according to the invention. Said computer-readable storage medium is preferably a non-transitory computer-readable storage medium.

In yet a further embodiment, the present invention relates to a data processing system comprising means for carrying out the method according to present invention.

### DESCRIPTION OF THE DRAWINGS

FIG. 1 shows an exemplary representation of the system and architecture of the present invention, comprising a three-tier architecture, where (i) the first tier is built upon a database utilizing a Real-Time DBMS to support the transformation/aggregation—including the computation of the performance indicators as embodiments of Information Functions—further comprising the first three layers as disclosed within this invention (BADS, FADS, RTADS), (ii) the second tier incorporates the reporting application logic layer RTOLAP (i.e. OLAP servers), Real-Time data-marts, and the like, to provide the multidimensional analyses (reports), and (iii) the third tier which integrates the OLAP servers, Real-Time data-marts, and the like with a variety of visualization interfaces, through which the users perform queries/analysis against the OLAP server. The first tier contains (ref. to the schematic representation within the Real-Time DBMS) the Real-Time transformation and/or aggregation engine of the present invention (details in FIG. 16) to perform isomorphic and/or homomorphic processing. User queries can launch on-demand additional data aggregation and/or computation requests including ad-hoc queries, data mining and knowledge discovery in databases.

FIG. 2 is a systematic scheme in order to represent the spirit and the scope of the

Information Function. Typically, but not restricted to, an Information Function (IF) delivers out of specified input values a value of importance (measure data) in order to characterize the subject under observation. The structure of such Information Function guarantees and enables the representation of the corresponding information in a most advantageous manner.

FIG. 3 is an exemplary representation of a generalized embodiment of a prior art system and method (data flow), comprising (i) a raw data loader for receiving raw data from external systems (Data Sources), (ii) a staging area (ETL-layer) and (iii) a corporate Data Warehouse. The data from the (primary) data sources are loaded through the ETL-layer into the Data Warehouse. Real-Time Reports (not represented) can be performed against the Data Warehouse, but no corporate KPIs can be calculated and reported in Real Time. Batch aggregation/computation (usually during off-hours at night) of the corporate KPIs supplies the results necessary for reporting.

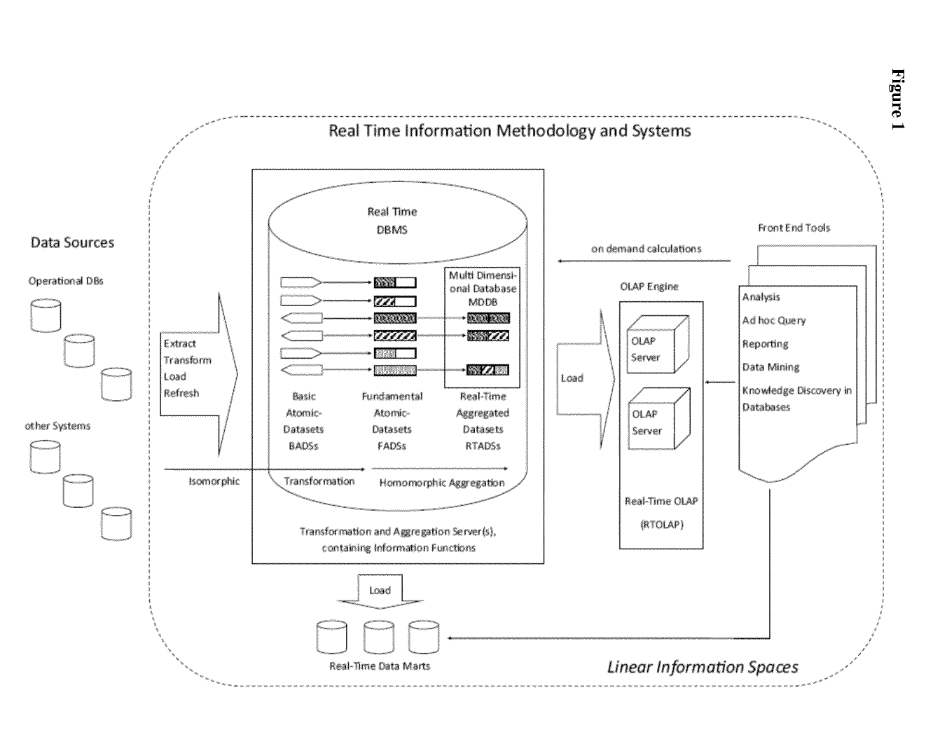

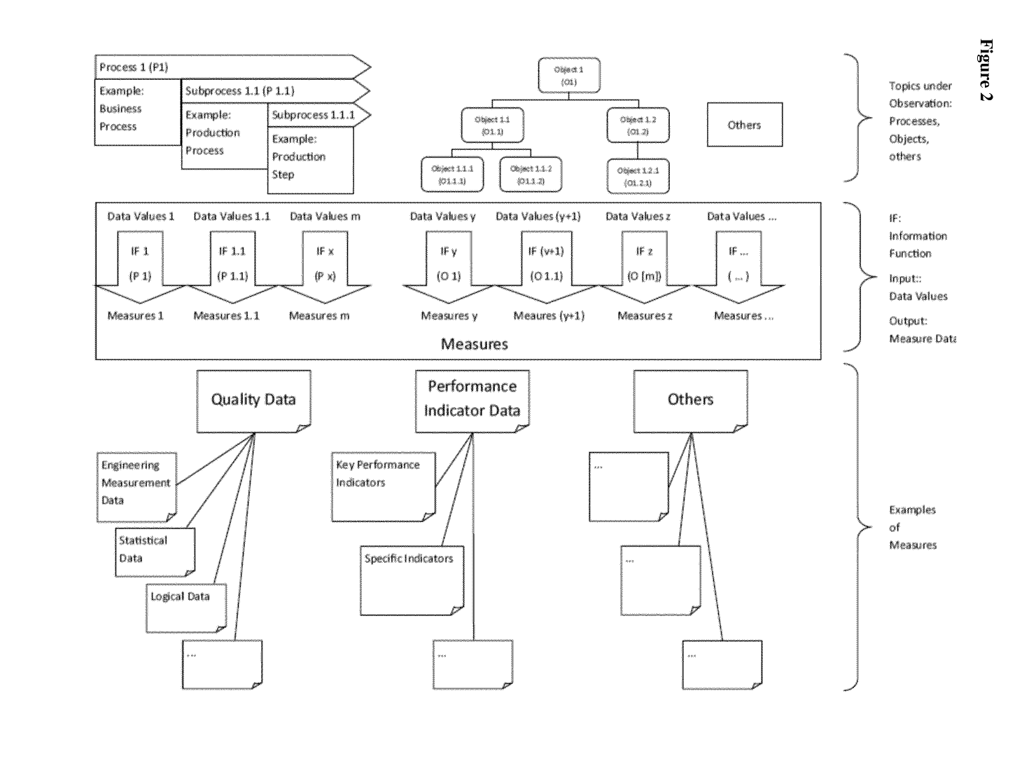

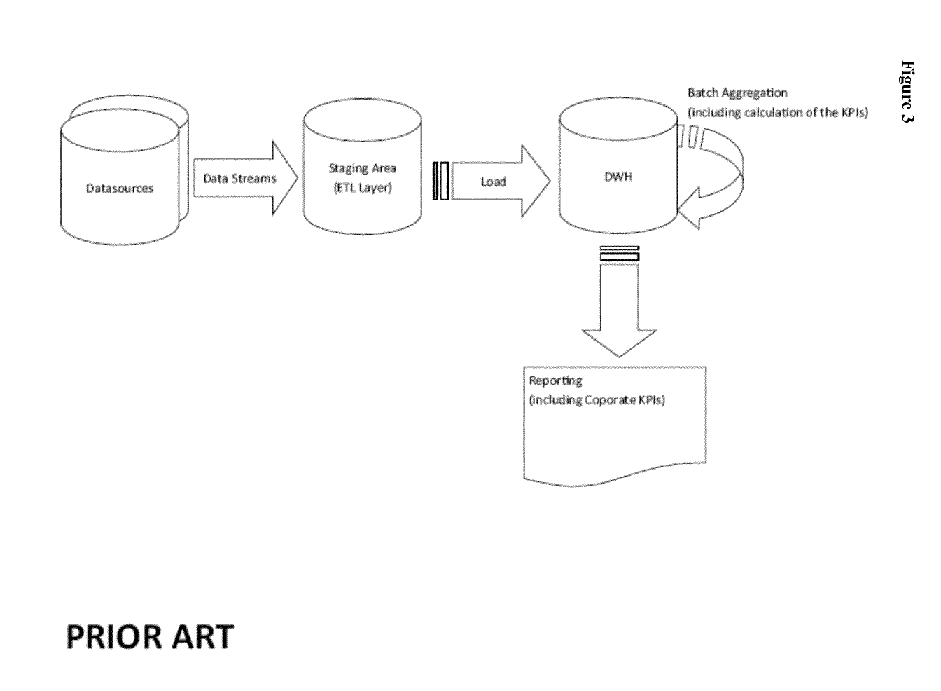

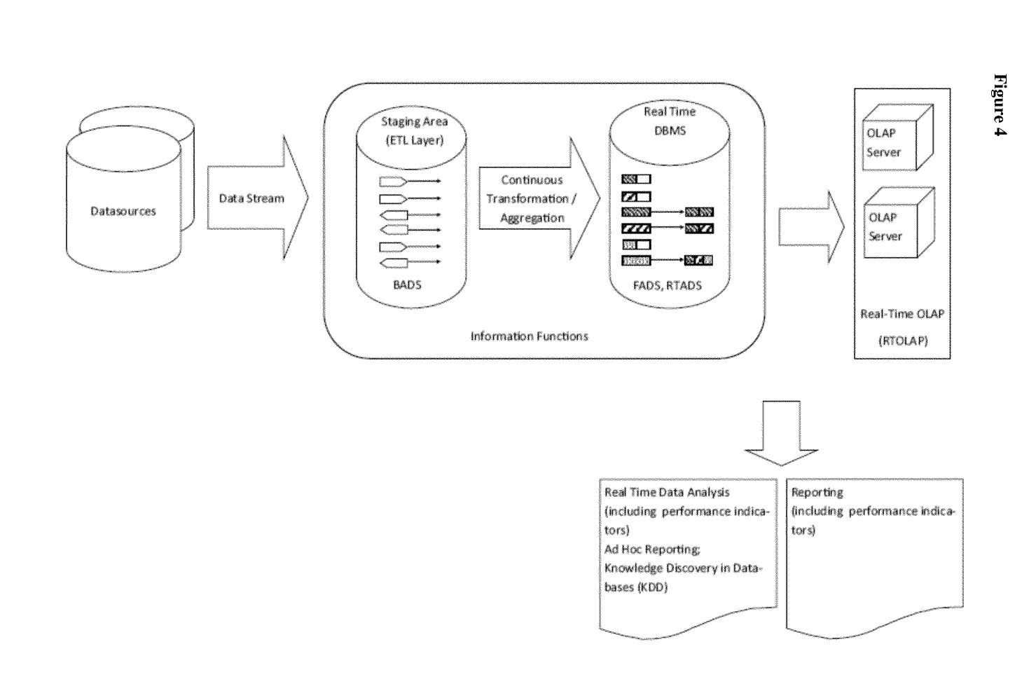

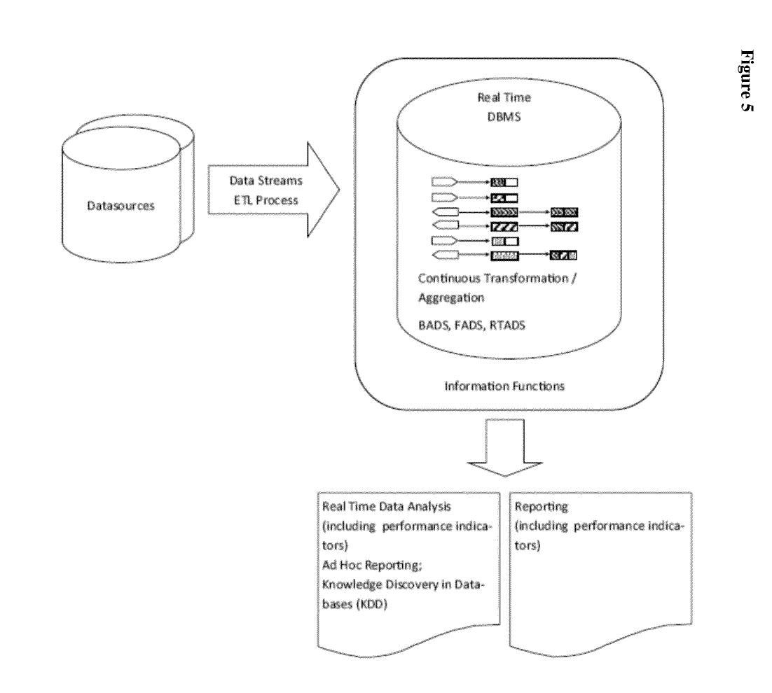

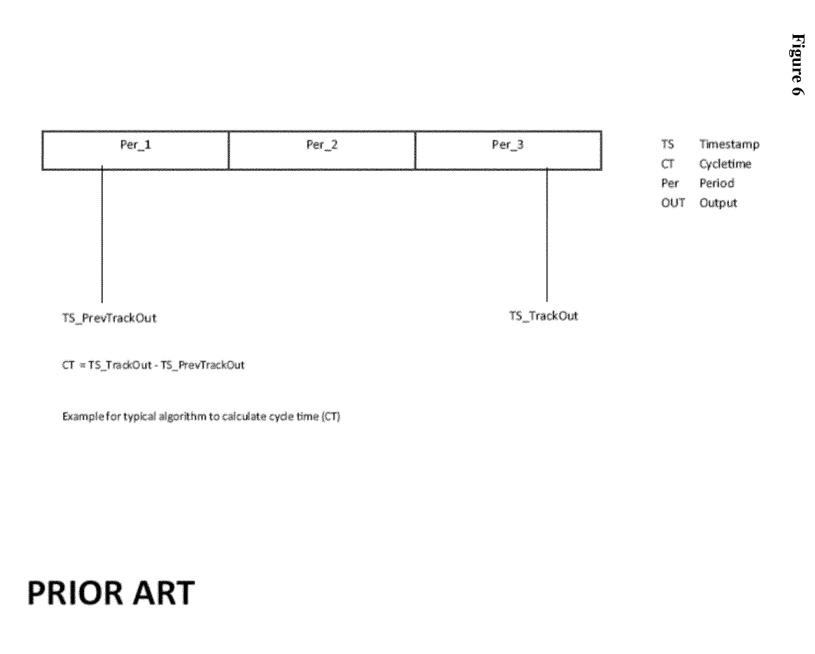

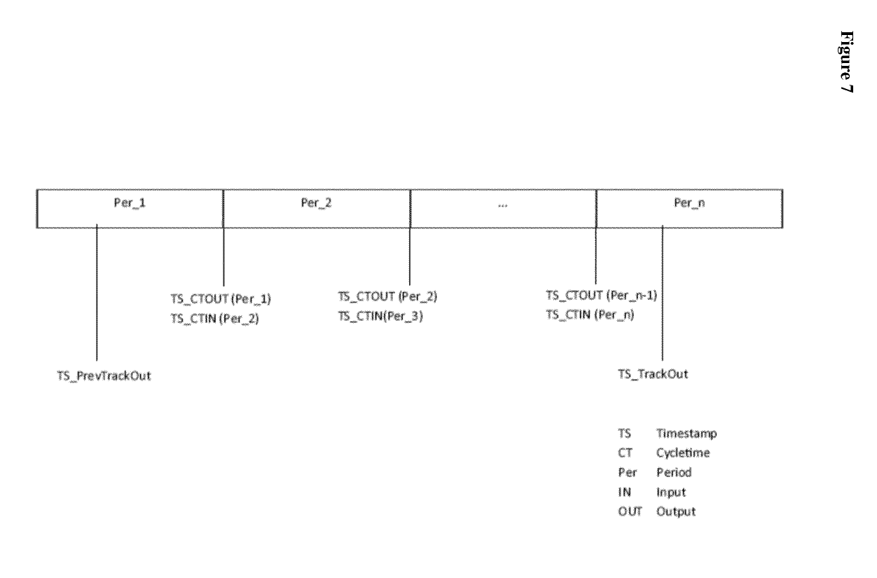

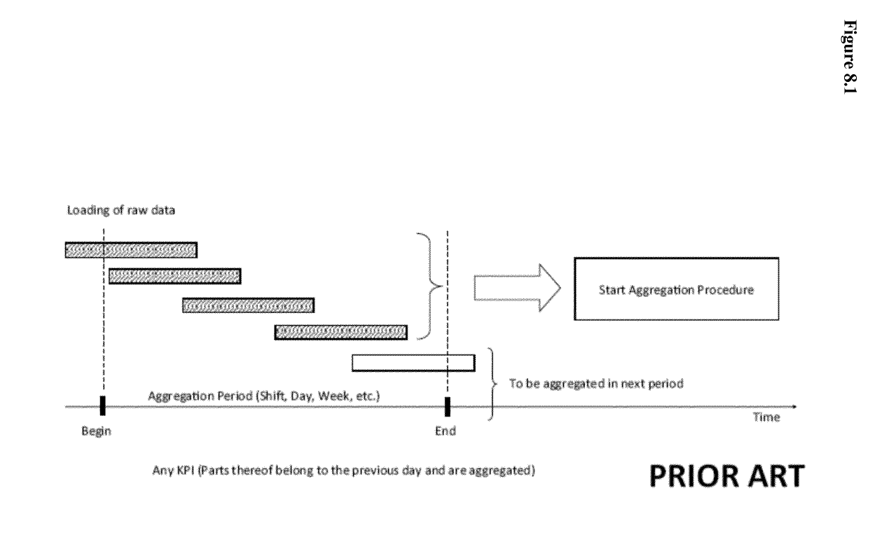

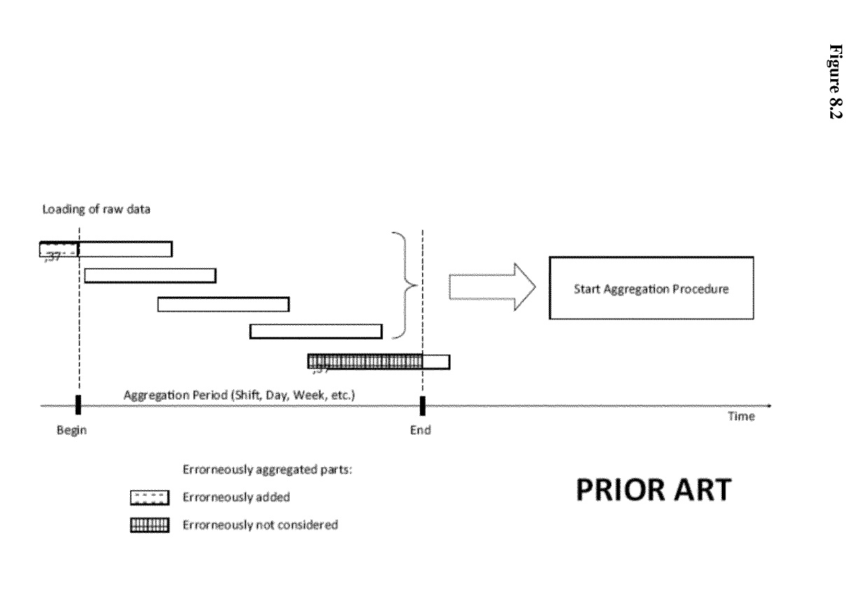

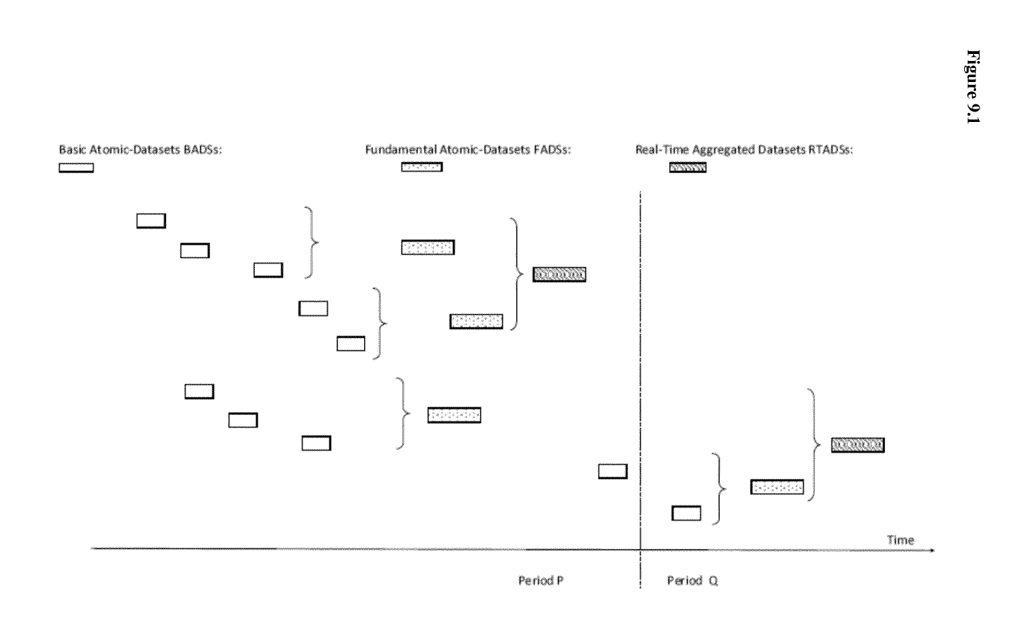

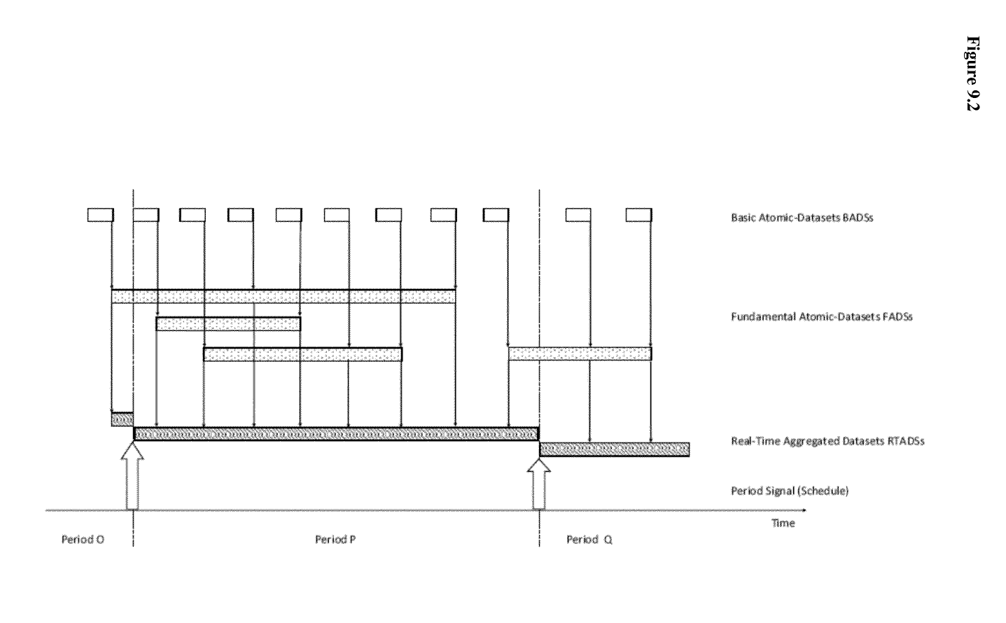

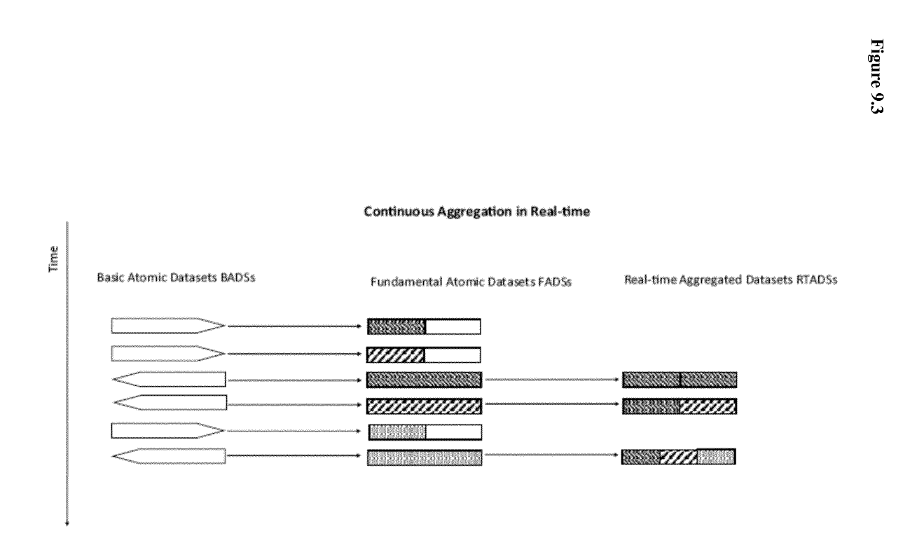

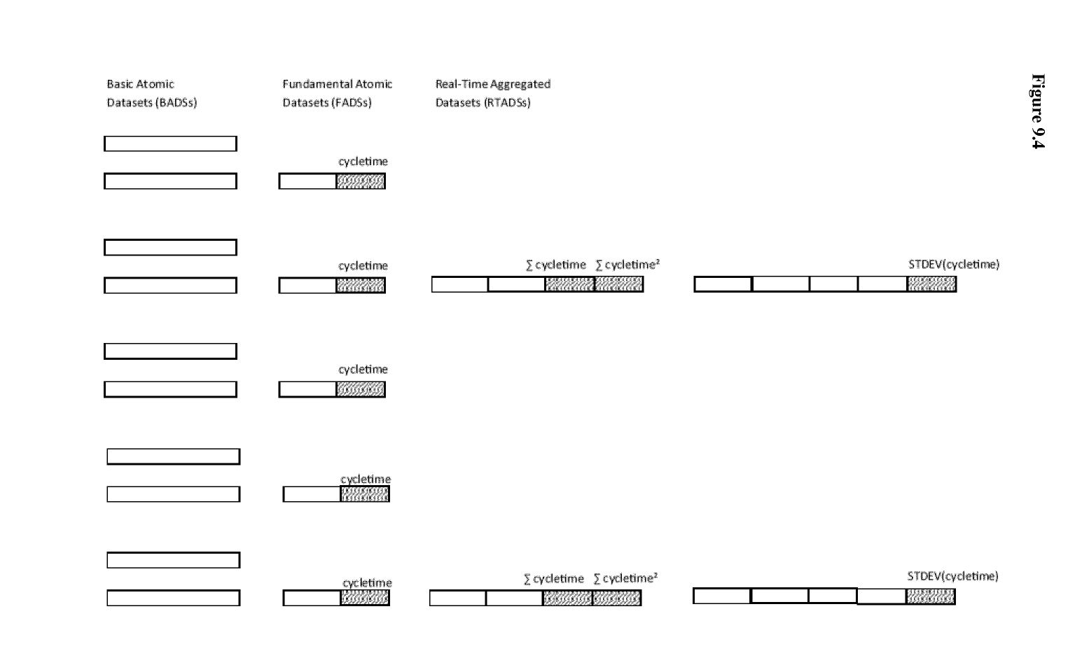

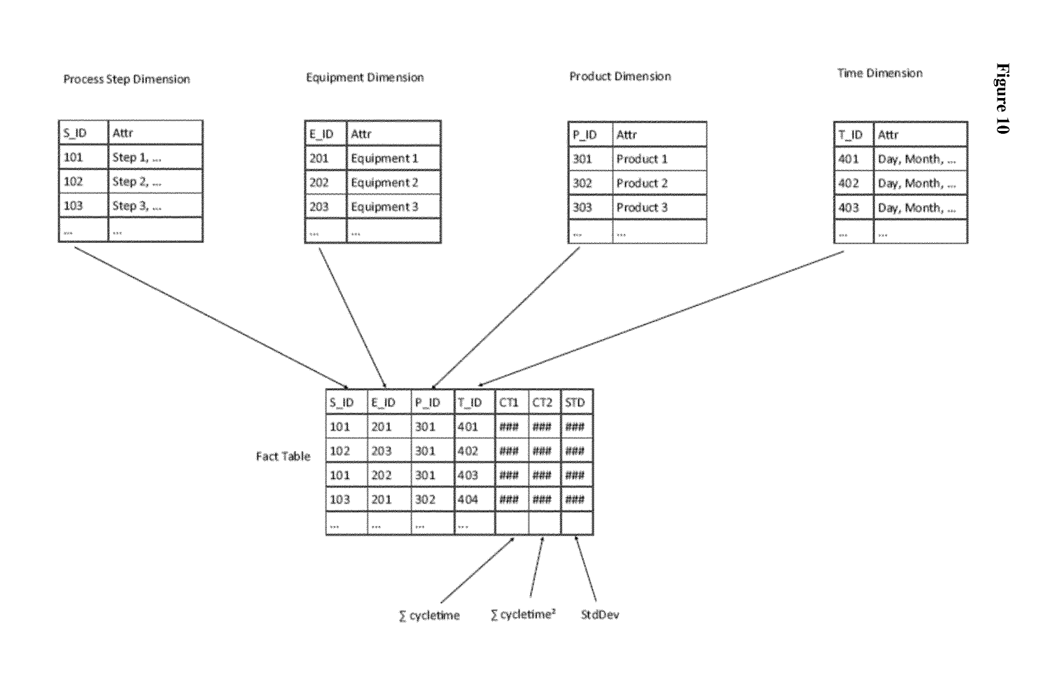

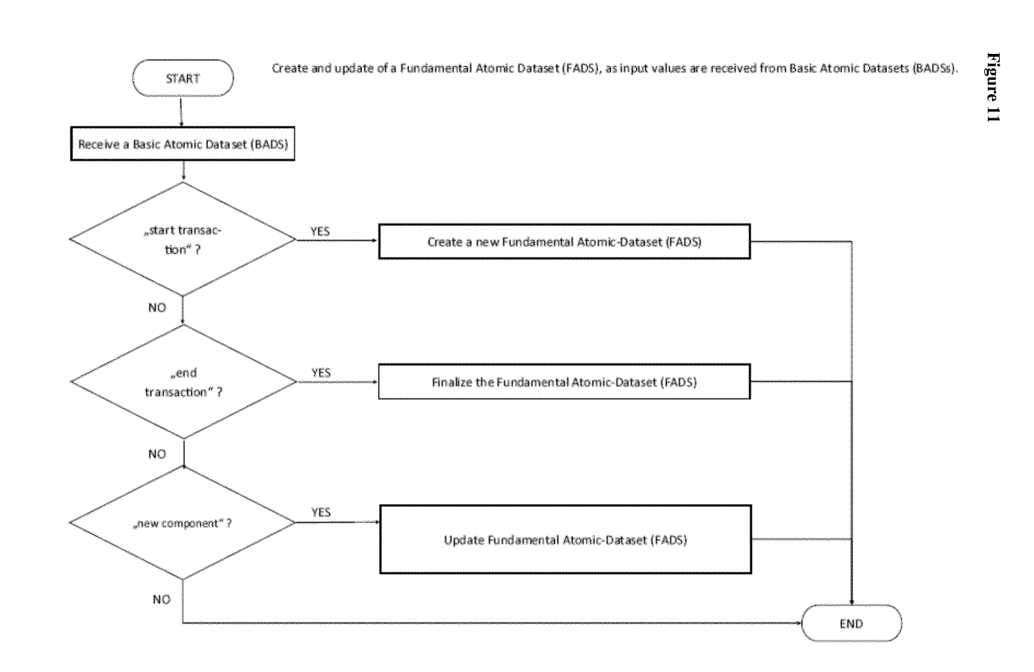

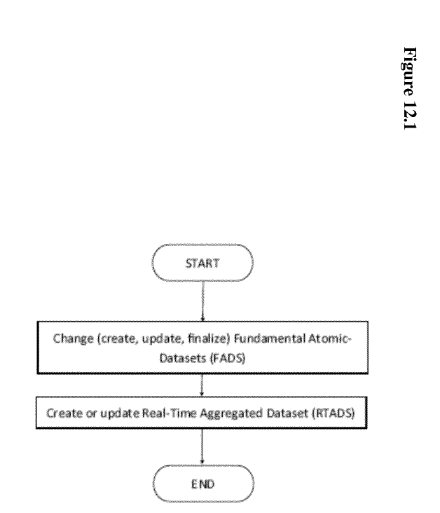

FIG. 4 (in conjunction with FIG. 1) is an exemplary schematic representation of the data flow of the system and method of present invention.
The raw data is loaded from the data sources into the staging area, where the raw data is transformed, building the basic atomic dataset layer (BADS-layer) as according to the disclosures of the present invention. The basic atomic datasets are further transformed, summarized and enhanced by some new attributes, building the fundamental atomic dataset layer (FADS layer). The performance indicators are calculated in Real Time based on summaries on the FADS layer—building the Real-Time aggregation dataset layer (RTADS-layer)—including multiple levels of aggregations, i.e. aggregates of aggregates, also including processing of relative performance indicators, as disclosed in the present invention).
According to the aforementioned continuous aggregation strategy, the calculated partial values—i.e. fraction values referring to the point in time considered for the calculation within the aggregation period—of the performance indicators are already available—in Real Time—during the aggregation period, including corporate KPIs and the like. Hence, data analysis, reporting, knowledge discovery in databases, etc. is possible as soon as the involved data is loaded and it is available in the source-systems, including but not restricted to OLTP systems.
In contrast to the aforementioned potentiality, the batch aggregation strategy of the previous art provided the calculated values of the performance indicators after the expiration of the corresponding aggregation period (considering also the time necessary for the batch aggregation). Usually, the FADS layer and the RTADS layer contain enough information, such that data analysis, including reporting and the like are performed against these layers. Sometimes, special analysis is performed against the BADS-layer, which contains the finest granularity of the data in the Real-Time DBMS. The present drawing contains an exemplary embodiment of the data flow of the system and method of present invention, but other embodiments, where the Real-Time DBMS is split into (i) a component containing the first tier (i.e. BADS, FADS, and RTADS) and (ii) an additional component containing the RTOLAP, are possible.

FIG. 5 (in conjunction with FIG. 1 and FIG. 4) is an alternative (to FIG. 4); exemplary schematic representation of the data flow of the system and method of present invention. The embodiment shows an integrated ETL-layer, whereas the integration is implemented within the data streams; i.e. during the messaging phase (middleware). This way, the traffic of unnecessary data is eliminated enhancing the Real-Time behavior of the system. The raw data as loaded from the data sources is immediately transformed/aggregated. The performance indicators are calculated continuously in order to enable Real-Time reporting.

FIG. 6 is an exemplary representation of the algorithms of the typical prior art calculation of the cycle time (CT) for period aggregation, as defined in the working examples. The cycle time is typically calculated as

CT:=TS_TrackOut−TS_PrevTrackOut,
where TS_TrackOut and TS_PrevTrackOut are the points in time when the corresponding events (which were considered for the delimitation of the cycle time) occurred. The time line between the aforementioned two events covers three periods as represented in FIG. 6.

FIG. 7 is a representation of the exemplary calculation of a performance indicator (this example comprises the calculation of the “cycle time” related to time periods) of the present invention, where the underlying production process is spread over multiple periods (n>3). The cycle time is the length of the time passed between two events, usually TS_TrackOut and TS_PrevTrackOut. For each complete period, which does not contain TS_TrackOut or TS_PrevTrackOut, two new attributes are defined: TS_CTIn and TS_CTOut, which represents the beginning of the period to be reported on, and the end of this period, respectively. For period Per_2 the cycle time is equal to TS_CTOut−TS_CTIn. Similar results are valid for all periods. The advantage of this method is that information for bottleneck analysis—including the calculation of other indicators—becomes immediately visualizable. As disclosed within this invention, the average WIP for the related time period can be immediately calculated out of the aforementioned “cycle time” related to time periods. Little's Law can be directly applied.

FIG. 7 represents and illustrates a continuous aggregation algorithm to calculate cycle time (CT).
The abbreviations in FIG. 7 mean:
TS Timestamp
CT Cycle Time
Per Period
IN Input
OUT Output
Description of the assignment of variables in FIG. 7 in order to calculate the cycle time:

$$TS\_CTIn ( Per\_ 1 ) = TS\_PrevTrackOut$$

$$TS\_CTOUT ( Per\_ 1 ) = TS\_EndofPeriod ( Per\_ 1 )$$

$$TS\_CTIn ( Per\_ 2 ) = TS\_StartofPeriod ( Per\_ 2 )$$

$$TS\_CTOut ( Per\_ 2 ) = TS\_EndofPeriod ( Per\_ 2 )$$

$$…$$

$$TS\_CTIn ( Per\_n ) = TS\_StartofPeriod ( Per\_n )$$

$$TS\_CTOut ( Per\_n ) = TS\_TrackOut$$

$$CT ( Per\_ 1 ) = TS\_CTOUT ( Per\_ 1 ) - TS\_CTIn ( Per\_ 1 )$$

$$CT ( Per\_ 2 ) = TS\_CTOUT ( Per\_ 2 ) - TS\_CTIn ( Per\_ 2 )$$

$$…$$

$$CT ( Per\_n ) = TS\_CTOUT ( Per\_n ) - TS\_CTIn ( Per\_n )$$

FIG. 8 shows exemplary graphical representations of the algorithms—considering the chronological order they are started—of the typical prior art period aggregation. The aggregation period is delimited by the Begin and End time points. The aggregation procedures can only be started once the corresponding datasets of the entire period (e.g. working shift, day, week, etc.) have already been loaded into the Data Warehouse and are available in the desired format. For example, the daily batch aggregation procedures could be started only after the preceding data loading procedures have been completed (i.e. after midnight), ensuring that all the relevant data for aggregation of the previous day is already in the Data Warehouse at the right place/in the correct format. FIG. 8.1 shows the typical calculation of performance indicators, whose timely evolvement are spread over multiple periods. Hence, the first dataset is considered at his full length and the last dataset is not considered at all. FIG. 8.2 indicates the erroneous parts of the calculation, which have to be corrected, in order to deliver accurate values.

FIG. 9 shows are exemplary representations of the “continuous aggregation methodology in Real Time” of the present invention. The raw data from the primary data sources (not represented in these figures) is transformed building the basic atomic datasets (BADSs), which contain the lowest level of granularity of the information for data analysis. Usually, no summary reports are launched against this layer; but ad-hoc interrogations and knowledge discovery applications may directly access this layer.
The basic atomic datasets, which belong to the same logical entity—i.e. transactions from the perspective of the manufacturing process—are grouped and the relevant information is extracted into a specific dataset, the fundamental atomic dataset (FADS).

FIG. 9.2 details the mapping of BADSs, FADSs and Real-Time aggregated datasets (RTADSs) to periodic intervals. Distinctions between different intervals might be initiated and identified using period signals. Those signals might be controlled via a scheduler, thus enabling a proper processing of any Information Function with regard to such periods.

FIG. 9.3 distinguishes the logical entities by different shadowing, since the basic atomic datasets can be chronologically interlaced. The FADSs contain the lowest level of granularity of the information needed for reporting (including calculation of the performance indicators and the like). The FADSs contain summarized information of the BADSs enhanced by new attributes containing calculated values (for example a FADS may contain the value of the cycle time as a difference of two points in time). The data is aggregated continuously from lower level of granularity towards higher levels (in order to keep the representation simple, just one level of aggregation is considered in the figures). Hence, the corresponding performance indicators and the like are calculated continuously.

In FIG. 9.1 the shaded area suggests that the corresponding attributes contain calculated values. For each grouping—related to a given period—a unique dataset is created/setup for aggregation, which is then continuously updated each time a new FADS is created.

In FIG. 9.3 this update process is visualized from another perspective, suggesting that over time (arrow left) the aggregated dataset contains the additional information (different shadowing) involved. This figure shows also possible dedications of RTADs to different periods (O, P, Q in this example). It has to be noted, that periods may also overlap (ex.: working shift aggregation vs. daily aggregation), be hierarchically grouped, etc.

FIG. 9.4 details the calculation strategy of the present invention, by showing a schematic graphical representation of the chronological order of the aggregation methodology. For each FADS the fraction values of the performance indicators are calculated as soon as the involved attributes of the FADS are determined—termed as FADS is completed—for example, as soon as the TS_TrackOut value is known, the “cycle time” for the transaction can be calculated/stored. In more detail, all FADS data components are determined in Real Time, which is succeeded by further aggregation processes towards Real-Time aggregated datasets (RTADSs). Following the aforementioned methodology, all data required for data analysis, reporting, and knowledge discovery is available in Real Time. As in the present example, the attributes “CycleTime” and “SQ_CycleTime” belonging to the RTADS layer are updated by the corresponding values of the FADSs. The final value of the performance indicators (for example STDEV) can either be calculated within the update cycles, or they can be calculated “on demand”, when requested by the GUI. Alternatively, the final values of the performance indicators (like STDEV) can be calculated within the GUI.

FIG. 10 is an exemplary representation of the star schema of the present invention. According to the disclosures of the present invention, the fact and dimension tables are refreshed continuously and the calculated values of the performance indicators are held up to date, enabling Real-Time reporting.
Process Step Dimension means e.g. {ProcessStep, SubRoute, Route, . . .
Equipment Dimension means e.g. {Chamber, Equipment, Cluster, . . . }.
Product Dimension means e.g. {Product, ProductClass, ProductGroup, Technology, . . . }.
Time Dimension means e.g. {Shift, Day, Week, Month, Year, . . . }.
The fact table is updated as soon as a fundamental atomic dataset is processed. The benefits of the scheme illustrated in FIG. 10 is that the value of attributes (like “Shift”, “Day”, etc.) can be retrieved at different points in time, e.g. at 8:00, 12:00, 22:00; visualizing the progress of the manufacturing process.

FIG. 11 is an exemplary schematic representation of the organigram (flow chart) of the—Real-Time—creation/update process of a fundamental atomic dataset (FADS) of the present invention. All BADSs which belong to the same logical entity—termed transaction within this disclosure—will map their information to the same FADS. Each time a basic atomic dataset (BADS) is created a corresponding algorithm creates/updates/finalizes the FADS. There is a one-to-one linear mapping (isomorphism) of the production process—in terms of transactions from the perspective of the manufacturing process—to the FADS layer, which constitutes a fundamental strategy of the present invention). Refer to the example 2. In this example, “start transaction” corresponds to the PrevTrackOut transaction of a specific step s (except the first step for a route) and “end transaction” correspond to the TrackOut transaction at the step s. As aforementioned, this assignment is required, since as soon as a material unit is processed at a specific step (TrackOut), the subsequent step has already been determined. The algorithm works as follows (simplified version):
For an incoming BADS, the algorithm determines if this BADS corresponds to a “start transaction”. If this is the case, then a new FADS is created with the relevant information of the BADS considered. For example, the subsequent step of the BADS will be mapped to the attribute “step” of the newly created FADS. If the BADS corresponds to an “end transaction”, then—after updating all relevant attributes—the FADS is finalized, i.e. no more updates are performed on the aforementioned FADS. The relevant information is retrieved from the BADSs, which are neither “start transaction” nor “end transaction”—termed “new component”—and this information is added to the corresponding FADS. For example, for an incoming BADS, which contains TrackIn information, at least the TrackIn time stamp (TS_TrackIn) is added to the corresponding FADS.

FIG. 12 shows exemplary schematic representations of the organigram of the—Real-Time—creation/update process of a Real-Time aggregated dataset (RTADS) of the present invention and of the span aggregation of the present invention.

FIG. 12.1 is an exemplary schematic representation of the organigram (flow chart) of the—Real-Time—creation/update process of a Real-Time aggregated dataset (RTADS) of the present invention. The algorithm is very similar to the algorithm presented in FIG. 11 to create/update the fundamental atomic datasets (FADSs).
Each time a FADS is created/updated/finalized a corresponding algorithm creates/updates the associated RTADS, in order to calculate partial/fractional values of the performance indicators, thus performing a Real-Time calculation (preferably summation) of the performance indicators and the like. The aforementioned methodology (homomorphic aggregation) constitutes another main pillar of the present invention.
As detailed in the example in the Chapter “Summary”, as soon as the FADS is updated with the information regarding the TrackOut transaction, the newly calculated value of the “cycle time” will be added to the corresponding attribute on the RTADS layer.
As soon as all the FADS s of the corresponding grouping (for the period considered) is aggregated, the attributes containing the calculated values of the performance indicators and the like already hold up-to-date information that can be used for reporting and further data analysis.
It is not the scope of this description to clarify more details, which deal with higher level of specificity, see for this purpose the disclosures of the present invention of the Chapter “Summary”.

FIG. 12.2 is an exemplary schematic representation of the organigram of the span aggregation of the present invention. For each period (shift, day, week, etc.) a new group of aggregated datasets with the corresponding information is created or updated.

FIG. 13 is an exemplary representation of the rolling window aggregation strategy of the present invention. Consider the working examples of the present invention regarding the calculation of the standard deviation. If a fundamental atomic dataset enters or leaves the rolling window time frame, then the corresponding attributes Σcycle time, Σ(cycle time)², and STDEV are updated as illustrated.
The algorithm as presented in FIG. 13 can also be used to correct erroneously calculated attributes of the span aggregation methodology of the present invention.
For example, if a fundamental atomic dataset (FADS) contains erroneous information due to a wrong raw dataset, this erroneous information is further propagated to the RTADS layer. For correction, the erroneous information has to be removed from the RTADS layer (usually performing a subtraction or the opposite mathematical operation used for updates).
After correcting the aforementioned FADS, the new information can be added to the aggregation layer, thus making a recalculation of the whole period obsolete.

FIG. 14 shows schematic representation of the system of the present invention, comprising one or more OLTP.

FIG. 14.1 is a schematic representation of the system of the present invention, comprising one or more OLTP (online transaction processing) system(s) as data source(s), an ETL (extract, transform and load) layer, a RDBMS (relational data base management system) for data storage. The OLAP (online analytical processing) engine is part of the presentation layer, through which users perform OLAP analyses. Usually, the analysis of data is extended by a MOLAP (multidimensional online analytical processing) system (not presented in the drawing).

FIG. 14.2 represents an alternative of FIG. 14.1, where the transformation (BADS-layer into FADS layer) and aggregation (FADS layer into RTADS-layer) is one entity (real time transformation and aggregation engine).

FIG. 15 is a schematic representation of an exemplary embodiment of the system of the present invention, showing the major components.
The staging area service may for example be deployed on separate staging area server. The aggregation service may for example be deployed on a separate aggregation server. The Real-Time DBMS may for example be deployed on a separate server. Also the OLAP server may for example be deployed on a separate Server.

FIG. 16 is a schematic block diagram of the illustrative embodiment, as shown in FIG. 1, showing its primary components, namely (i) an ETL interface for receiving basic atomic datasets (BADSs) from the ETL-layer, (ii) a configuration manager for managing the operations of the BADS-layer, the ETL interface, and the ETL data loader, (iii) a transformation and aggregation engine (TAE), (iv) a MDDB handler for storing/retrieving multidimensional data (RTADS-layer) in/from the (v) multi-dimensional data base (MDDB), (vi) a request analyzer for receiving requests from the OLAP clients, cooperating with the transformation and aggregation engine and the MDDB handler especially to calculate performance indicators and the like, on sparsely distributed data and returning the requested data back to the OLAP clients, (vi) an aggregation client interface, (vii) a configuration manager for managing the operation of the request analyzer and the aggregation client interface.

FIG. 17 shows a schematic diagram of an exemplary embodiment of the Real-Time information system. Input/output devices are for example PCs, monitors, keyboards, printers, tablets, smartphones, etc.

### DETAILED DESCRIPTION OF THE INVENTION

In particular, the present invention pertains to the following items:
1. A method for operating a data processing system, comprising data structures, transformation and aggregation processes and corresponding multidimensional databases, characterized in that the transformation and aggregation is based on homomorphic processing, which is grounded on a linear decompositional base system model, wherein said linear decompositional base system model preserves the linearity of the data structures.
2. The method according to item 1, wherein said method enables Real-Time information processing.
3. The method according to any one of items 1 or 2, comprising a base data structure and a corresponding layering, comprising a basic atomic dataset (BADS) layer, fundamental atomic datasets (FADS) layer, Real-Time aggregated dataset (RTADS) layer and a Real-Time OLAP (RTOLAP) layer, wherein said layers are constituted by one or more linear spaces.
4. The method according to item 3, wherein Information Functions are providing calculated information, based on aggregations and/or compositions of said data sets on said layers.
5. The method according to item 4, wherein Information Functions are providing calculated information, based on multiple aggregations and/or compositions of said datasets on said layers.
6. The method according to item 4 or 5, wherein said Information Functions have a three-fold structure, consisting of
   (i) the name,
   (ii) the definition, and
   (iii) the formula and/or algorithm to compute the Information Function.
7. The method according to any one of items of items 1 to 6, comprising Real-Time transformation and aggregation processes based on data components, such as BADSs, FADSs, RTADSs, RTOLAPs, and corresponding Information Functions, wherein the raw data, which are loaded from the data sources, are transformed, aggregated and further processed in at least one information system.
8. The method according to item 7, wherein said at least one information system is deployed on data management systems, such as relational databases or other database management systems, including non-relational databases.
9. The method according to item 7 or 8, wherein said Real-Time aggregation processes are based on continuous component-wise transformations and aggregations within the linear space.
10. The method according to any one of items 7 to 9, wherein said Real-Time aggregation processes are enabled as soon as the corresponding raw data enters the at least one information system.
11. The method according to any one of items 4 to 10, wherein the representations of the Information Functions, including e.g. statistical functions, are adapted and/or transformed such that linearity is achieved.
12. The method according to item 11, wherein the adaption and/or transformation of the Information Functions includes rules and mechanisms in terms of mathematical functions, wherein the adaption and/or transformation is enabled by the structure-immanent linearity of any Information Function.
13. The method according to any of items 4 to 12, wherein the Information Functions are materialized as performance indicators.
14. The method according to any one of items 3 to 13, comprising homomorphic maps from the fundamental atomic dataset layer (FADS layer) into the Real-Time aggregated dataset layer (RTADS-layer), wherein the linearity of the underlying layers is preserved.
15. The method according to any one of items 7 to 14, comprising a continuous transformation and aggregation strategy.
16. The method according to item 15, wherein all operations and/or data manipulations are performed using said continuous transformation and aggregation strategy.
17. The method according to item 15 or 16, wherein the amount of memory needed for computation is minimum.
18. The method according to item 15 or 16, wherein the amount of resources required for storage and/or retrieval operations (e.g. hard disk, SDDs, etc.) and the associated I/O requirements are minimum.
19. The method according to item 15 or 16, wherein the CPU usage needed for computation is minimal, including the usage of multiple CPUs and CPU cores.
20. The method according to item 19, wherein all operations and/or data manipulations map to desired computer instruction sets and/or operations and/or to other infrastructure components (e.g. databases, middleware, computer hardware and the like).
21. The method according to item 20, wherein the resource usages are further minimized, wherein calculated values of sparse data or values, which are only needed sporadically, are calculated on demand.
22. The method according to item 21, further comprising an interface to an OLAP server, wherein a Real-Time OLAP system, a Real-Time Data Mart and/or the like is realized, wherein the OLAP system(s) and Data Mart(s) are freed from performing aggregation operations.
23. The method of item 22, providing an interface to OLAP systems (e.g. MOLAP, ROLAP, HOLAP) and further client systems, which may connect to said OLAP systems to provide Real-Time OLAP analysis functionality as requested by the user through the client system.
24. The method of item 23, comprising a higher degree of flexibility than classical ROLAP or MOLAP technology, due to the possibility of flexible data grouping, wherein ROLAP structures are bound to a hierarchical tree model.
25. The method of item 22, providing an interface to Data Marts and client systems, which may connect to said Data Marts to provide Real-Time analysis functionality as requested by the user through the client system.
26. The method of item 9, comprising an interface to a client, which may connect to the base informational structure of the system (BADS s, FADS s, RTADSs, RTOLAPs), and which enables the client to process ad-hoc analysis in Real Time, based on the structurally immanent Real-Time capability and fast feedback of the system, wherein said ad-hoc analysis consists of the capability to define and execute unplanned queries against the data store (such as SQL queries and the like), including the capability to create newly composed structures out of the existing structures and apply further transformations and/or aggregations via corresponding Information Functions such as performance indicators; and including the capability to store and manage the newly derived information.
27. The method of item 26, comprising a base informational structure to support and enable Real Time knowledge discovery in databases (KDD), based on the structurally immanent Real-Time capability and fast feedback of the system, and including a data catalog functionality in order to search, prepare and select all required data types for further KDD analysis, wherein said KDD consists of the capability to define and execute data mining functions against the data store (e.g. using data mining tools such as RapidMiner, WEKA, and the like), and including the capability for the desired preparation process, as well as the further interpretation of the results, via corresponding Information Functions, such as performance indicators.
28. A computer program product adapted to perform the method according to any one of items 1 to 27.
29. The computer program product according to item 28, comprising software code to perform the method according to any one of items 1 to 27.
30. The computer program product according to item 28 or 29 comprising software code to perform the method according to any one of items 1 to 27, when executed on a data processing apparatus.
31. A computer-readable storage medium comprising a computer program product adapted to perform the method according to any one of items 1 to 27.
32. The computer-readable storage medium according to item 31, which is a non-transitory computer-readable storage medium.
33. The computer-readable storage medium according to item 31 or 32, coupled to one or more processors and having instructions stored thereon, which—when executed by the one or more processors—cause the one or more processors to perform operations for providing at least one transformation and aggregation process and corresponding grouped, multidimensional datastore process.
34. The computer-readable storage medium according to item 33, wherein said transformation and aggregation is based on homomorphic processing, which is grounded on a linear decompositional base system model and thereby preserves the linearity of the underlying data structures.
35. The computer-readable storage medium according to item 34, which enables Real-Time information processing.
36. A data processing system comprising means for carrying out the method according to any of items 1 to 27.
37. The data processing system according to item 36, comprising a computing device and a computer-readable storage device coupled to the computing device and having instructions stored thereon, which—when executed by the one or more processors—cause the one or more processors to perform operations for providing at least one transformation and aggregation process and corresponding grouped, multidimensional datastore process.
38. The data processing system according to item 37, wherein said transformation and aggregation is based on homomorphic processing, which is grounded on a linear decompositional base system model and thereby preserves the linearity of the underlying data structures.
39. The data processing system according to item 38, which enables Real-Time information processing.
40. The data processing system according to any one of items 36 to 39, comprising an aggregation server and a transformation and aggregation engine, wherein the transformation and aggregation engine supports high-performance aggregation (such as data roll-up) processes to maximize query performance of large data volumes and/or to reduce the time of ad-hoc interrogations.
41. The data processing system according to any one of items 36 to 39, comprising scalable aggregation server and a transformation and aggregation engine, wherein the transformation and aggregation engine distributes the aggregation process uniformly over the entire data loading period.
42. The data processing system according to item 41, which enables an optimized usage of all server components (e.g. CPUs, Memory, Disks, etc.).
43. The data processing system according to any one of items 36 to 39, comprising a scalable aggregation server for use in OLAP operations, wherein the scalability of the aggregation server enables the speed of the aggregation processes carried out therewithin is substantially increased by distributing the computationally intensive tasks associated with the data aggregation among multiple processors.
44. The data processing system according to any one of items 36 to 39, comprising a scalable aggregation server with a uniform load balancing among processors for high efficiency and best performance, wherein said scalability is achieved by adding processors.
45. The data processing system according to any one of items 41 to 44, wherein said scalable aggregation server supports OLAP systems (including MOLAP, ROLAP) with improved aggregation capabilities and similar system architecture.
46. The data processing system according to any one of items 41 to 44, wherein said scalable aggregation server is used as a complementary aggregation plug-in to existing OLAP (including MOLAP, ROLAP) and similar system architectures.
47. The data processing system according to any one of items 41 to 46, wherein said scalable aggregation server uses the continuous Real-Time aggregation method according to any one of items 2 to 27.
48. The data processing system according to any one of items 41 to 47, comprising an integrated MDDB and aggregation engine and which carries out full pre-aggregation and/or on-demand aggregation processes within the MDDB on the RTADS layer.
49. The data processing system according to any one of items 41 to 48, comprising a scalable aggregation engine, which replaces the batch-type aggregations by uniformly distributed continuous Real-Time aggregation.
50. The data processing system according to any one of items 36 to 49 for transforming large-scale aggregation into continuous Real-Time aggregation, wherein a significant increase in the overall system performance (e.g. decreased aggregation and/or computation time) is achieved and/or overall energy consumption is reduced and/or new functionalities at the same time are enabled.

More preferably, regarding the method of the present invention, the present invention pertains to the following items:
1. A method for operating a data processing system comprising data structures, transformation and aggregation processes and corresponding grouped, multidimensional datastores, wherein the transformation and aggregation is based on isomorphic and homomorphic processing, and so preserving the linearity of the underlying structures and the correspondence to the system(s) and data to be informed on and/or reported, which is grounded on a linear decompositional base system model, and so enabling best performing, Real-Time information processing.
2. The method of item 1, further comprising a base data structure, including basic atomic datasets (BADSs), fundamental atomic datasets (FADSs), Real-Time aggregated datasets (RTADSs), whereas the datasets are enfolding a linear space; and in more detail Key Performance Indicators (KPIs) and the like are kept as part of RTADSs.
3. The method of item 2, further comprising a Real-Time transformation and aggregation mechanisms based on data components (such as BADSs, FADSs, RTADSs) such that the raw data (loaded from the data sources) is transformed and aggregated in the information system in its components within the linear space, wherein such information system persisted in data management systems, like relational databases or other database management systems (including non-relational databases).
4. The method of item 3, further comprising a Real-Time aggregation mechanism as based on continuous component-wise (or small data portions) transformations and aggregations within the linear space, as soon as the data is loaded into the information system.
5. The method of item 4, further comprising the strategy of adapting/modifying the formulas for the KPIs and the like (including non-linear functions in the usual sense; for example calculation of the mean absolute deviation), such that linearity of the underlying layers can be achieved, including rules and mechanism in terms of mathematical functions like summation and the like, including statistical functions and the like, whereas the strategy is enabled by structure-immanent linearity of KPIs and the like.
6. The method of item 5, further comprising a homomorphic (i.e. linear) map from the fundamental atomic data layer (FAD-layer) into the Real-Time aggregated data layer (RTAD-layer) thus preserving the linearity of the underlying layers and hence enabling the roll-up capability of the aggregation.
7. The method of item 6, further comprising a continuous transformation and aggregation strategy such that the amount of memory needed for computation is minimal, such that all subsequent operations/data manipulations are performed within desired amounts of data (and thus associated storage requirements), whereas the amount of data is given by the size and number of data components which are processed in conjunction during data transformation and aggregation.
8. The method of item 6, further comprising a continuous transformation and aggregation 3 0 strategy such that the resources as required by storage/retrieve operations (such as disk access) needed for computation are minimal, such that all subsequent storage and retrieval operations are performed with desired data components (such that data is aggregated and stored continuously; retrieving large amounts of data is not any more necessary).
9. The method of item 6, further comprising a continuous transformation and aggregation strategy such that the CPU usage needed for computation is minimal, such that all subsequent data manipulations map directly and/or indirectly to desired computer instruction sets/operations and/or to other infrastructure components (like databases, middleware, computer hardware and the like).
10. The method of item 9, further comprising a continuous transformation and aggregation strategy such that the resource usage are further minimized, such that calculated values of spare data or values which are only needed sporadically are calculated on demand.
11. The method of item 10, further comprising an interface to an OLAP server, so thereby realize a Real-Time OLAP system, a Real-Time Data Mart and the like capable of performing continuous aggregation operations.
12. The method of item 11, providing an interface to OLAP systems (MOLAP, ROLAP, HOLAP, and the like) and client systems which may connect to the said OLAP systems to provide Real-Time OLAP analysis functionality as requested by the user through the client system, and storing and managing such data.
13. The method of item 11, providing an interface to Data Marts and client systems which may connect to the said Data Mart systems to provide Real-Time analysis functionality as requested by the user through the client system, and storing and managing such data.
14. The method of item 12, comprising a higher degree of flexibility then classical ROLAP or MOLAP technology, such that no limits on the possibility of flexible data grouping are made, whereas ROLAP structures are bound to a hierarchical tree model. The aforementioned flexibility arises from the linear structure of the underlying components.
15. The method of item 10, further comprising an interface to a client system, which may connect to the base informational structure of the system (BADSs, FADSs, RTADSs), and which enables the client system to process ad-hoc analysis in Real Time, based on the structurally immanent Real-Time capability and fast feedback of the system, whereas such ad-hoc analysis consists of the capability to define and execute unplanned queries against the data store (such as SQL queries and the like), including the capability to create derived new composed structures out of the existing structures and apply further transformations/aggregations; and including the capability to store and manage the newly derived information.
16. The method of item 15, further comprising a base informational structure to support and enable Real Time knowledge discovery in databases (KDD), based on the structurally immanent Real-Time capability and fast feedback of the system, and including a data catalog functionality in order to search, prepare and select all required data types for further KDD analysis, wherein such KDD consists of the capability to define and execute data mining functions against the data store (using data mining tools as RapidMiner, WEKA and the like), and including the capability for the desired preparation process, as well as the further interpretation of the results.

Advantages of the Embodiments of the Present Invention: Minimal Descriptional Model and Minimal Algorithmic Effort

It is to note that the invention supports a paradigm shift from a more subjectively oriented kind of “artwork strategy” in software engineering towards an objectively grounded methodological approach, enabling objectively-anchored best solutions to customers.

Business processes, and in more detail, know-how intensive manufacturing processes are seen as important characteristics of complex systems. Some authors are defining manufacturing complexity as separated into two constituents, static and dynamic complexity (Gabriel, 2008). The static complexity represents the factory structure, number of products, number of machines, and length/grades of interlinkedness of production routes. Dynamic complexity represents the uncertainty of the system, due to the appearance of unpredictable events (machine breakdowns, products faults or malfunctions, etc.). Performance indicators (or similar measures) represent the healthiness or goodness of the manufacturing process. More general, an explication of “complex systems” has been given by Simon (Simon, 1962). He gave focus to the pragmatic approach, that complex systems are made up of large number of parts (which might be made of simple elements or more complicated machines), which interact in a non-simple way. Simon emphasizes on hierarchical systems as prime candidates for complex systems, built within a decompositional architecture. In more detail, Ladyman (Ladyman, 2013)—while relying on Simon—points on the statistical dimension, which characterizes complex systems. He concludes that complex systems must possess some records of their past, incorporating and displaying the diverse range of the complex systems behavior over time.

Accordingly, the concept of performance parameters (or similar kinds of system descriptions) provides a conceive description of the behavior over time of a complex system. It is a further embodiment of the present invention that the concept of a general Information Function pertains to linear spaces, which enable straightforward description and highly effective and computability of complex systems. Advantageously, this system description enables minimal algorithmic effort, in order to calculate such kind of performance indicators and the like (being materializations of Information Functions). This is of special interest because typically the minimum description length of an algorithm cannot be computed (the minimum description length is equal to the so-called Kolmogorov complexity). From the perspective of software engineering, Campani and Menezes (Campani and Menezes, 2004) are arguing that during the process of software development the goal is to identify the program with the shortest length (and highest effectiveness), which is equal to the Kolmogorov complexity. It should be noted that Kolmogorov complexity cannot be computed and software projects typically may suffer from prolongations and unpredictability (and may include important amounts of heuristics and experiments (Hansen and Yu, 2001). Other authors (Faloutsos, Megalooikonomou, 2007) argue that for similar reasons data mining (and Data Warehousing) will always be an art. Computer science theories are still to be seen as insufficient in order to enable and facilitate software engineering in a coherent and complete manner, unlike physics or electrical engineering (Sommerville, 2010).

According to the present invention and contrary to the aforementioned opinions in the prior art—data mining and Data Warehousing dispense the aforementioned unpredictability, the need for heuristics and experiments and evolve towards systems, which are simple to design, are easy controllable and reliable. Based on the systems and methods of the present invention, the transition of such systems from art to systems, which can be designed by straightforward scientific and technological means, is now becoming a reality.

The present invention is built on the fundaments of a stable minimum-description model of the overall problem domain area (Real-Time information systems, including Data Warehousing). The invented levels of abstraction materialize this foundation (basic atomic dataset (BADS) layer; fundamental atomic dataset (FADS) layer; Real-Time aggregated dataset (RTADS) layer; Real-Time OLAP (RTOLAP) layer. In particular, this structure represents the minimum description length and/or minimum algorithmic effort—as grounded on linear information spaces—by immanent evidence. Prior art solutions do not rely on such a conceptual anchoring; prior art solutions are practically, and conceptually inadequate in order to approach the claimed optimality of the present invention.

The model of the present invention has been designed by inherent evidence—grounded on the decompositional model—and pertains to linear spaces of information, which incorporates highest algorithmic effectiveness of the Information Functions by mathematical evidence.

The present invention is based on a fundamental approach, which puts the basic design of the system model into the foreground, and for this reason circumvents or minimizes the problems that the algorithmic effort and algorithmic complexity cannot be objectively estimated, as reported by Lewis (Lewis, 2001). In contrast, the model and functionality of the present invention is—through the specification of Information Functions—evidently close to any kind of additionally required coding, whereas the problems as reported by Lewis typically appear during phases of complex coding. According to the present invention, algorithmic complexity is reduced to a mathematically grounded minimum and due to the detailed specification of the methodological approach, avoids and circumvents such problems.

In particular, Lewis is arguing that software estimation, i.e. the estimation of development schedules and the assessment of productivity and quality, is a formal process, hence an algorithm. Then, because the optimality of an algorithm cannot be judged algorithmically and/or objectively, Lewis concludes that software estimation cannot be judged objectively. In contrast, the goal of the methodology of the present invention is not the identification of the program incorporating the shortest code. The goal is to identify the model, which represents the most effective structure, including necessary and sufficient correspondences to the real-world model, and necessary and sufficient correspondences to computing systems. This correspondence cannot be built via a formal process or an algorithm. It is built through the process of acquiring new knowledge, which, by evidence, builds an inherent correspondence between a clear mathematical and/or physical description of the real-world model and methodologically incorporated rules, in order to design optimal systems and solutions.

Accordingly, the present invention pertains to a system and methodology, which enables system specification and development of highest effectiveness, within a context of highest industrialization, delivering the required robustness, adaptability, extendibility and maintainability of the corresponding solutions.

The linearity of the aforementioned information spaces offer very important and advantageous properties, because any data component can be processed independently and enables insofar the desired Real-Time capability of the overall system. For this reason, any further information on such data components—all performance indicators, KPIs and the like are calculated based on such singular atomic data components—can be calculated in Real Time. The decompositional base system model is consistently defining linear information spaces, without loss of any information, and preserving the capability of integrating such information across the whole business and/or industrial process, including financial processes, and the like as well. The concept of hierarchical system decomposition includes the capability of chaining and hierarchically nesting such base systems, while preserving the linearity of the informational spaces.

The ensemble made of adequate decompositional system models and corresponding historical records are of particular importance. This concept is now consistently mapped to the deep structure of the system of the present invention (i.e. foundational ontology of information systems as introduced by Wand and Weber, 1995), and to the Information Functions. Information is created out of the knowledge of the base system model and further analysis based on corresponding historical records. Such further analysis is done via Information Functions. To conclude, the claimed information system holds in its overall composition an immanent structure of a linear model (linear information spaces). It is important to note, that these linear structures also hold true, if the real-world system shows nondeterministic behavior. In fact, all target systems which are within the scope of the present invention (production systems, business systems, etc.) are showing such a nondeterministic behavior. It is therefore of high interest, to include all kind of data into further analysis (which creates one of the reasons for the rapid growth of so-called “Big Data”, and ever expanding historical records).

Thus, in a most preferred embodiment of the present invention, linear Information Functions are linear maps and as such preserve the structure of the underlying linear spaces. This includes also reports and/or information about non-deterministic systems. For example, a weather report might be made of a timely sequence of the evolution of performance indicators of the weather, like temperatures, wind directions, amount of rain, snow, and other indicators. The same holds true for production systems, with regard to the actual flow of material. Wand and Weber (1995) already concluded a homomorphism between the real-world and the information system. This includes the decomposition model, in order to adequately represent the real-world system (which indicates the level of granularity regarding the historical records). It is known that different kinds of applications or systems, which might act as input sources for the present invention, may have different, maybe also inconsistent and/or conflicting data models. For example, the term “capacity” is often used to measure the load volume of stockers or shelf, but is also used to measure the throughput of production systems. Nevertheless, the present invention relates to the existence of fundamental, non-conflicting data categories. Those data categories, i.e. basic atomic datasets (BADSs), hold the described isomorphic relationship (i.e. mapping) to the production model, or business model.

Nondeterministic behavior appears while unplanned, spontaneous events are introduced to the system. But any nondeterministic behavior is consistently and without any loss of information kept in the historical records of the basic atomic atasets BADSs, which create the entry-point for the claimed linear information spaces. Additionally, another homomorphism exists between BADSs, and the fundamental atomic datasets (FADSs), between FADSs and the Real-Time aggregated datasets (RTADSs) respectively. The aforementioned homomorphisms do not necessarily define bijective (i.e. one-to-one) mappings, as summarization techniques are applied.

Especially, the present invention is grounded on the design of linear information spaces, in order to support and enable immanent Real-Time capability and corresponding optimized and advantageous system design, embodiments and further system deployment. It has been shown that the linearity of the described information spaces hold an ontologically grounded fundamental structure. The present invention supports also the definition and execution of ad-hoc queries and system interrogation, which are composed out of newly analyzed interrelations between existing data structures, and incorporates for this reason an open system structure The present invention also enables steps toward the creation of further relationships, including nonlinear analytics. In more detail, systems are characterized as nonlinear, if the relationship system parameters, which are describing the behavior of a system, are nonlinear. For example, the throughput of a fluid which leaves a container through a hole is (see Ottens, 2008):

Thₑₓ=C\sqrt{h(t)}
wherein C is a constant depending on the cross section, outflow and the gravitation; h(t) is the height of the fluid in the container as a time dependent function.

Nevertheless, the system behaves deterministically. Practically, zones of linearity may be discovered, in order to linearize the system. Yet another approach is, to calculate the parameter at the required points in time (online). Such kinds of calculations are done by APC tools (advanced process control). For further analysis, it might be required to store such calculated setup parameter, in order to support further, for example statistical analysis on such parameter. For this purpose, such kind of parameter will be handled as a performance indicator.

For example, a process parameter such as “etching time” may be calculated out of a dependent parameter, which might be dedicated to another process step (for example a measurement step). Another example is the lithography process in semiconductor industry. Within this example, process control parameters may depend on multiple other parameters (for example EDC parameters/engineering data collection; typically such parameter are collected during measurement operations). Optimized process setup information of a subsequent batch of semiconductor wafers to be processed are calculated during processing time by averaging correction values over a number of previously calculated correction values, as for example disclosed in US2002012861. The process setup parameters are stored within the manufacturing system (may be within a component of a manufacturing execution system). All such parameters can be stored as performance indicators and will be included in the data collection and aggregation process. Subsequently, the current invention supports more complex and sophisticated analysis regarding possible dependencies of those parameters (for example using statistical capabilities of the present invention). The same holds true for possible comparisons and further evaluations of other kinds of quality indicators. Another example is the comparison between statistical process parameters (including engineering data collection parameters, APC capabilities/advanced process control parameters, and the like). Those quality related indicators may be defined as KPIs, and will be considered for this reason within the present invention.

Accordingly, the “Information Function” as further described herein is inherently corresponding to the described deep structure of the information system. The system of the invention is holding an open structure, which is also required in order to support the claimed knowledge creation capability.

In particular, the application domain of the present invention is anchoring its fundamental data structures within an analysis of the linearity of information and subsequently within the design of a linear information space. Additionally, such fundamental characteristics imply highest benefits, because it supports the design, implementation and maintaining process of adequate computing architectures and systems. The linearity of the overall system allows consistent decomposition and high parallelization of a desired system design with regard to its principal business requirements.

For example, the linear system structure implements the capability to support the design of an adequate desired target system as a) a safety-critical system, b) a mission-critical system, or even c) a business-critical system (“criticality” is used herein is as defined by Sommerville, 2010). And even additionally, the linear system structure, which is anchored in real-world system structures implements the desired Real-Time capability of the present invention by immanent evidence.

This is enabled by two main reasons: Firstly, the proposed structure guarantees and enables an adequate information system design based on fundamental structuring, which pertains to a minimal system description (conceptual simplicity) of high correspondence and meaning with regard to the real-world system. This model and/or description is as precise as possible and easy-to-understand at the same time, and is open for user-implemented structuring and supports knowledge discovery in databases. And secondly, based on the linear structure, such system model can be mapped in the simplest manner to desired computing architectures. The desired Real-Time system behavior will be achieved, because the linear structure holds an immanent, built-in capability for highest system parallelization. The overall system may be decomposed into logically independent subsystems; further executions are becoming parallelizable and distributable within modern computing architectures as desired (in one or as much as desired computing instances).

Accordingly, the current approach creates its uniqueness out of a consistent and comprehensive mapping of real-world structures towards a linear information space, which enables and guarantees highly simplified system design, highest system performance and highest system reliability. For this reason the present invention supports information system and/or Data Warehouse system design in terms of supporting and enabling the requested level of business criticality, which is further based on following characteristics: reliability, performance, safety, security, availability, maintainability (as defined by Sommerville, 2010).

Based on the decompositional system model and the corresponding deep structure of the model, the fundaments are laid down for the claimed method and system of Real-Time information system/Real-Time Data Warehousing, as follows:

Let S and V be sets.

Let I:S→V be an Information Function defined on S with values in V.

Set F:={0,1}. Then F is a field (with the usual addition and multiplication).

Let <(S, ⊕, )> and <(V, ⊕, )> be vector spaces over F generated by S and V, such that the addition/multiplication are not necessarily defined in the same way on S and V respectively. Instead of F, any arbitrary field could have been chosen for the definition above.

An example for the Information Function/may be the cardinality (the SUM) of a set of chairs. Another example is the total production time of a product, whereas this time is calculated as the SUM of the process times of all process steps required to manufacture a product.

Let s, s₁, s₂ ∈ S. According to the definition of homomorphic maps between vector spaces, the linearity of the Information Function/is satisfied if and only if:

I(s₁ ⊕ s₂)=I(s₁) ⊕ I(s₂)

I(as)=aI(s)

Accordingly, any kind of aggregate functionality will be methodologically conceptualized as a composition of the corresponding data components.

As an example: The total value of the production time of a product is the (mathematical) sum of the single values of the production time (based on fundamental atomic datasets considering the corresponding data components), which have been used to manufacture the product. Prior art systems and method are unsatisfactory because such fundamental basement has not been recognized and constantly conceptualized. As a result, prior art systems suffer from unmotivated complexity and systematic imperfection.

It is to note that such an Information Function may be carried out any point in time. More specifically, the present invention relates to predefined performance indicators or ad-hoc defined data aggregates. In a preferred embodiment, the system and method of the present invention enables to execute any Information Function using minimal calculations steps, while the system efficiency gets maximized. Systems and methods of prior art usually uses more complex processes for aggregation (batch mode). Hence, the present invention enables and supports tremendously improved performance and functionality over previous art by inherent design and technology improvements.

It is not an object of the present invention to work on the definitions and further clarifications of such indicators. Instead, the present invention provides a mathematical analysis of the immanent structure of such indicators, which delivers the isomorphic relationship between the business process(es) to be reported on and the system model.

Performance indicators (and as aforementioned other kinds of aggregated data and reports, including support for ad-hoc interrogation and knowledge discovery in database) may be calculated through business intelligence (BI) aggregation processes. Those processes are typically running while the number of active users is at its minimum (i.e. during night shift). They may also be calculated within specific application domains. For example, certain KPIs may be calculated within a MES. But in such cases, such domain-specific KPIs may not contain information or relations regarding other domains. For example, the actual production state of a product may not hold any information about the financial creditworthiness of a customer. Consequently, there is a growing demand to provide KPI information from within an integrative perspective, supporting flexible aggregation capability on multiple levels and between different domains. This includes as well the capability for additional comprehensive and ad-hoc information requests.

In a preferred embodiment, the present invention supports and enables the Real-Time calculation of performance indicators and the like, including ad-hoc defined data aggregates and the like.

In a further preferred embodiment of the present invention, the values of such performance indicators (KPIs) and the like may be calculated at any point in time, which offers many advantages:
(i) the availability of up-to-date values of such KPIs at any point in time;
(ii) minimized usage of resources/energy through a new system model;
(iii) highest performance to calculate such KPIs and the like;
(iv) support for complex and high performant ad-hoc interrogations;
(v) support for knowledge discovery in databases and more generally for the creation of new information.

Knowledge discovery in databases becomes especially possible due to the high performance and flexibility of the present method and system.

The present invention further relates to a method and system with regard to the defined Information Function, including calculation of performance indicators and the like. In a preferred embodiment, the present invention relates to use of method and system of the invention for all sets or aggregates of data. This includes the required support for the growing demand of ad-hoc interrogations to systems, which deal with the management of data. This demand is also growing, because the volume of data, which is produced, is continuously growing. Typically, performance indicators and the like are calculated during off-hours of the business. But this does not supply data values of a performance indicator for example during the business day. The current invention fully supports continuously aggregated and hence up-to-date values of performance indicators and the like, and also the capability for highly performant ad-hoc interrogations and queries to the system.

The present invention further relates to a system and method for including non-linear (in the usual sense) properties and functions.

In a further preferred embodiment, the present invention covers a higher degree of flexibility than classical ROLAP or MOLAP technology. The present invention makes no limits on the possibility of flexible data grouping, whereas MOLAP structures are bound to a hierarchical tree model.

The system and method of the invention is not restricted to the usage of specific computer hardware or computer infrastructure (including database systems and the like). Typically, KPIs and similar aggregated values may be managed by and calculated by different data management systems (relational/No-SQL databases, column or row oriented databases, in-memory databases, and other systems). The present invention is applicable to all systems, which support the management of sets of data, and which support the required Information Functions.

There are several challenges, which are arising from exponentially growing data volumes and the constantly increasing need for timely and accurate business intelligence solutions, which cannot be met by currently existing Data Warehousing systems.

In addition to keeping scheduled BI and ETL processes running smoothly, IT staff is regularly asked to provide unplanned reports that are vital for supporting business decisions. Scheduling these just-in-time reports is a complex process that not only consumes IT staff time, but can also interfere with the successful execution of regularly scheduled production workflows. The biggest challenge, when scheduling BI and ETL jobs is achieving error-free, end-to-end integration between the processes that are distributed throughout the enterprise that supply the necessary data (Cisco white paper). Based on such problems, improvements have been made in system automation and survey and management of dependencies between for example the BI level and/or jobs and the ETL level and/or jobs, respectively. Such solution design has become necessary, because the as of today existing systems and methods do not provide the required Real-Time capability for calculating KPIs and the like.

“Today's integration project teams face the daunting challenge that, while data volumes are exponentially growing, the need for timely and accurate business intelligence is also constantly increasing. Today's businesses demand information that is as fresh as possible. At the same time the concept of business hours is vanishing for a global enterprise, as Data Warehouses are in use 24 hours a day, 365 days a year. This means that the traditional nightly batch windows are becoming harder to accommodate, and interrupting or slowing down sources is not acceptable at any time during the day.” (An Oracle White Paper “Best Practices for Real-time Data Warehousing”). According to this paper, Oracle proposes a technique which tries to enable Real-Time or near-Real-Time data aggregation. But Oracle stays in the classical architectural concepts, and does not conceptualize linear base data structures, and corresponding isomorphic transformations and homomorphic aggregations. In more detail, Oracle's “Real-Time aggregation process” does not capture the component based continuous calculation of KPIs of the current invention. Also the concept of “Real-Time reporting” includes—according to the present invention—the possibility to display the Real-Time values of the KPIs and the like calculated as mentioned above. This possibility is missing in the prior art where Real-Time reporting is performed on raw data. The latency requirements for Real-Time reporting have to take into account the time needed for the additional calculation of the values of the KPIs and the like. Due to the techniques disclosed in the present invention, the time needed for Real-Time computation will not increase the loading time considerably.

According to Cisco, one of the biggest challenges facing an IT group is completing ETL processing and traditional batch-based BI jobs within the constraints of an ever-shrinking batch window. While there is a trend toward Real-Time BI, the vast majority of BI report generation today relies heavily on this “offline” window to complete these jobs. Under certain condition “nightly aggregation” may seem reasonable, since even in a 24×7 (24 hours per day and 7 days per week), production mode there is less strain on the BI systems at night than during the usual business hours. The reverse side of the medal is that IT staff has to provide the technical capabilities to start the “nightly aggregation routines” also during the “rush hours”. These procedures may crash or erroneous data may render the BI-reports unusable. In such cases, the aggregation routines have to be restarted as soon as the causes for the faulty behavior have been removed or the erroneous data has been rectified. The additional load should not affect the usual business processes by any means.

According to the present invention, aggregation and computation of the KPIs and the like are performed continuously over the loading period, usually 24×7. Hence, there are no performance peeks due to aggregation/computation. Also recalculation due to erroneous data affects only small portions of the aggregates and usually a subtraction followed by an addition can remedy the repercussion of erroneous atomic datasets on the aggregates. Furthermore, due to continuous aggregation and Real-Time reporting of the present invention, most of the misbehavior of the aggregation routines and data supply can be identified during the usual business hours or soon afterwards. Hence, remedy actions can be taken in a relatively longer period of time, avoiding the panic situations of the previous art.

Another pain point according to CISCO is the “service-level consistency”. Service-level agreements (SLAs) are the universal benchmark of successful IT performance. Usually, overall SLA performance slips a little each time an unforeseen problem halts a workflow and a job finishes late. According to the disclosures of the present invention, the routines that compute the KPIs and the like are substantially slimmer than their counterpart of the previous art. This is not only the result of a more direct algorithmic approach of the present invention, and it is also motivated through complex and hence error-prone effort to improve the performance of the previous art routines and keep their execution time within the batch window time constraints. Within the present invention the efforts necessary to fulfill the criteria of the SLAs are substantially reduced.

Furthermore, the heavy impact of ad-hoc queries on the system and database performance of the previous art will be substantially reduced according to the disclosures of the present invention. An ad-hoc query as defined above is an unplanned, improvised, on-the-fly interrogation responding to spur of the moment requirements, which has not yet been issued to the system before. It is created in order to get a new kind of information out of the system. The ad-hoc queries can cause unforeseeable and unpredictable heavy resource impact to the system, depending also on how skillful the query has been designed. Usually these ad-hoc queries are not prepared by highly skilled people in the art, and their influence on the overall system is not very well studied. A major reason for damaging system behavior may also be caused by the usual period aggregation mechanisms in prior art systems. Unplanned aggregations (for example restart of the nightly aggregation during the usual business hours) may also cause unplanned system load or even heavy system performance degradations, such that system administrators need to cleanup and recover the system. In general database systems are designed to overcome such kind of problems. But prior art Data Warehouses do not contain the fundamental data structures in the required and necessary immanent manner of the present invention, which by concept reduces such kinds of misbehavior.

The aforementioned disadvantageous situation can be overcome by the system and methodology of the present invention. The requirement for ad-hoc analysis is growing and needs to be supported in an adequate manner. According to the present invention, the concept of fundamental data structures dramatically reduces the aforementioned misbehavior, and makes the overall system controllable in the desired manner, at the same time supporting requirement for ad-hoc analysis. The present invention reduces or eliminates performance degradations, because the support for ad-hoc queries is done in a most advantageous manner by directly accessing fundamental atomic datasets or basic atomic datasets. As disclosed in the present invention, any kind of ad-hoc interrogation becomes smoothly executable, since most of the information is already available.

Data Warehouse like systems require explicit data aggregation mechanisms. For example, the cycle time of a product is calculated adding up the cycle times of the single process steps. This is typically done through an analysis of the historical entries of the production process (products, process steps, equipments, quality data, timestamps, and the like). But, based on the aforementioned explications, any Information Function delivers an aggregated value of certain data components.

Within the context of the present invention, timely aggregations are of specific importance. As a consequence, up-to-date values of such performance indicators can be calculated in Real Time with regard to the introduced decompositional system model. A major application domain with regard to the present invention is made of discrete-time systems. For example: in manufacturing, the production process may be characterized as a discrete-time system (having single process step as a time-discrete elements). Then, within each discrete-time slice, the value of any performance indicator and the like is calculated according to the corresponding definition (example: the cycle time of the single process step is defined by the sum of the waiting times and the raw process times). As a consequence, complete and consistent information about the value of any aggregated performance indicator with regard to a predefined period is already available throughout the whole aggregation period at any point in time.

For example, let F be an Information Function—materialized as a performance indicator—and let P:=[t_{S}, t_{E}] be a time interval on which continuous aggregation is to be performed. Then for any point in time t such that t_{S}<t≦t_{E} and thus for the time interval P′:=[t_{S},t], up-to-date values for F can be retrieved in Real Time. This means especially, that as soon as the period expires, the aggregates are already evaluated, making the classical batch aggregation (characteristic for the previous art) obsolete.

The same holds true for other systems too, because such systems and systems related processes have for quantification and algorithmization reasons always to be cut into smaller, discrete portions, which are finally executable by single steps of CPUs.

The datasets, which hold the finest granularity regarding the demands on data analysis, knowledge discovery in databases and unplanned reporting are termed “basic atomic datasets” (BADSs). Such BADS s are containing all the information which is required to calculate performance indicators. Within a next step, the information from the aforementioned BADS s is summarized and enhanced by new attributes in order to setup a new layer on which the calculation of the performance indicators is performed, termed “fundamental atomic datasets” (FADSs).

FADS s are defining the next level of detail—i.e. level of granularity—with regard to the foreseen reporting functionalities. The fundamental atomic datasets (FADSs) get enriched by corresponding quantitative and logistic data components, which are involved in further aggregation and the calculation of the performance indicator and the like, setting up this way the next level of detail, termed “Real-Time aggregated datasets” (RTADSs).

As an example for a FADS, it might be required to track the process-end timestamp of the previous step, and corresponding start-time/end-time of the current step, in order to calculate the cycle time of the current step [cycle time (step)=process-end time (step)−process-end time (previous step)]; process-start time might be required to calculate waiting times, etc. FADSs may be enriched by additional attributes (example: number of holds). A RTADS might contain as an example aggregated values of groups of process steps, products, technologies, factories, customers, budgets, etc.

Usually, performance indicators are calculated within the aggregation processes, but the present invention claims as well the capabilities of ad-hoc interrogations and knowledge discovery in databases with regard to the overall system model and structures.

Any business process can be subdivided into discrete/disjunct business process portions, whereas the outputs from one business process portion serves as input to forthcoming business process portions. Consequently, according to the present invention any business process can be consistently mapped to the above mentioned data structures.

According to the invention, the analyzed performance indicators induce a linear structure; and based on this discovered structure the Information Function is defined in its most advantageous and general meaning based on the linearity of the information as shown herein.

A manufacturing company may measure its performance by throughput and cost, a KPI of a service company is the mean time to handle a service call, etc. The preserved linearity of the overall system enables and guarantees that an up-to-date value of any performance measure or any aggregated value (as calculated by an Information Function) can be immediately calculated, and is based on up-to-date data of the ongoing portion of the business process and the like.

As an example, the current value of the cycle time of a product can be calculated based on actual information (measure) of the process, which is used to produce this product. This measure and calculus does not require any data about the value of this data at a preceding time interval or any other kind of dependency. Therefore, it is possible to create singular data portions, which are required for the calculation of performance indicators on any kind of business process levels (strategic, tactical operational). Singular data portions contain pre-calculated values—in its most advantageous representation—to be further aggregated, such that the calculation of the performance indicators relies on a restricted set of such data. In detail, this approach enables also to define and create ad-hocly any kind of additional indicator, and request ad-hocly and in Real Time actual values of such newly defined indicators. As aforementioned, this concept is applicable to any kind of business process (whether event based, time-discrete processes, or continuous processes or any other kind of business process and the like).

In prior art systems, the concept of linear information spaces and corresponding linear Information Function is not exploited. As a consequence, prior art systems fail to deliver and incorporate immanently structured functionalities, as required for the desired Real-Time capability of the overall system. Prior art systems are not based on a decompositional system model, grounded on the linearity of the overall system. That is, prior art system have to incorporate more complex handling—including logistical dependencies, or other dependencies with regard to the structure of business processes—during the treatment of data with regard to the reports on performance indicators. As an example, in prior art systems, those calculations and aggregations are typically done in batch procedures, which are started after the expiration of the corresponding aggregation periods. As another consequence, in prior art, pre-calculated values of performance indicators are not available throughout the course of the aggregation period. In conclusion, prior art systems mostly use complex, laborious, time-consuming and inefficient and hence error-prone aggregation routines.

As aforementioned, most of the performance indicators rely on SUM, MAX/MIN, avergae or similar aggregation functions. For example, the cycle time (CT) of a product is calculated by adding up the cycle times of the single (atomic) process steps. Prior art systems calculate for example the cycle time of a product after a predefined aggregation period, based on an analysis of the timestamps and/or other process flow information of the product. In contrast to the aforementioned prior art calculation methodology, the present invention (pre-) calculates any performance indicator throughout the entire course of the period under consideration for aggregation. And from then on, any kind of aggregation (including predefined reports) will be executable in most advantageous manner through simple mathematical functions (like SUM, MAX/MIN, average, but not restricted to).

Prior art systems, which claim Real-Time behavior, do not include immanently structured Real-Time calculation of performance indicators. Neither do they claim the above mentioned capability to execute those aggregations based on the linear spaces and linear Information Function.

To summarize, prior art systems fail to support the desired Real-Time capability of performance indicators. They fail also to support complex, multi-hierarchical ad-hoc functionalities for data aggregation. For example, a decision maker might require following ad-hoc analysis: a report about the timely evolution of the cycle times of all process steps of a factory, but with regard to a specific time frame (maybe somewhere in the past), and with regard to other selective information (logical combinations of product groups, measurement- and quality data, customer information, and the like). Today, prior art systems fail to deliver in Real Time specific, non-standard reports which have to evaluate important amount of data of different application domains.

Main reason for the failure of the prior systems and methods is that they do not address and eliminate the causal reasons of those insufficiencies. Based on the requirements to continuously support new incoming data volumes, the problem will continue to exist, and will even become bigger, because of the desired Real-Time capability of the overall system. The causal reason for the insufficiencies is due to the fundamental inadequacy of the structural model of such systems, as well as due to the processing methods.

Further Advantages of the Present Invention with Regard to Prior Art Including Beneficial Usage of Existing Technologies

It has to be noted that the present invention (in more detail the method of homomorphic computing) supports also deployment in MOLAP or ROLAP technology, or any other database management system (including the NoSQL technologies and the like), whereas data elements may be accessed, manipulated and updated.

Prior art aggregation techniques performed satisfactory if carried out during the night hours. Unfortunately, even one erroneous dataset could substantially falsify the reported values. In such cases, the aggregation procedures had to be restarted later, maybe during the usual business hours in order to provide the desired aggregates. As a consequence, additional hardware capacities are to be planned to support data aggregation during business hours; thus increasing power consumption. According to the technology used in the present invention a dataset can be corrected in Real Time very easily by subtracting the old value and adding the new value to the subtotal.

Prior art aggregation techniques benefitted from increased main memory to speed up aggregation time and reduce computational effort. According to the present invention, by reducing large-scale aggregation to continuous aggregation, practically the amount of the main memory needed is determined by the performance requirements of the reporting system, thus substantially reducing energy consumption.

Prior art aggregation techniques use highly performant rack systems for storage, having additional memory and sophisticated software for fast retrieval. According to the present invention, the data involved in the aggregation is already loaded in memory within the Real-Time ETL-cycle executions. Hence the storage system can be chosen based on the performance requirements of the reporting system, thus substantially reducing energy consumption.

In prior art systems, the nightly aggregation is the most resource consuming part of the overall activity. Hence, the hardware requirements are determined by the time constrains of the nightly aggregation. According to the present invention, the load of the continuous aggregation is uniformly distributed over the whole computational period, thus producing a constant load on the system. As a consequence, in accordance with the disclosures of the present invention, there are no high performance peaks during the night, but more or less a constant load during the entire production period. Hence, due to more or less evenly distributed load, the hardware requirements for the system can be determined more accurately, thus reducing the overall energy consumption.

In prior art systems, either the column store or the row store approach was more appropriate for aggregation. Typically, but not necessarily, column store is more advantageous for reporting purposes, while row store approach performs better for aggregation functionalities. While the present invention is reducing large-scale aggregation to continuous aggregation—and having the data for aggregates already in memory—both approaches may perform similarly. As a consequence, the user can within the context of specific projects and use cases assess on such technologies (including other technologies like in-memory solutions, or No-SQL solutions). More generally, the present invention supports usual software engineering processes.

### DETAILED DESCRIPTION OF THE INVENTION

The present invention is based on the concept of linear information spaces, which supports and enables a straightforward, nevertheless continuous, consistent and complete aggregation and calculation of the performance indicators (or any other kind of Information Function). In particular, according to the invention, such performance indicators (or other aggregates) are automatically kept up to date at any given point in time, due to the consistent mapping of all related information into the aforementioned linear spaces. As a consequence, any further aggregation and composition of data becomes achievable with minimum computational effort.

The information systems and methodology based on the present invention are built on following strategical framework and deep structure/fundamentally grounded multi-leveling:

I. Basic Atomic Dataset (BADS) Layer:

The basic atomic datasets represents the finest granularity of the data necessary for (unplanned) reporting or further analysis and knowledge discovery, and it is the finest granularity of the data as it is loaded (for example: from the staging area) into the information system (including Data Warehouses and the like). Most of the reports do not need this level of granularity, but in order to be able to provide ad-hoc reporting, this level of granularity should be included in the system. Planned reports usually use summarized information based on the basic atomic datasets.

II. Fundamental Atomic Dataset (FADS) Layer:

This layer represents summaries (content-wise grouping) of basic atomic datasets. They represent the finest logical entity used for reporting. This level of abstraction is called “fundamental atomic datasets” in order to distinguish it from the basic atomic datasets which represents the finest granularity of the data as it is loaded into the information system (including Data Warehouses and the like). The fundamental atomic datasets are extended by additional attributes to store pre-calculated data, which is used in further aggregation for the calculation of the performance indicators and the like. As an example, a new attribute “cycle time” will be defined as the difference of two points in time.

III. Real-Time Aggregated Dataset (RTADS) Layer:

RTADS represents a summary (grouping) of the fundamental atomic datasets according to the requirements of the Data Warehouse designers: Let t₁, t₂ be points in time, let P:=[t₁, t₂] be the period considered, for example a shift, a day, etc. According to the disclosures of the present invention, aggregation is done continuously, i.e. as soon as a fundamental atomic dataset is created and/or updated, partial values of the KPIs and the like corresponding to the aforementioned fundamental atomic dataset are calculated. Hence, according to the new technology as disclosed within this invention, partial values for the aforementioned KPIs and the like are calculated in Real Time and are valid for any t such that t₁<t≦t₂.

According to the disclosures of the present invention, the aggregated dataset layer contains fully aggregated/calculated closed time periods. The final values of performance indicators (or other kinds of aggregates) are ultimately available at the end of the current time period P:=[t₁, t₂].

### IV. Real-Time OLAP Layer (RTOLAP)

RTOLAPs are Real-Time multi-dimensional summarized datasets, based on Real-Time aggregated datasets (RTADSs). Such further multi-dimensional grouping of RTADSs delivers OLAP-compliant information, which gets adequately represented in RTOLAPs. The Real-Time OLAP layer enables Real-Time analysis to be carried out on OLAP (including MOLAP, HOLAP, ROLAP, etc.) systems.

In one embodiment, the strategical approach of the present invention uses minimal computational effort to compute any Information Function. All prior art methods calculate performance indicators after the relevant data for entire aggregation period has been loaded into the Data Warehouse and the like. Hence, the calculation of the performance indicators could be addressed solely after the end of the period considered. Besides, due to the aforementioned strategy, prior art uses complicated and hence error-prone aggregation routines in order to be able to analyze the entire data and meet the temporal requirements (i.e. to fit into the scheduled execution window). In contrast, the system and method of the present invention supports and enables slim and timely balanced calculations of performance indicators (or any other kind of aggregation) based on efficient summations of fundamental atomic dataset values.

In another embodiment, the strategical approach of the present invention uses minimal computational effort to calculate any KPI and the like. The current state of the art does not recognize and/or conceptualize the immanent relationship between real-world business processes and their structure, the data structure as they are represented in common operational systems and the aggregation process which calculates performance indicators out of such operational data. In prior art method and systems, the aggregation process typically takes place during following steps.

1) Data Loading (From MES and Other Sources)

Usually, primary sources of the data consist of the enterprise's operational systems; for example MES and the like. Usually, such systems are supported by relational databases, and data has to be extracted by using appropriate methods and tools. Typically, such extracted data is stored in temporary and intermediate files or in databases. Modern, Real-Time oriented architectures may also include some kind of online-messaging or database triggers.

2) Data Transformation and Aggregation

In a next step, the data has to be arranged and transformed for loading into the Data Warehouse. During this process, aggregation functionalities in order to calculate KPIs are applied. For this reason, the corresponding files or databases need to be read and analyzed. This is the second step of data processing; potentially all data which has been accessed and manipulated in step 1 need to be re-accessed again.

3) Data Supply (of the Aggregated Data) into the OLAP Structures

It has to be determined how often each group of data must be kept up to date in the Data Warehouse. The additional load on the system due to data streaming and further calculations has to be estimated, and based on those estimates, a schedule has to be done for the periodical updates. The different kinds of updates (i.e. daily, weekly, monthly, etc.) have to be planned, executed and monitored. If desired, specific monitoring capabilities have to be implemented.

Finally, reports have to be created, based on the updated OLAP data.

In summary, the same information is accessed multiple times during the conventional ETL (extract, transform and load) and aggregation steps. In particular, prior art systems first transform and store operational data and then re-access the data during the aggregation processes, and finally calculate performance indicators and the like (Ponniah, 2010). Each of those steps causes corresponding CPU-load, I/O-load and communication effort. For this reason, prior art systems hinder Real-Time aggregation, because the data extraction and further transformation and aggregation processes are holding a sequentialized structure, which conflicts with the goal of Real-Time Data Warehousing (Thiele et al., 2011). The basic conflict arises from the problem that in prior art systems, the aggregation procedures, which are required to calculate the KPIs are started in batch mode. This barrier still exists, even if the refresh and updating cycles are kept small or are redesigned to incremental mechanisms. Data Warehouse refreshment cannot be executed anymore during off-peak hours. Some authors argue that update anomalies may arise when base tables are affected by updates that have not been captured by the incremental loading process (Joerg and Dessloch, 2009). The next incremental load could, but must not necessarily resolve such anomalies. Similar anomalies may arise for deletes and inserts. As a consequence, ETL jobs have to be modified and extended in order to prevent such anomalies and to approach at least a Real-Time characteristics of the system.

From a computing perspective, the effort to calculate the performance indicators and the like of prior art systems is much higher in comparison to the present invention.

It has also been mentioned that—due to the complexity of the prior art processes (including OLTP and OLAP systems)—the requested Real-Time capability of Data Warehouses may only become achievable through in-memory databases (Thiele, 2011). Other authors argue that different database engines will evolve and fill the growing gap, especially with regard to the desired Real-Time capability of the systems and with regard to different application domains (Stonebraker, 2005; Stonebraker, 2007). Hence, Stonebraker realized the growing gap between the expectation towards Real-Time data analysis capabilities, and the current practice (Cisco white paper); he recognized that the state the of the art of the database technology does not provide Real-Time capabilities to the extent required by different applications (mostly due to dramatically increased data volume to be evaluated), and predicted corresponding advances in the database technology to catch up with the demands. In this context, the present invention assists and supports the aforementioned anticipated progress of the database technologies. By reducing and uniformly distributing the load (from within the background of evolving parallel computer architectures, new middleware capabilities, new storage capabilities, etc.) over the whole data supply period; by eliminating the peaks due to batch aggregation, and due to lacks in foundational ontologies (also with regard to properly support ad-hoc queries), the present invention facilitates the (early) launching of leading edge technologies.

In contrast to prior art systems, the present method and system is based on an analysis of the overall and fundamental informational structure. This structure is given by the analysis of business processes and the like (which should be visualized in reports; and which should be easily analyzable) as made of fundamental undividable and independent business process elements, which are consistently mapped to the corresponding data components within the information framework. Consequently, any possible further analysis of any business process (or production process) will not fall below the granularity of such business/production process elements and components. As a consequence—because of the logical independency of each business/production process element—any data which characterizes such business/production processes and the like can already be created and extracted out of the development of any single business process element during current execution time (and will be stored in fundamental data-components, i.e. fundamental atomic datasets).

Consequently, any Information Function according to the present invention can be already calculated during the original flow of the business process in Real Time through continuous aggregation of the corresponding datasets using simple calculation algorithms. Additionally, such calculations are directly mapped to desired capabilities of preferred embodiments. Consequently, the present invention supports and enables the desired Real-Time capability of the proposed method and system by immanent logical evidence. The aforementioned different parts of data transformation, data loading, and the like are becoming obsolete and replaced by the unique and simple activities concerning fundamental data components and corresponding Information Functions. Many methods and technologies support such a mapping of desired capabilities as aforementioned to database systems, multi-core hardware systems, distributed systems and others. Within this context, dynamic optimizations of execution plans may be mentioned as another example (Chiou et al., 2001); i.e. this method supports the handling of linearized calculations like median values. All those technologies, embodiments and capabilities may serve in order to identify an optimal mapping of desired functions and methods with regard to the desired performance behavior of the overall system.

Absolute and relative performance indicators (or any kind of data which is provided by an Information Function) are managed in structurally identical manner. An example with regard to relative performance indicators may deal with rework rates in manufacturing.

In the semiconductor industry, the Rework Rate may be defined as the sum of the production transactions in rework (Rw) in relationship to the overall sum of production transactions (Tr), usually at a particular process step s and the like and over a time period P (working shift, day, week, month, and the like); this relative KPI is termed Rwᵣₐₜₑ^{P, s}.

$${Rw}_{rate}^{P , s} = \frac{{\sum }_{t ∈ P} {Rw}_{t}^{s}}{{\sum }_{t ∈ P} {Tr}_{t}^{s}}$$

Within the scope of the present invention, basic atomic datasets (BADS s) may capture certain data from any single event during production; this may include all kind of context data (example of context data: production step, production equipment, used recipe, name of product, product group(s), etc.). Such BADS s may be used to instantiate fundamental atomic datasets (FADS s). Within this example, these FADS s are used in conjunction with a specific, atomic context; that is, a specific production step, production equipment, used recipe, product, etc, to create/update Real-Time aggregated atomic datasets (RTADSs). Within any such RTADSs two attributes are to be kept up to date in Real Time. Those attributes represent the sum of the transactions in rework (SRw=ΣRw), and the sum of the overall transactions (STr=ΣTr) respectively; both attributes with regard to the specific context data. If desired, another attribute may be added, in order to store the value of Rwᵣₐₜₑ. The value of the relative performance indicator Rwᵣₐₜₑ could be updated automatically, if any of the dependent parameters (sum of rework transactions, sum of overall transactions) gets updated. The strategy to recalculate the value of involved KPI (Rwᵣₐₜₑ) if one of its components (SRw, STr) gets updated is not energy efficient, especially if the data involved is sparse and the values of the KPIs are retrieved only sporadically. Alternatively, the value of this KPI can be calculated on demand. Additionally, the user might require further aggregations; for example further aggregated values of Rwᵣₐₜₑ with regard to specific, on-the-fly defined sets of steps, products, and/or customer, and/or production equipments, etc. For example, for a period P and set of steps S:

$${Rw}_{rate}^{P , s} = \frac{{\sum }_{s ∈ S} {\sum }_{t ∈ P} {Rw}_{t}^{s}}{{\sum }_{s ∈ S} {\sum }_{t ∈ P} {Tr}_{t}^{s}}$$

Such new, on-the-fly demands are supported by the present invention in Real Time within appropriate functionalities in a most advantageous manner. The structural reason in order to support appropriately and enable such on-the-fly demands is based on the ontological foundation of the present invention: all required data is kept as logically independent data components on an atomic level (within BADSs, FADS and RTADS). Within the present example, any further aggregated value may be calculated directly and in Real Time, because all required data components are kept up to date independently within the underlying linear spaces. In consequence, any such kind of newly defined on-the-fly demands can be fulfilled within a minimal set of calculation steps.

In computer science, the prefix sum, or cumulative sum of a sequence of numbers is a second sequence of numbers, which represents the sums of prefixes (or running totals) of the input sequence. For instance, the prefix sums of the natural numbers: 1, 2, 3, 4, 5, 6, . . . , are the triangular numbers: 1, 3, 6, 10, 15, 21, . . . . Prefix sums are trivial to compute in sequential models of computation. However, despite their ease of computation, prefix sums are a useful primitive in certain algorithms such as counting sort, in parallel algorithms, etc.

The prefix-sum approach has been used for range queries in data cubes (Ho, Ching-Tien, 1997) to pre-compute some auxiliary information that is used to answer ad-hoc queries at run-time. The aforementioned approach uses pre-computed values (SUM or MAX) over balanced hierarchical tree structures to speed-up the computation of range queries over data cubes. However, updates on data cubes built by this approach are expensive operations, because each update requires re-calculating all the entries in the cube (Zhang, Jie, 2007). To overcome this deficiency many algorithms—which compute data cubes and at the same time support efficient updates—have been proposed (see Zhang, Jie, 2007; pag. 13-14). Common to these approaches is that they do not address Real-Time capabilities, consume important amount of storage space/memory and expensive update costs. In current practice, data cubes use relatively expensive systems that first batch load data and then permit read-only access.

The approach as described by Zhang, Jie, 2007 tries to increase the query performance, by maintaining auxiliary information (prefix sums), which is of the same size as the data cube, all range queries for a given cube can be answered in constant time. In contrast, the method and system according to the present invention generates new information through the evaluation of the Information Function, materialized by performance indicators and all other kinds of aggregates.

Another approach (Yang et al., 2003) uses the SB-tree, which is a balanced, disk-based indexing structure, supporting incremental insertions, deletions and updates. The SB-tree contains a hierarchy of time intervals along with aggregate values that will be part of the final aggregate values for those intervals. Aggregation over a given temporal interval is done by performing a depth-first search on the tree and accumulating partial aggregate values along the path. The SB-query supports SUM, COUNT, AVG and MIN/MAX queries. However, if deletion is allowed, then the SB-tree does not support MIN/MAX operations. Other approaches like MVSB-trees (Zhang, Jie, 2007; page 16) support only distributive aggregate functions, such as SUM, COUNT and AVG. One disadvantage of the MVSB-tree is that the tree consumes too much space—much larger than the size of the data. Other approaches as LKST overcome the aforementioned disadvantage of the MVSB-tree by using only a small index (but uses approximate temporal aggregation) and supports only count and sum aggregate functions. The decisive distinction of the present invention is that in prior art, the aggregation has been done (SB-trees) by performing a depth-first search on the tree and accumulating partial aggregate values along the path, whereas within the present invention the current value of an Information Function corresponding to the latest input information is determined as soon as the input information is known to the system. Hence, the prior art (SB-trees) was not intended for Real-Time aggregation. The purpose of the SB-trees was to provide fast lookup of aggregate results based on time, by maintaining the SB-tree efficiently when the data changed. Furthermore, the SB-tree approach (Yang et al., 2003; 3.4 Deletion) does not handle the MIN and MAX functions when tuples are deleted from the base table.

Another advantageous characteristic of the present invention is the capability for a parallelization of the system design. Any transaction within a linear system can be executed independently. For this reason, all incoming inputs to the system can theoretically be executed through parallel instances (i.e. CPU's, threads, parallelized instructions, and the like). That is, the process of creation and updating (if required) of single basic atomic datasets, single fundamental atomic datasets and single continuously aggregated datasets can be performed independently of any other computation, requires no communication messages, and can be executed as simple and independent parallel task. Additionally, within the scope of the overall informational space, all of such tasks show a similar and simple structuring, and, as a consequence, consume similar computing resources (i.e. CPU cycles), which is another prerequisite for optimal parallelization. In more detail, the overall system is to be designed in a manner that such parallel tasks can be processed by similar parallel execution units approximately in similar time slices. This is an outcome of the overall system design. Different database systems or database products may be used and may benefit within different scales from this immanent structure.

Accordingly, the linear system model of the present invention enables optimal effectiveness and efficient parallelization of the overall system and corresponding distribution of computing tasks. Consequently, inter-task communication is becoming minimized in a preferred embodiment, and minimal in adequate mathematical models. Consequently, optimized system design is enabled by following this methodology. This new methodology supports and enables best performance and minimum energy consumption of target systems, including desired embodiments, based on the simplicity and straightforwardness of the continuous aggregation strategy, and overall load smoothing and balancing due to peakless, continuous load design of all computing tasks. No interim tasks are required; no unexpected communication queues may appear. That is, expected load profiles are foreseeable and designable and are mostly smoothly distributed over the whole life cycle of the system.

According to the invention, this overall architecture and methodology enables best effectiveness and best efficiency of the systems and embodiments considered. By consequently distributing simplified tasks over the systems and components considered, an overall Real-Time capability will be achieved and enabled by immanent evidence. The methodology includes the mapping of system designs and components towards adequate overall hardware architectures and systems. In more detail, Real-Time constraints of the overall system are becoming manageable in a most advantageous manner.

Another preferred embodiment of the present invention is to adequately include the statistical methods, which are commonly used within the Data Warehouse world and which have to support the claimed continuous Real-Time calculation and aggregation mechanisms. Typically, in prior art systems such statistical figures (i.e. averages, standard deviations, etc.) are calculated within the overall batch oriented aggregations. It has to be noted, that such statistical calculations create—especially for practitioners—another known barrier for efficient and trustable Real-Time Data Warehousing. In contrast to this, the present invention supports and enables the required methods, which supports continuous and optimal aggregation of such statistical parameters.

Yet another embodiment of the present invention arises from current market evolutions, which identify a growing need for new or newly to be developed database engines (Stonebraker, 2007). Within this context, Stonebraker et al. are introducing a database system, which supports stream processing capabilities (Stonebraker, 2007):
“SQL systems contain a sophisticated aggregation system, whereby a user can run a statistical computation over groupings of the records from a table in a database. The standard example is:
Select AVG (salary)
From employee
Group by department
When the execution engine processes the last record in the table, it can emit the aggregate calculation for each group of records. However, this construct is of little benefit in streaming applications, where streams continue forever and there is no notion of “end of table”. Consequently, stream processing engines extend SQL (or some other aggregation language) with the notion of time windows.”

Stonebraker is emphasizing on an upcoming differentiation with regard to newly emerging applications and data management and processing principles. It has to be noted that the present invention supports and enables such stream processing capability within commercial database systems.

The systems and methodology provided by the present invention provide the framework for Real-Time reporting based on a predefined time interval or fixed periods (rolling windows), for example Real-Time reports over the last 8 hours relative to the current time.

According to the present invention, the continuous aggregation technology enables and supports in addition to the aforementioned capabilities the computation of the performance indicators with regard to flexible time periods. For example, a user would like to know the average value of the cycle time of the entire facility between 5 and 10 am. This value can be calculated by using fundamental atomic datasets, which have to be aggregated with regard to the requested time period. The system of the invention supports and enables also further calculations of ad-hoc values with regard to different operational levels (operational, strategic, tactical, etc.). Such ad-hoc reports may be based additionally on aggregates on already aggregated data and may also include already existing reports and the like.

The aforementioned strategical approach of the present invention allows a reduced computational effort to calculate the Information Functions (materialized by performance indicators and the like). All other methods, which calculate such data in the classical prior art way—in batch-mode—use sophisticated algorithms to address the performance problems due to the date volume inherent of the batch approach. In contrast to this, the system and methodology of the present invention support and enable complete calculations of performance indicators based on simple, fast and efficient summations of fundamental atomic data values.

Final calculation of the performance indicators is supported and enabled through a continuous aggregation/computation process. Such aggregation process is typically defined with regard to a predefined time period. That is, a performance indicator may be calculated for each shift, for each day, for each month, etc. As a consequence, the value of any such performance indicator is updated and automatically kept up to date during such aggregation period. No further computation is required, if the endpoint of any aggregation period has been reached. All performance indicators are already holding their final values and may be immediately reported.

In prior art systems the fundaments of the present invention have not been considered or used as input for the design of systems. As a consequence, aggregations and further calculations are load intensive tasks, which require important amounts of system resources. It is commonly accepted, that applications in the context of Data Warehousing and data mining should be based on a meaningful modeling. The present invention is built on decompositional system model, which immanently maps to linear information spaces. Prior art systems and methods do not consider these important aspects, and for this reason they fail to deliver optimal solutions.

Another important argument for the system and methodology provided by the present invention comes out of the fundamental requirement for easily understandable and transparent KPIs. Cognitive science relies explicitly on the concept of linear spaces in order to conceptualize cognitive behavior (Churchland, 1992 and Haugland, 1997). The physicist Richard Feynman is arguing that the entire universe can be described by linear base vectors. All natural phenomena are holding in its fundaments the form of linear spaces (quantum physics). Any nonlinear system behavior appears on the macroscopic physical level (weather, etc.). If nature is fundamentally based on the concept of linear spaces, then such structure should be identifiable within epistemological structures. Such proof has been made by empirical epistemology (Vollmer, 1985). As a consequence, the term “easily understandable” implies directly a system model based on linearly independent elements and structures (Luhn, 2012). As a consequence, this holds true for the known definitions of performance indicators. Apart of this, numerous methods exist to solve problems of nonlinear systems. But all of them have to be transformed into linear models, if algorithms and computers are required in order to find solutions (because the usage of any algorithm requires a linearization of the model). The present invention supports also the functionality to include nonlinear—in the usual sense—relationships and functions. This is done through linearization and continuous computing along the frames of the aforementioned linear structures.

Advantages of the Present Invention in Regard to Overall Efficiency Including Algorithmic Efficiency

Aggregation processes—typically executed during off-hours—may suffer from huge demands of memory (because entire tables have to be read), may cause the creation of temporal tables and storage requirements (memory, disk), and may additionally suffer from inefficient calculation tasks (in contrast, the present invention relies mostly on simple summations and the like), and may even additionally suffer from avoidable multiple accesses to same data elements. The core design principle of the system and methodology of the present invention is grounded on the principle of designing an information framework, which maps a consistent real-world business process into an optimal and adequate mathematical model (linearity of information, decompositional system model), and which supports the creation of any desired information in Real Time due to consistently designed, linear system structurization and corresponding Information Functions, which are based on most simple, straightforward and efficient mathematical functions (summations and the like). The adequateness and optimality of the system and methodology of the present invention arises from the fundamental requirement of supporting and enabling the Information Functions of the invention in Real Time.

As the factor “time” is a major pillar in algorithmic efficiency, the system and methodology of the present invention provides an optimal solution by immanent evidence. This factum is enforced by the efficiency by which the CPUs calculate sums and the like. In even more detail, it has to be noted that due to this efficiency and adequateness, Data Warehousing becomes much more simple and efficient within a more general scope. New data analysis functionalities are now achievable, for example a Real-Time and continuous analysis of bottleneck situations of a productions site during the current working shift—based on the fractional values of the performance indicators relative to the temporal evolvement of the shift, which even may be analyzed in more detail and under ad-hoc defined conditions (for example regarding different kinds of products, product groups, technologies, machines, recipes, recipe parameters, measurements, versioning or other kinds of information). The methods of data aggregation and further data processing and/or calculation, which are provided by the present invention, cover most parts of the functionality which are commonly understood as Data Warehousing. It has already been laid down, that the system and methodology of the present invention supports and enables the processes of knowledge discovery in data bases from within an inherent perspective. Accordingly and advantageously, the present system and methodology supports and encourages a paradigm shift in Data Warehousing towards a coherent linear information framework, supported by appropriate embodiments and deployments.

Accordingly, any existing Data Warehouse system and corresponding solutions or products (including corresponding database technologies, like column or row oriented solutions, in-memory systems, etc.) are supported embodiments of the present invention and shall be embraced by the present invention. The selection of a specific embodiment depends on different parameters and user requirements, and any such embodiment may enable Real-Time Information Systems, including Real-Time Data Warehousing. Representative examples of embodiments and corresponding systems and methods are described throughout the specification, examples and figures of the present invention.

Energy Efficiency and Resource Consumption Using Von Neumann Architecture

The present invention defines embodiments, which are built upon the von Neumann computing architecture. Data Warehousing systems are generally built on such platforms. It has to be noted, that the present invention is not limited to those kinds of computing architectures and embodiments. For example, some kinds of data mining systems are built on neural network technologies.

Next, based on the aforementioned examples (standard deviation, etc.), the energy efficiency, and the resource consumption within the present invention will be analyzed and compared to the performance of the previous art. The comparison additionally provides an insight into the principles of the present invention and contradicts the prevalent assumption that Real-Time computing is more resource consuming (hardware resources, energy), than the classical batch approach. As aforementioned, the formula for the standard deviation used within this invention is:

$${s}_{N} = \frac{1}{N} \sqrt{\vert N {\sum }_{i = 1}^{N} {x}_{i}^{2} - {( {\sum }_{i = 1}^{N} {x}_{i} )}^{2 } \vert}$$

where {x₁, x₂, x₃, . . . , x_{N}} are the observed values of the sample items.

As aforementioned, the usual approach for the standard deviation as used in prior art is

$${s}_{N} = \sqrt{\frac{1}{N} {\sum }_{i = 1}^{N} {( {x}_{i} - \overline{x} )}^{2}}$$

The resource consumption (occurrence) is—comparison of prior art and present invention:

TABLE 1
Comparison of operational effort

| | | Present |
|---|---|---|
| Operation | Prior Art | Invention |
| (1) Addition | 3N | 2N + 1 |
| (2) Multiplication | N | N + 1 |
| (3) Division | 2 | 1 |
| (4) Square root | 1 | 1 |
| (5) Retrieval from storage | N | 0 |
| (6) Number of registries | N + 2 | 3 |
| (7) Algebraic Comparison | 0 | 1 |

The higher resource consumption of the previous art is due to the calculation of the mean value

$$\overline{x} = \frac{1}{N} {\sum }_{i = 1}^{N} {x}_{i}$$

; the values {x₁, x₂, x₃, . . . , x_{N}} have to be retrieved from the storage system, whereas according to the present invention, the aforementioned values are already stored in the memory/registries.

Based on the aforementioned example, the resource consumption of the algorithms (calculation of the KPIs and the like) of the present invention can be reduced by factors of magnitude, by performing pre-aggregation/pre-calculation and leaving the calculation of the final values of the KPIs and the like (i.e. the processing the square root) to the on-demand retrieval strategy.

Hence, as stated in the previous examples, the sums

$${\sum }_{i = 1}^{N} {x}_{i} and {\sum }_{i = 1}^{N} {x}_{i}^{2}$$

are updated for each new sample item. Those sums are capturing the linearity of the model, because they are to be calculated continuously while related events are updated to the system. Then, in an independent step, the standard deviation value S_{N} is calculated only when it is needed. Assuming a practical use case, where it might not be required to calculate the root at any point in time when a new dataset is updated to the system, the CPU cycle count consumption is slightly lower than in the previous art (batch aggregation).

To conclude, CPU consumption is slightly lower with regard to the structure of the algorithms.

Additionally, the algorithm for the calculation of the standard deviation is slightly simpler than those usually used for batch aggregation (prior art), it performs moreover only one division instead of two as in the prior art. Of course, for real-world calculation, the simplification of the algorithms depends on the skills of the experts familiar with the art. In more detail, the simplification of the algorithms used for batch aggregation (i.e. providing slim source code) is achieved, because the source code of the batch aggregation procedures was inflated merely due to performance optimization rather than due to the calculation of the KPIs. In the prior art (batch aggregation), the focus and challenge was to optimize the aggregation procedures to fit in the execution time-frame.

To conclude, CPU consumption is reduced by the present invention by a factor of magnitude due to the disadvantages of the batch aggregation.

As aforementioned, one of the crucial benefits of the present invention is that—in order to perform Real-Time continuous aggregation—no information has to be retrieved from the storage systems—except for the partial values of the aggregates, which were persisted and are needed for further aggregations. Therefore, most of the information needed for aggregation is already in memory during the ETL computational phase. Hence, the memory needed for continuous aggregation is only a fraction of the memory required for batch aggregation procedures. To conclude, memory consumption is reduced by the present invention by a factor of magnitude due to the disadvantages of the prior art batch aggregation approach.

Hence, by reducing large-scale aggregation to Real-Time continuous aggregation according to the present invention, there is a dramatic cut in I/O consumption.

Accordingly, I/O consumption is reduced by a factor of magnitude due to the disadvantages of the prior art batch aggregation approach.

Hence, memory, CPU, and disk I/O consumptions due to batch aggregation (for example nightly aggregation) will therefore be eliminated. For example, in prior art systems resource intensive join functions are used on regular basis. A simple calculation shows that a table containing 100.000 rows/each row 1 Kbyte of data may cause 10 GByte of memory requirements for a simple inner join. Similar requirements exists for sorting of such tables or even more complex joins. Consequently, the hardware requirements can be minimized and are practically equal to the reporting needs, including the newly designed ETL process. Moreover, prior art systems are mostly designed to support the load of the nightly aggregation processes. This becomes obsolete due to the current invention.

If Real-Time aggregation is not a requirement, then the aggregation procedures can be designed such that they capture certain timeframes. That is, the present invention supports also discrete aggregation mechanisms (small-scale aggregation, i.e. batch size is small, such that the data to be aggregated fits in memory), but enables nevertheless the advantages in comparison to prior art batch aggregation. The size of the small-scale batch jobs of the present invention can be optimized in such a way, that the resource consumption including the execution time is minimal. There exist commercial performance tuning modules (for example Toad from Quest) such that optimal source codes for the aggregation procedures can be determined. Toad generates alternatives to the existing SQL-queries and determines the resource consumption (mostly execution time) by running the queries in a virtual environment. In such a way, the optimal batch size (for example run aggregation jobs every 5 minutes) of the small-scale aggregation can be determined. The solution of the present invention is optimal in the sense, that with the methods existing in the prior art, no further improvements using database technologies are achievable. Further improvements can be achieved only by other means like redesigning the information flow, architectural changes, simplifying the formulas of the KPIs and the like, etc.

Thus, there is a tremendous benefit of the methods of the present invention also in the classical field of batch oriented aggregation (small-scale aggregation).

Isomorphic Transformation/Homomorphic Aggregation

Preserving the linear structure of the information spaces is part of the fundamental principles of the present invention, and it is essential for the roll-up strategy of the present invention. Two linear information spaces are said to be homomorphic if there is a map between the two spaces which preserves the linear structure of the spaces involved. Such a map is called a linear homomorphism. An isomorphism is a bijective homomorphism.

Within this example, the standard deviation will be considered again.

As aforementioned, the formula for the standard deviation used according to the present invention is

$${s}_{N} = \frac{1}{N} \sqrt{\vert N {\sum }_{i = 1}^{N} {x}_{i}^{2} - {( {\sum }_{i = 1}^{N} {x}_{i} )}^{2 } \vert}$$

where {x₁, x₂, x₃, . . . , x_{N}} are the observed values of the sample items.

In order to keep the current description simple and intuitive, the row and the column representation of an information vector are considered equivalent.

Let S be the information space of all sample items.

Let X:=(x₁ x₂ . . . x_{N}) and Y:=(y₁ y₂ . . . y_{M}) for X, Y ∈ S

Define X ⊕ Y:=(x₁ x₂ . . . x_{N} y₁ y₂ . . . y_{M}) being the sample item containing the values of the sample X and sample Y.

The grouping {g₁, g₂, g₃, . . . , g_{K}} such that K≦N will be considered for aggregation.

Each xₙ, n ∈ {1, 2, . . . , N} is mapped at least to a group gₖ, k ∈ {1, 2, . . . , K}.

The item xₙ which is mapped to the group gₖ, will be denoted by xₙ^{k}.

Hence, the structure of (g₁, g₂, g₃, . . . , g_{K}) can be represented as a matrix:

$$( \begin{matrix}{g}_{1} \\ {g}_{2} \\ … \\ {g}_{K}\end{matrix} ) := ( \begin{matrix}{x}_{1}^{1} & {x}_{2}^{1} & … & {x}_{{l}_{{g}_{1}}}^{1} \\ {x}_{1}^{2} & {x}_{2}^{2} & … & {x}_{{l}_{{g}_{2}}}^{2} \\ … & … & … & … \\ {x}_{1}^{k} & {x}_{2}^{k} & … & {x}_{{l}_{{g}_{K}}}^{k}\end{matrix} )$$

Let V be the information space of all groupings corresponding to the sample items.

Define the Transformation function T:S→V by

$$( \begin{matrix}{x}_{1} & {x}_{2} & … & {x}_{N}\end{matrix} ) -> ( \begin{matrix}{g}_{1} \\ {g}_{2} \\ … \\ {g}_{K}\end{matrix} )$$

Obviously T is bijective.

Analogously, consider the grouping P:=(p₁ p₂ . . . p_{K}) defined by

$$( \begin{matrix}{y}_{1} & {y}_{2} & … & {y}_{N}\end{matrix} ) -> ( \begin{matrix}{p}_{1} \\ {p}_{2} \\ … \\ {p}_{K}\end{matrix} )$$

For G=(g₁ g₂ . . . g_{K}) and P=(p₁ p₂ . . . p_{K}) defined as above, set

$$G ⊕ P = ( \begin{matrix}{g}_{1} \\ {g}_{2} \\ … \\ {g}_{k}\end{matrix} ) ⊕ ( \begin{matrix}{p}_{1} \\ {p}_{2} \\ … \\ {p}_{k} \end{matrix} ) = ( \begin{matrix}{g}_{1} & {p}_{1} \\ {g}_{2} & {p}_{2} \\ … & … \\ {g}_{k} & {p}_{k}\end{matrix} ) := ( \begin{matrix}{x}_{1}^{1} & {x}_{2}^{1} & … & {x}_{{l}_{{g}_{1}}}^{1} & {y}_{1}^{1} & {y}_{2}^{1} & … & {y}_{{l}_{{p}_{1}}}^{1} \\ {x}_{1}^{2} & {x}_{2}^{2} & … & {x}_{{l}_{{g}_{2}}}^{2} & {y}_{1}^{2} & {y}_{2}^{2} & … & {y}_{{l}_{{p}_{2}}}^{2} \\ … & … & … & … & … & … & … & … \\ {x}_{1}^{k} & {x}_{2}^{k} & … & {x}_{{l}_{{g}_{k}}}^{k} & {y}_{1}^{k} & {y}_{2}^{k} & … & {y}_{{l}_{{p}_{k }}}^{k}\end{matrix} )$$

Let W be the information space of all aggregations corresponding to the groupings of the sample items.

Define the Aggregation Function A as:

A:V→W

$$G := ( \begin{matrix}{g}_{1} \\ {g}_{2} \\ … \\ {g}_{k}\end{matrix} ) -> ( \begin{matrix}{G}_{1}^{1} & {G}_{2}^{1} & {l}_{{g}_{1}} \\ {G}_{1}^{2} & {G}_{2}^{2} & {l}_{{g}_{2}} \\ … & … & … \\ {G}_{1}^{k} & {G}_{2}^{k} & {l}_{{g}_{k}}\end{matrix} ) = : {A}_{G}$$

where for g:=(x₁ x₂ . . . xₙ) arbitrary element of {g₁, g₂, . . . g_{K}}, the corresponding components G₁, G₂, I_{g} are defines as follows:

$${G}_{1} := {\sum }_{i = 1}^{n} {x}_{k} ; {G}_{2} := {\sum }_{i = 1}^{n} {( {x}_{i} )}^{2} ; {l}_{g} := n$$

Let additionally Aₚ be an element of W such that

$$P := ( \begin{matrix}{p}_{1} \\ {p}_{2} \\ … \\ {p}_{K}\end{matrix} ) -> ( \begin{matrix}{P}_{1}^{1} & {P}_{2}^{1} & {l}_{{p}_{1}} \\ {P}_{1}^{2} & {P}_{2}^{2} & {l}_{{p}_{2}} \\ … & … & … \\ {P}_{1}^{k} & {P}_{2}^{k} & {l}_{{p}_{k}}\end{matrix} ) = : {A}_{P}$$

Define the addition ⊕ on the linear space W by

$${A}_{G} ⊕ {A}_{P} := ( \begin{matrix}{G}_{1}^{1} + {P}_{1}^{1} & {G}_{2}^{1} + {P}_{2}^{1} & {l}_{{g}_{1}} + {l}_{{p}_{1}} \\ {G}_{1}^{2} + {P}_{1}^{2} & {G}_{2}^{2} + {P}_{2}^{2} & {l}_{{g}_{2}} + {l}_{{p}_{2}} \\ … & … & … \\ {G}_{1}^{k} + {P}_{1}^{k} & {G}_{2}^{k} + {P}_{2}^{k} & {l}_{{g}_{k}} + {l}_{{p}_{k}}\end{matrix} )$$

Set F:={0,1}. Then F is a field (with the usual addition and multiplication).

Let<(S,⊕, )>, <(V, ⊕, )> and <(W, ⊕, )> be vector spaces over F generated by S, V and W respectively. Then the following relations hold for X, Y ∈ S.

T(X ⊕ Y)=T(X)⊕T(Y) and

A(T(X) ⊕ T(Y))=A(T(X)) ⊕ A(T(Y))

Similar relations hold for instead of ⊕.

Hence, the functions T and A are homomorphisms. Since the function T is bijective, it is an isomorphism.

Prior art systems and methods merely use built in function to calculate the standard deviation for a sample (like STDEV in Oracle).The common approach of the prior art, which only uses the built in functions and the like of the databases, does not offer on-the-fly roll-up computation possibilities of the standard deviation.

In clear words, consider two products p and q, and assuming measurements values for those products Xₚ and Y_{q}; those measurement values having the cardinality (i.e. the number of elements) Nₚ and N_{q}. Now, let Xₚ:=(x₁ x₂ . . . x_{N}_{ₚ}) and Y_{q}:=(y₁ y₂ . . . y_{N}_{_{g}}) be the measurements for product p and q respectively and let

Xₚ ⊕ Y_{q}:=(x₁ x₂ . . . x_{N}_{ₚ} y₁ y₂ . . . y_{N}_{_{q}}) be the entire set of measurements containing all items for product p and q.

Let STDEV be the built in function for the calculation of the standard deviation, let StDₚ:=STDEV(Xₚ) and StD_{q}:=STDEV(Y_{q}) be the calculated valued for the standard deviation for the product p and q, on the items Xₚ and Y_{q} respectively. Then the standard deviation for the measurement data Xₚ ⊕ Y_{q} cannot be reliably determined by using build in functions like SUM, AVG, and the like having as parameter StDₚ and StD_{q}.

The corresponding value StD_{p⊕q} for of all measurement data Xₚ ⊕ Y_{q} can then be calculated by invoking STDEV as StD_{p⊕q}:=STDEV(Xₚ ⊕ Y_{q}). This means in particular, that in prior art, all involved measurement data had to be retrieved each time, on-the-fly aggregations were performed, thus usually prior art does not provide roll-up capabilities based on aggregates for the standard deviation based on built-in function, like STDEV.

In conclusion, as disclosed throughout the present invention, the continuous aggregation strategy of the present invention performs a very well contoured fundamental approach such that:
a) each piece of information is evaluated and further computed—aggregated including the calculation of the component values of the performance indicators and the like—as soon as the information is available to the system;
b) this overall structure enables highest potential for designing solutions and embodiments based on leading edge database technologies, including but not restricted to parallel and distributed computing, in memory and non-relational databases, etc., as well as leading edge middleware technologies;
c) the methodology according to the present invention supports efficient knowledge discovery in Real Time.

For example, the cycle time a lot spent in the production system at a specific step is calculated as soon as the necessary information—specific points in time when the lot was processed at the aforementioned step is available. Furthermore, the cycle time corresponding to the aggregates to which the lot is associated, is immediately updated. Thereby, accurate and up-to-date information is available for each performance indicator in Real Time.

Moreover, the methodology according to the present invention guaranties optimal calculation effort—reduced by orders of magnitude over the previous art for performance indicators, or any other Information Function, since:
1) the data necessary for the calculation of the partial values of the performance indicators is already in memory and does not need to be reloaded several times, which is the common practice of the batch aggregation method of the previous art;
2) the data involved in the aggregation/calculation is reduced to minimum in adequate computational models, and any performance optimization from an implementation perspective is within the scope of the present invention;
3) joins are optimal—since data is small—thus the Cartesian product of the joins is minimal;
4) the algebraic expressions and the structure of the performance indicators are designed for highest algorithmic simplicity and effectivity (based on SUM, COUNT, AVG, MIN/MAX, and the like);
5) performance improvement strategies are straightforward,—due to the simplicity of the algorithms—best performance of the aggregation algorithms is achievable by methodological design;
6) load balancing among multiple processors is achieved in a straightforward way using disjunct data partitions, on which aggregation procedures may operate separately and in parallel;
7) peak phases are avoided, for example due to recalculations of the nightly aggregation during business hours (these kind of activity occurs inevitably during the production process);
8) erroneous data can be detected in Real Time during the load and continuous aggregation process;
9) recalculation of the performance indicators and the like—due to erroneous data—can be performed continuously and in Real Time by simply reloading the corresponding datasets having the corrected values. In contrast, the common practice of the prior art is to restart the batch jobs as a whole;
10) avoids/reduces hot phases for IT-staff during the night, such that the nightly aggregation (prior art) does not evolve to “a race against time” (restart of erroneous procedures/batches risks to exceed the timeline, etc.);
11) enables much smoother load balancing of the aggregation efforts over the whole day, and avoids performance peaks. In this sense, additional reduction of the energy consumption over the previous art can be achieved by choosing optimal and hence smaller hardware.

As aforementioned—by replacing the nightly (previous art) batch aggregation with continuous aggregation spread over the entire day—important hardware reduction (and corresponding reduction in energy consumption) can be achieved. There is no more need for high performant disk racks to support the nightly aggregation of the previous art (using complex and hence error-prone and inefficient procedures); the disk racks needs to support more or less the ETL—and reporting efforts. The algorithms of the continuous aggregation procedures are of maximum efficiency and effectiveness in adequate computational models, and support best efficiency and effectiveness in terms of dedicated embodiments. Substantial CPU and disk I/O effort reduction is achieved over the previous art by:
1) distributing the load uniformly through the whole aggregation period (for example 24 hours for the daily aggregation);
2) simplifying the formulas for the Information Function, including performance indicators, to its most effective and efficient representation;
3) simplifying the algorithms used for transformation and aggregations/calculations to its most atomic and effective form.

### Detailed Description of the Preferred Embodiments of the Present Invention

Referring to the drawings, the preferred embodiments of the method and system of the present invention will be now described in more detail below.

In general, the methods and apparatus (for data aggregation and calculation of the performance indicators) of the present invention can be employed in a wide range of applications, including MOLAP, ROLAP, HOLAP systems, column or row store databases, in memory databases or databases with hybrid drives or disk storage, but the methods and apparatus are not restricted to the enumeration as above.

FIG. 1 illustrates a generalized embodiment of the present invention comprising:
(i) a set of different data sources (which may include OLTP systems),
(ii) a Data Warehouse realized as a (not necessarily relational) database, including the Real-Time DBMS server of the present invention, having an integrated aggregation engine (Details in FIG. 16) and a MDDB (multi dimensional data base),
(iii) one or more Real-Time OLAP (MOLAP, ROLAP, HOLAP) servers communicating with the Real-Time DBMS server and supporting a plurality of OLAP clients.

In accordance with the principles of the present invention, the Real-Time transformation and aggregation server performs transformations, aggregations, calculation of the performance indicators—being embodiments of Information Functions—, as well as multi-dimensional data storage.

In contrast to conventional practices, the principles of the present invention enable the Real-Time DBMS server(s) to perform continuous aggregation and Real-Time calculation of the performance indicators and the like, using optimal linear structures and corresponding linear Information Functions. The aforementioned linear structures and information functions enable highest degree of system parallelization and optimal system efficiency. The aggregation server enables efficient organization and handling of data as well as Real-Time retrieval of any data element in the MDDB.

The Real-Time DBMS server contains standardized interfaces so that it can be plugged into the OLAP server of virtually any vendor, thus enabling continuous aggregation and Real-Time computation of the performance indicators and the like.

The Real-Time DBMS server of the present invention can serve the continuous aggregation and Real-Time computing requirements of other types of systems besides OLAP systems such as RDBMS, data marts, etc., but not restricted to the enumeration above.

The Real-Time DBMS server can perform “on demand” calculation of some performance indicators, which cannot be calculated straightaway by adding up the corresponding partial values of the performance indicators. For example if the functions ƒ, with i ∈ {1, 2, . . . , n} are linearizable such that the performance indicator considered is equal to F(f₁ f₂, . . . , fₙ) then the function F can be calculated on demand, especially if the data is sparse and the result is needed only occasionally. Alternatively, in such cases, the function F can be calculated by the GUIs, while the component values of the functions ƒᵢ are calculated by the transformation and aggregation server. Such functions F, ƒᵢ, etc. are treated as Information Functions (i.e. materialized as performance indicators).

While serving the OLAP server, the transformation and aggregation server of the present invention discharges the OLAP server from the initial task of aggregation/calculation of the performance indicators and the like, and therefore letting the OLAP server to concentrate on data analysis and reporting, and more generally, part smoothes the load profile of the OLAP systems.

FIG. 16 shows the primary components of the transformation and aggregation engine (TAE) of the illustrative embodiment as explained in great detail before. During operation, the raw data originates from MES, equipment coupling devices, other primary data storage systems, Data Warehouses, ASCII or XML files, etc. The ETL configuration managers—in order to enable proper communication with all possible data sources and data structures—configures two blocks, the ETL interface and the ETL data loader. As shown in FIG. 16, the core of this part of the system is the transformation and aggregation engine (TAE), and a MDDB handler to store and retrieve multidimensional aggregated data in the MDDB. The architectural layer of the TAE contains the FADS layer as well as the RTADS-layer having multiple stratifications, i.e. multiple layers for different period aggregations (working shifts, day, week, month, etc.). The TAE serves the OLAP server(s) or other similar systems via an aggregation client interface.

Additional aggregation results—non-calculated values for some specific measures—are supplied on demand. For example, to determine the standard deviation as shown in FIG. 13, the attributes Σcycle time, Σ(cycle time)² are calculated continuously; i.e. for each new relevant information (additional attributes in FADS), the aforementioned attributes are updated continuously. Merely, the value for STDEV is calculated on demand using the above attributes as input values (except closed period aggregations, for example day, week or month, where the value for STDEV is calculated once for the whole period involved). In order to achieve the calculation of some performance indicators and the like (for example STDEV), the request analyzer—after parsing and identifying the required attributes—sends a request for the calculation of the missing value of the performance indicator and the like to the TAE. The calculated value is then forwarded to the requester.

As shown in FIG. 16, the transformation and aggregation engine of the present invention serves the OLAP Server (or other requesting computer system) via an aggregation client interface. Aggregation/calculation results are supplied continuously towards the OLAP Server, hence enabling Real-Time reporting capabilities for the OLAP server.

An object of the present invention is to make the transfer of data completely transparent to the OLAP user, which is enabled by the unique data structure and continuous aggregation mechanism of the present invention.

In accordance with the embodiments of the present invention, data transformation, data pre-aggregation, and data aggregation are carried out in 3 to 4 steps according to the method illustrated in FIG. 16.

First, the raw data is loaded and transformed, building the basic atomic dataset layer (BADS-layer), which contains the finest granularity of data necessary for ad-hoc reporting, decision making and data analysis. This process is part of the newly designed extract, transform and load (ETL) system, which is further part of the data supply chain. For example, the raw data contains—spread over multiple datasets—the basic information regarding the production process in the semiconductor industry as lot, step, transcode, equipment, timestamp, product, etc.

Next, based on the information contained in the basic atomic datasets, the foundations for the base layer for reporting are established.

The finest granularity of the data used for reporting is termed fundamental atomic dataset layer (FADS layer). Relevant information from the basic atomic dataset layer is summarized and enhanced by new attributes—some of them containing derived data based on the information of the same fundamental atomic dataset—setting up the FADS layer. These new attributes contain (pre-)calculated information, which are further involved in the calculation of the performance indicators relative to a time period. For example, in the semiconductor industry information about the previous production step and the scheduled next steps are stored for each fundamental atomic dataset. Then, successively, the cycle time for the process step involved is calculated and stored for each fundamental atomic dataset.

Based on the information contained in the fundamental atomic datasets, different pre-aggregations are successively performed. For example, for a predefined period of time (e.g. working shift, day, week, etc.) or rolling window, the information regarding all lots at the same step, equipment, product within the same period are continuously pre-aggregated and the corresponding new attributes are calculated right away.

Hence, attributes like NoI (number of items), CT (being the sum of the cycle times) or SQ CT (being the sum of the square of the cycle times) are updated. Afterwards, based on CT and SQ_CT, the standard deviation (STDEV) of the cycle times for the period considered are calculated. Alternatively, the standard deviation can be calculated on demand or during the data analysis process by the GUIs. According to the disclosures of the present invention, performance indicators are calculated steadily and in Real Time. For example, consider “day” as the period; for each point in time the current value of every performance indicator is kept continuously updated, and can be displayed, i.e. CT/NoI displays the current value of the average cycle time at each point in time. By evaluating CT/NoI for example at 13:46 the average cycle time of the considered day from 00:00 till 13:46 is calculated. Hence, the progress of the production process can be very well tracked by using data analysis against the Real-Time aggregated dataset layer.

Similar considerations are valid for the rolling window (FIG. 13). Thus, if a new fundamental atomic dataset enters the window, then the corresponding attributes of the appropriate Real-Time aggregated datasets are updated, usually by adding up the corresponding new values. On the contrary, if a fundamental atomic dataset leaves the time-frame of the window, then usually the appropriate values are subtracted from the corresponding sums.

Pre-aggregated data evolves towards fully aggregated/calculated data as the current time tends to the upper limit of the time period considered for the aggregation.

Once, all fundamental datasets corresponding to the time-frame of the period considered are aggregated, then the full set of the performance indicators are ready for reporting.

Hence, according to the technology of the present invention, the performance indicators for the previous day are ready for reporting, already shortly after midnight. Nevertheless, values for the performance indicators can already be retrieved at 22:00 or 23:00, providing Real-Time values for the performance indicators. Sometimes, some post-calculation is reasonable. Hence, for example under some circumstances (sparse data) to calculate the standard deviation (STDEV) of the cycle time should not be done at each update of the attributes CT and SQ_CT, but just when there is a new demand. This can be done any time by the GUIs.

Multidimensional data is continuously aggregated/calculated according to the disclosures as above. The technology can be embedded into the OLAP (MOLAP, ROLAP, etc.) server of any vendor, thus supporting online data analysis on cubes and snowflake schemas. Prior art period data aggregation/calculation of the Corporate KPIs used batch mode aggregation techniques, i.e. the aggregation jobs were started only after the corresponding data for the whole period was known to the system.

Some people argue that this strategy is very convenient, since at night the overall load on the database due to reporting/data analysis is significantly lower than during the usual business hours. The truth is that those systems have to support the nightly aggregation/computational load also during rush hours. Nightly aggregation/computation may crash or due to erroneous data the aggregation procedures have to be restarted at a later date.

FIG. 16 shows the transformation and aggregation engine (TAE) of the present invention as a component of a corporate Data Warehouse, satisfying the requirements for Real-Time continuous aggregation and including components like data marts, RBMSs, MOLAP, ROLAP or HOLAP systems.

Based on these operations, the aggregation and/or calculation becomes highly efficient, dramatically reducing memory and storage needs, since aggregation is continuously performed during the usual loading/transformation process. Additionally—due to optimized continuous aggregation methodology, adequate data structure and data flow and enhanced methods for the calculation of the performance indicators—the overall time needed for aggregation/calculation of the performance indicators as well as the CPU load can be reduced considerably.

Optimal performance associated with central (corporate) Data Warehousing is an important consideration of the overall approach. Due to the enhanced database structure and the calculation of the component values of the performance indicators, queries can access the most advantageous layers for analysis/reporting; having at their disposal the full range of aggregated structures and calculated performance indicators. Hence, Real-Time ad-hoc reporting and data analysis as well as Real-Time Knowledge Discovery becomes possible.

The scalable aggregation server of the present invention can be used in any Data Mart, RDBMS, MOLAP, ROLAP or HOLAP system environment for data analysis, reporting, Real-Time knowledge discovery, etc. The present invention enables any interrogation about corporate performance indicators in a most advantageous and general sense, including for example further details about particular markets, economic trends, consumer behaviors, and straightforwardly integrating any type of information system, which requires Real-Time data analysis and reporting capabilities. The scope of the present invention includes all fields of Data Warehousing, and, in more general terms, any information systems with regard to Real-Time aggregation capabilities or any Information Function (linear information framework).

The afore-defined methodology and systems of the present invention provides significant leeway in designing objectively grounded, generic and optimal Corporate Data Warehouses.

It is understood that the illustrative embodiments described herein above may be modified in a variety of ways, which will become readily apparent to those skilled in the art of having the benefit of the novel teachings disclosed herein. All such modifications and variations of the illustrative embodiments thereof shall be deemed to be within the scope of the present invention as defined by the claims of invention.

### EXAMPLES OF THE INVENTION

### Example 1

### Calculation of Information Functions as Generic Measures

Within the spirit of the present invention, any data of interest, which has to be captured, will be treated as a measurement, as measures, or as figures. Such figures may be given as performance indicators, engineering measurements, financial indicators, or any other data of interest. In a most abstract sense, a measure may not be a priori dedicated to specific contents of meaning. On this level, measures may be defined as organized assemblies or groupings of types of data (such as numerical data types, logical data types, data types incorporating specific internal structures (arrays, records etc.), pictures, sound representations, unstructured texts, and others). The aim of this approach is to enable and to support proper processing of any such kind of data, even if no informational content is given. Informational content may be dedicated to any such data within a separate step (i.e. a posteriori). Practical examples of this capability are definitions of sets or groupings of data types, which may be used and re-used within different informational contents. However, the following examples do not reflect on this most abstract capability.

### Example 2

### Calculation of Information Functions in the Semiconductor Industry

Within the present examples, an arbitrary time period will be considered for aggregation. The time period can be a working shift, a day, a week, a month, etc., but it is not restricted to the enumeration above.

The finest granularity of the basic atomic datasets in the examples is (material) unit, (production) step, timestamp, transcode, equipment, product, unittype, unitdesc.

The (material) unit is the manufactured item, which is tracked by the manufacturing and execution system (MES). In the semiconductor industry the (material) unit can be a lot, a wafer, a chip, etc. In order to simplify the notations, the term unit will be used instead of the material unit. In all other cases, the unit type will be explicitly mentioned (e.g. time unit, etc.).

The (production) step is the finest abstraction of the processing level, which is tracked by the reporting system. In order to simplify the notation, the term step is used meaning the production step.

The timestamp, which is related to a basic atomic dataset, defines the point in time when the corresponding event occurred, usually, with accuracy of seconds or milliseconds.

The equipment defines the “abstraction level” on which the material unit is processed at a production step. In practice, the equipment can be a physical equipment, a part (for example a chamber) of a physical equipment, a set of physical equipments or an abstract attribute, which is associated later to physical item during the production process.

The transcode denotes the event that is performed at a specific step and equipment during the production process. Common transcodes in the semiconductor industry are TrackIn, TrackOut, Create a Lot, Ship a Lot, etc. TrackIn defines the start (first event) of processing a unit at a certain step and equipment corresponding to a transaction from the processing point of view. TrackOut defines the last event of processing the corresponding unit at a certain step and equipment.

The product characterizes the manufactured item, (like technical specifications, etc.) which can be tracked within the production process.

The unittype is an additional distinction between the material units, such that the units are Productive, Development, Test, Engineering, etc.

The unitdesc contains the description of the material unit. In the semiconductor industry, the unitdesc can be lot, wafer, chip, etc.

The unitvalue represents the number of material units that are processed together.

The material unit enters the production system (production line), is processed at several steps according to the specifications of the route and leaves the system. Usually, the production flow is not linear; reprocessing (rework) is common in the semiconductor industry. Hence, each basic atomic dataset is expanded by the following attributes procID and transID. Some basic atomic datasets (including those having transcode=TrackOut) are expanded by the attribute subseqstep.

The attribute procID is an integer, which is incremented at each event (transcode) of the processing phase. Accordingly, procID shows the chronology of the production processes, i.e. its temporal evolvement.

The subseqstep specifies the next (subsequent) production step, which follows chronologically to the production step considered. This can be done according to the execution plans (routes). Sometimes, the decision which step shall be processed next can be taken by an operator.

The transID uniquely identifies the set of basic atomic datasets belonging to the same transaction in the processing phase. Commonly, some sort of identification is delivered in this respect by the MES. If this is not the case, then basic atomic datasets having the same value for unit, step, equipment, product, unittype, unitdesc, usually have the same transID.

The fundamental atomic datasets contain summarized information of the basic atomic datasets belonging to the same transaction, i.e. having the same transID. They contain all the information such that continuous aggregation techniques can be used on this level. The fundamental atomic datasets do not hold the attribute transcode of the basic atomic dataset. The following attributes are added in any case: TS TrackIn, TS TrackOut, TS PrevTrackOut. Additional attributes necessary to calculate the desired key performance indicators can be added accordingly.

TS_TrackIn is the value of the corresponding timestamp (point in time) of the basic atomic dataset with transcode=“TrackIn”; TS_TrackOut is the corresponding timestamp of the basic atomic dataset with transcode=“TrackOut” and TS_PrevTrackOut is equal to TS TrackOut of the previous (in chronological order) fundamental basic atomic dataset.

Raw Process Time (RPT) is the minimum production time to complete a step (or a group of steps) without considering waiting times or machine downtimes.

The fundamental atomic dataset is unique with respect to unit, step, equipment, product, timestamp, where timestamp can be one of the following: TS_PrevTrackOut, TS_TrackIn, TS_PrevTrackOut.

i) Calculation of the Uncorrected Standard Deviation (i.e. Without Bessel's Correction)

In statistics and probability theory, the standard deviation shows how much variation of dispersion from the average exists. A low value of the standard deviation indicates that the data points tend to be very close to the mean (also called expected value). On the contrary, a high value of the standard deviation indicates that the data points are spread out over a large range of values.

Let {1, 2, 3, . . . , N} be the number of datasets over which statistical computation (standard deviation) should be computed. Since the number of items is finite, with equal probabilities at all points,—this is common in the semiconductor industry—the uncorrected formula can be used:

$${s}_{N} = \sqrt{\frac{1}{N} {\sum }_{i = 1}^{N} {( {x}_{i} - \overline{x} )}^{2}}$$

where {x₁, x₂, x₃, . . . , x_{N}} are the observed values of the sample items and x̅ is the mean value of these observations. Bessel's correction (i.e. using

$$\frac{1}{N - 1}$$

instead of

$$\frac{1}{N}$$

in the formula above) is not necessary, since the correction is only applied, when estimating the populations standard deviation using a sample, if the populations mean is unknown.

The above formula for the calculation of the standard deviation cannot be applied at first glance with continuous aggregation techniques. The reason lies in the term (xᵢ−x̅)², i ∈ {1, 2, 3, . . . , N}, which can only be calculated if all datasets involved in the sample are known. In order to be able to apply continuous computational techniques, the aforementioned formula will be rearranged as follows: (termed computational formula of the standard deviation):

$${s}_{N} = \sqrt{\frac{1}{N} {\sum }_{i = 1}^{N} {x}_{i}^{2} - {( \frac{1}{N} {\sum }_{i = 1}^{N} {x}_{i} )}^{2}}$$

The representation of the standard deviation as above is very well known in the scientific literature. In order to avoid negative values in the calculation of the square root, due to calculation errors (cumulated rounding errors and the like), the following formula for the calculation of the standard deviation should be used.

$${s}_{N} = \frac{1}{N} \sqrt{\vert N {\sum }_{i = 1}^{N} {x}_{i}^{2} - {( {\sum }_{i = 1}^{N} {x}_{i} )}^{2} \vert}$$

The numerical error in total obtained by adding up a sequence of finite precision floating point numbers can be reduced substantially by using techniques of numerical analysis. In particular, using the compensated summation algorithm (see Kahan, 1965), large number of values can be summed up with an error that only depends on the floating point precision, i.e. it does not depend on the number of values. Alternative methods for improving the precision of the calculation of the standard deviation can be used (see Chan, 1983 and Chan, 1979). But, in most cases—if N is not very large, or

$$N {\sum }_{i = 1}^{N} {x}_{i}^{2}$$

is substantially greater than

$${( {\sum }_{i = 1}^{N} {x}_{i} )}^{2}$$

—the precision of the built in functions of the exemplary embodiments deliver sufficient accuracy such that additional algorithms to compensate rounding errors and the like are not necessary. On the contrary, if

$$N {\sum }_{i = 1}^{N} {x}_{i}^{2} ≅ {( {\sum }_{i = 1}^{N} {x}_{i} )}^{2}$$

then set S_{N}=0. This suffices for most of the practical cases.

The standard deviation was chosen as an example in order to exemplify the kind of transformation necessary to use continuous computational techniques.

Next, the following three additional attributes NoI, SQ CT and CT to store N,

$${\sum }_{i = 1}^{N} {x}_{i}^{2} and {\sum }_{i = 1}^{N} {x}_{i}$$

respectively are defined.

Another attribute (STDEV_CT) will then store the value of s_{N} for each N. The calculation of STDEV_CT is straightforward (using SQL syntax):

set STDEV_CT=1/NoI*SQRT(ABS(NoI*SQ_CT−SQUARE (CT)))

Hence, the complex formula for the calculation of the standard deviation has been reduced to a more advantageous one, with components which can be easily calculated within the continuous aggregation strategy. Therefore, in order to calculate the standard deviation, corresponding data structures will be set up in the aggregation layer. The low-level information regarding the values of the cycle time on the fundamental atomic dataset layer is not any more tracked to calculate the standard deviation. Instead, the sum of the cycle times and the sum of the square of the cycle times is tracked.

In order to calculate the throughput (TH), the cycle time (CT), the standard deviation of the cycle time (STDEV_CT) and the flow factor (FF), the following new attributes will be added to the each fundamental atomic dataset: TH, CT, SQ_CT, RPT.

The aforementioned attributes can be calculated only when the corresponding fundamental atomic dataset is closed. This is the case when the basic atomic dataset having the transcode equal to TrackOut—belonging to the same transaction, i.e. having the same transID—is processed and updates (i.e. completes) the aforementioned fundamental atomic dataset. Hence CT is set as the difference between TS_TrackOut and TS_PrevTrackOut and SQ_CT is set as CT*CT. The value of RPT (Raw Process Time) has to be loaded from some basic tables or calculated on-the-fly, according to the specifications.

Planned/unplanned reporting is already possible on the fundamental atomic dataset layer, since this layer has almost all the information of the basic atomic dataset layer. If necessary, additional attributes may be added. For example, the flow factor can already be calculated for a grouping and a time interval as:

/* ad-hoc query for flow factor */

select sum(CT)/sum(RPT) as FF

from . . .
where TS_TrackOut>‘24.03.2013 00:00:00’
and TS_TrackOut<=‘28.03.2013 00:00:00’

group by step, equipment, product, unittype, unitdesc

Additional KPIs can now be calculated. This may include aggregates of aggregates, relative KPIs and the like. For example, KPIs for weekly aggregations can be calculated in a straightforward manner based on the corresponding values of the KPIs of the daily aggregations (or any other KPI which is part of the target KPI).

The history of the production process is tracked, hence to each material unit, which is processed at a given production step and equipment, a basic atomic dataset with the relevant information is stored in the Data Warehouse. This dataset can contain additional information and it is not reduced to the aforementioned attributes. The repository (table) where the datasets are stored as above will be called material unit history. If the material unit, which is tracked is the lot, the repository will be denoted lot history.

According to the material unit history, to each particular fundamental atomic dataset (containing a step) the fundamental atomic dataset, which contains the previous step (chronologically related to the production flow), is unambiguously determined. The information, which is related to the previous fundamental atomic dataset, will be prefixed by Prey, e.g. PreyStep, PreyEquipment, etc.

ii) Continuous Aggregation Based on Atomic Components

The basic idea of the continuous aggregation is that the components for a specific Information Function (for example a specific KPI) are calculated while the fundamental atomic datasets are setup or updated in the Data Warehouse i.e. during the whole data supply period. In the semiconductor industry, the data supply is continuous and it is interrupted only by downtimes.

The scope of the continuous aggregation is to replace the classical batch oriented span aggregation process. For example, the nightly aggregation can last for several hours and it can be started only after midnight, when all the data involved in the aggregation has been previously loaded into the Data Warehouse. According to the disclosures of the present invention, the corresponding data is pre-calculated during the data load phase in a way that the daily KPIs can be easily displayed using (but not restricted to) the usual mathematical functions as sums, averages, MIN, MAX, etc., based on the pre-calculated data.

As previously mentioned, to each fundamental atomic dataset the previous (in chronological order) fundamental atomic dataset can be unambiguously determined. The fundamental atomic dataset is defined as holding at least the following compound information: unit, step, equipment, product, PeriodID, unittype, TS_TrackIn, TS_TrackOut, TS_PrevTrackOut. The attribute TS_PrevTrackOut is related to the corresponding previous fundamental atomic dataset. Other attributes (for example RTP) may be added.

iii) Computation of TS_CTIn and TS_CTOut

The following example is illustrated in FIG. 7

A timestamp includes all the information to characterize a point in time, i.e. year, month, day, hour, minute, seconds (possibly including fractions of seconds) for example 24.03.2013 14:25:59.734 but is not limited to the information above. The attributes

TS_EndOfPeriod denotes the time stamp corresponding to the end of the period considered for aggregation and the attribute TS_StartOfPeriod denotes the time stamp corresponding to the start of the period considered for aggregation, respectively.

The attributes TS_CTIn and TS_CTOut characterize the part of the cycle time related to the period involved. TS_CTIn is equal to TS_PrevTrackOut if TS_PrevTrackOut is within the period involved. If this is not the case, then TS_CTIn is equal to TS_StartOfPeriod. Similarly TS_CTOut is equal to TS_TrackOut if TS_TrackOut is within the period involved. If this is not the case, then TS_CTOut is equal to TS_EndOfPeriod.

Using SQL Syntax, the definition of TS_CTIn is as:

set TS_CTIn=(case when (TS_StartOfPeriod>TS_PrevTrackOut) then TS_StartOfPeriod else TS_PrevTrackOut end)

Analogously, the definition of TS_CTOut is as:

set TS_CTOut=(case when (TS_EndOfPeriod<TS_TrackOut) then TS_EndOfPeriod else TS_TrackOut end)

/* part of the CT related to the period considered */

set Fract_CT=(case when Datediff(ss, TS_CTOut, TS_CTIn)>0) then Datediff(ss, TS_CTOut, TS_CTIn) else 0 end)

/* total value of CT */

set CT=(case when (TS_TrackOut>TS_PrevTrackOut) then Datediff(ss,TS_TrackOut, TS_PrevTrackOut) else 0 end)

/* Flow factor (FF) for the period considered */

select sum(CT)Isum(RawProcessTime) as FF

from . . .

group by Period_ID, step, equipment, product, unittype, unitdesc

iv) Establishing the Aggregation Layer

An overview of the relationships of the elements of the aggregation process is illustrated in FIGS. 9.1, 9.2, 9.3.

The methodology presented above can be improved by establishing an aggregation layer. The present invention does not contain any restriction regarding how this layer is implemented (persistent, or by views, etc.).

The attribute (material) unit is not any more tracked at the aggregation layer. Accordingly, the attribute timestamp (which tracks the point in time when events related to the material unit occurred) is obsolete. The aggregated data is expressed in terms of (production) step, equipment, product, unittype, unitdesc. Additional attributes are considered as mentioned below. In any case, the attribute period_ID, a unique identifier for the aggregation period has to be considered.

Dependent on the KPIs, which are to be calculated, some attributes to store the KPI values on the aggregation layer have to be defined:
NoI (Number of items)
TH (Throughput i.e. the number of units which were processed)
CT_FP (fraction of the cycle time related to the period considered)
CT (Cycle Time calculated as Sum (TS_TrackOut−TS_PrevTrackOut))

SQ_CT (Square of the Cycle Time)
RPT (Raw Process Time)
FF (Flow Factor based on CT and RPT)

Usually, the attributes NoI and TH are equal, but there are some rare cases where a distinction is appropriate (e.g. batch jobs, where a bunch of items is processed together, etc.).

The aforementioned structure permits drill up functionalities in a straightforward way. For example, the attribute “product” can be summarized to “product group”, which can be further summarized to “product class”, further to “technology”, etc. Then for example, the Throughput for a product group can be calculated straightaway by summing up the Throughput for the products being part of the product group. Similar considerations hold for the product class or technology.

The challenge of the continuous aggregation is to adapt the KPIs and the like, such that the aforementioned techniques can be applied. Usually, performance indicators and other Information Functions are defined on the lowest granular levels of decompositional system models. As a consequence, performance indicators are in many cases aggregations of such absolute indicators (relative indicators are to be aggregated in the same manner).

But in other cases, more effort is required; some of the most fundamental cases are defined within the present invention (example: Cp and Cpk methods could be straightforward derived out of the statistical aggregation methods defined in the present invention, i.e. out of the standard deviation).

In order to use the continuous Real-Time methodology of the present invention, sometimes employing linearization techniques,—i.e. finding linear representations for the performance indicators—is unavoidable. All suitable linearization methods and strategies are thus comprised by the present invention. One of the most common strategies is to split the performance indicator into components which are linearizable i.e. find functions F, fᵢ with i ∈ {1, 2, . . . , n}, such that the performance indicator involved is equal to F(f₁, f₂, . . . , fₙ) such that the functions fᵢ are linearizable.

The example using the standard deviation highlights that by using the methodology of the present invention aggregation processes are significantly simplified and achieve maximal efficiency in comparison to prior art. This leads to important source code reduction, manageable, fault tolerant and efficient algorithms, which leads to robust, high available Data Warehouse environment.

### Example 3

### Statistical Methods

More generally, statistical methods are typically applied to finite sets of elements. This holds especially true for corresponding algorithmic definitions and implementations within the context of Data Warehousing, or even any computer related implementation of statistical methods. In particular, the most common statistical methods are induced by linear or linearizable functions. From the viewpoint of currently used typical definitions and practices regarding statistical methods, it may look sometimes uncommon to define and to use the continuous aggregation and/or computation techniques as disclosed in the present invention. But given the finiteness of sets within the context of any finite computing environment, it becomes clear that any statistical method may be defined in the scope of linear models (including all advantages of the linear model, as already mentioned supra). In the following, 3 examples within this context: MEDIAN, MAX/MIN, AVERAGE, and ABSOLUTE DEVIATION.

i) MEDIAN

In statistics and probability theory, the median is the numerical value separating the higher half of a data sample from the lower half. If there is an even number of observations, the median is usually defined to be the mean of the two middle values. In order to identify the median M of a finite sample, two heaps will be used, one heap referred as “h” for the lower part of the data and one heap referred as “H” for the higher part of the data. In addition to the usual functions (create, find-MAX, find-MIN, delete-MAX, delete-MIN, insert) the set of functions will be extended by “find-num-elem”, which returns the number of elements in the heap. Each new element is inserted either in the “h” heap or the “H” depending whether its value is lower or equal to find-MAX (“h”) or it is higher than find-MIN (“H”). If one of the heaps contains more elements then the other and the total number of elements is even, then the two heaps are balanced against one another such that both heaps contain the same number of elements and the heap “h” contains the lower half of the data sample and the heap “H” contains the higher half of the data, i.e. find-MAX (“h”)<find-MIN (“H”).

The identification of the median M of the sample data is straightforward, if both heaps contain the same number of elements then M:=(find-MAX(“h”)+find-MIN(“H”))/2. If for example, the heap “H” contains more elements (one more element than “h” according to the algorithm above) then M:=find-MIN(“H”). Similar results are valid if the heap “h” is larger. Optimized algorithms for the calculation of the MEDIAN have also been considered in prior art by other authors (see Chiou et al., 2001). Chiou et al. use early grouping techniques combined with partial integration in order to provide more opportunities for the query optimizer to find optimal plans since “all possible placements of the GROUP BY operators it the query are considered during the optimization process.” Chiou et al. considered the case in which a set S contains n values v₁, v₂, . . . , vₙ. By eliminating the duplicates among the values, S can be represented as a set of pairs S′={(v′ᵢ, a_{I})} where v′ᵢ is one of the distinct values in S and aᵢ is the number of duplicates of v′ᵢ in S. The approach used by Chiou et al. can degenerate in a simple list without duplicates if the measurement values v′ᵢ are real numbers, their approach having no benefit at all. Given this approach, the evaluation of MEDIAN cannot be started until the entire input to this function has been collected. This creates important disadvantages within the context of Real-Time aggregation and, more general, with Real-Time Data Warehousing.

Using the method of the present invention, the median M of a finite sample can be determined without explicitly storing all individual data of the sample, as mentioned by Chiou et al. According to the present invention, at each point in time, the data is pre-calculated in such a way (inserts in the two heaps and balancing as described above) that the median M is retrieved straightforward by performing comparisons and a couple of atomic queries on the heap. The main advantage of the algorithm of the present invention is that it uses heaps, which are standard features of almost all commercially available databases and that it supports the concept of continuous aggregation and Real-Time reporting.

ii) MAX/MIN

Even if deletions from the basic tables are allowed, and the aggregation values have to be recalculated, then the present invention supports straightforward and effective methods, in comparison to prior art. An example is the statistical parameter MAX-value, which might be affected, if certain elements will be deleted (and the value of the parameter MAX-value has to change accordingly). Within the scope of linear models a heap is used, and referred to as “h”, in order to contain the MAX-value stored (see also the previous paragraph, concerning the calculation of Median). The list of the procedures accessing the heap has to be enlarged by delete (“h”, V) to remove the value of the deleted element from the heap. Similar considerations are valid for the statistical MIN-value.

iii) Average Absolute Deviation

Some statistical parameters exist, which require all values in order to be calculated. But nevertheless, within the scope of linear models such parameters can be calculated in an advantageous manner. For the requirements of those cases, all values will be kept in a linear structure. As an example, the statistical parameter Average Absolute Deviation will be considered. Let AVEDEV be the average of the absolute deviations of values from their respective mean value. Let N be the number of datasets (size of the sample) over which statistical computation (AVEDEV) are to be computed. Then

$${AVEDEV}_{N} = \frac{1}{N} {\sum }_{i = 1}^{N} \vert {x}_{i} - \overline{x} \vert$$

where {x₁, x₂, x₃, . . . , x_{N}} are the observed values of the sample items and x̅ is the mean value of these observations. The above formula requires that for the calculation of the average of the absolute deviations all values |xᵢ−x̅|, i ∈ {1, 2, 3, . . . , N} need to be considered.

According to Nelson (2007), the AVEDEV function isn't really used in practice. Mostly a teaching tool, educators and trainers sometimes use the average deviation of dispersion to introduce the more useful but also more complicated measures of dispersion, the standard deviation and variance. However, although no summation method seems to exist in this case, using continuous aggregation techniques may be applied in an advantageous manner. The proposed method includes an additional linear data-structure, where the terms xᵢ with i ∈ {1, 2, 3, . . . , } are stored as soon as they are uploaded to the system. The linear data-structure defined as above supports fast procedures as “append”, “create” and corresponding functions for the calculation. Any new fundamental atomic dataset involved in the continuous aggregation methodology performs an “append” with the corresponding argument xᵢ. The values of AVEDEV can be retrieved by the data analysis tool or calculated on demand at any point in time.

### Example 4

### Partial Period Aggregation

This example introduces the method, which supports partial period aggregation of performance parameters. The scope of this method is to enable accurately aggregated performance parameters at any point in time in Real Time. Prior art does not consider this method, which is on the other side an important functionality of Real-Time Data Warehousing.

Suppose P=[t_{S}, t_{E}]:={t ∈ R|t_{S}≦t≦t_{E}} is a valid period for aggregation. As aforementioned, the methodology disclosed within this inventions facilitates continuous partial span aggregation, i.e. aggregation over the period [t_{S}, t] for any t:t_{S}<t≦t_{E}. Hence, partial values of the KPIs for each t with t_{S}<t≦t_{E} (for the period [t_{S}, t]) are calculated within the continuous loading, transformation and aggregation process. As an example, the calculation of the partial values of the cycle time is considered. When a (material) unit has been processed at a certain step, then due to logistical reasons the subsequent step of the production chain is already determined and known to the system. Hence, for the fundamental atomic dataset (unit, step, equipment, product, unittype, unitdesc, TS_TrackOut, . . . ,) the attribute subseqstep, which denotes the subsequent step within the production chain, is well defined. Similar considerations are not valid for the subsequent equipment on which the (material unit) will be processed at the next step. This information is only available when the (material) unit is assigned to dedicated equipments, usually during the TrackIn process. Hence, for the grouping (step, product, unittype, unitdesc) the present invention provides a more straightforward definition of the average cycle time as in prior art. Usually, for the grouping as above and the period P, the classical approach to define the average cycle time avgCT is

$$avg CT := \frac{1}{N} {\sum }_{i = 1}^{N} ( {TS\_TrackOut}_{i} - TS\_Pr {evTrackOut}_{i} ) ,$$

where N is the number of basic atomic datasets having TS_TrackOut within the period P:=[t_{S}, t_{E}] considered.

It needs to be highlighted, that the aforementioned formula is not erroneous or inaccurate.

Within the linearized model of the present invention, a more straightforward expression of the average cycle time can be given by considering the period P:=[t_{S}, t_{E}] in the calculations. The starting point and motivation for the alternative approach is that the aforementioned formula relies on the timely association of the calculation of the cycle time to TS_TrackOut, a point in time which can be outside the period considered. This shows significant impact especially for sparse data and small periods.

Let X:={x₁, x₂, x₃ , x_{N}} be the set of the fundamental atomic datasets of the material units considered for the calculation of the average cycle time for the period P:=[t_{S}, t_{E}]. This means

(TS_PrevTrackOut<t_{E}) and [(TS_TrackOut>t_{S}) or (TS_TrackOut is NULL)]

for each xᵢ ∈ X. The value NULL for TS_TrackOut means that this value will be set at a time point t such that t>t_{E}. Set

TS_CTIn:=TS_PrevTrackOut if (TS_PrevTrackOut≧t_{S}) else t_{S}

while t_{S} is defined above as the lowest bound of P.

Hence TS_CTIn is equal the TS_PrevTrackOut if TS_PrevTrackOut is within the period [t_{S}, t_{E}] considered. If this is not the case (i.e. TS_PrevTrackOut is lower than t_{S}) then TS_CTIn is equal to t_{S}.

Fix t ∈ (t_{S}, t_{E}]. Let Y^{t}:={xⱼ_{₁}, xⱼ_{₂}, xⱼ_{₃}, . . . , xⱼ_{ₙ}} ⊂ X be the subset of X such that TS_TrackOut is NULL at time t. As aforementioned, N is the cardinality of X and n is the cardinality of Y^{t}, where the cardinality of a set denotes the number of elements of it.

In order to calculate the average cycle time of the above grouping (considering partial period aggregation over the period [t_{S}, t]), three new additional attributes n, N, Sum_CT are considered. The first two attributes are calculated according to the definition above. The third attribute is calculated as follows:
a) Initialize Sum_CT=0 for the grouping (step, product, unittype, unitdesc) and the period P considered.
b) For each basic atomic dataset xⱼ_{ᵢ} ∈ Y^{t} set CTᵢ^{t}=(t−TS_CTIn)
c) For each basic atomic dataset xᵢ ∈ X \Y^{t} (i.e. t_{S}<TS_TrackOut≦t_{E}), the following entry is performed against the aggregation layer:

Sum_CT=Sum_CT+(TS_TrackOut−TS_CTIn)

The average cycle time for any t such that t_{S}<t≦t_{E} is then equal to (n, N, CT calculated at time t as disclosed above)

$$avg {CT}_{Period}^{t} = \frac{1}{N} ( Sum\_CT + {\sum }_{i = {j}_{1}}^{{j}_{n}} {CT}_{i}^{t} )$$

Hence, the attribute Sum_CT is updated each time the attribute TS_TrackOut for xᵢ ∈ X \ Y^{t}^{_{E}} is set (as described above). The term

$${\sum }_{i = {j}_{1}}^{{j}_{n}} {CT}_{i}^{t}$$

is then calculated on demand or at the end of the aggregation period.

The example above, t=t_{E} illustrates the post-aggregation strategy as used throughout this invention.

Alternatively, a pre-aggregation approach can be used as follow: Set CTᵢ^{t}^{_{E}}=(t_{E}−TS_CTIn) for each xᵢ ∈ X and add CTᵢ^{t}^{_{E}} to the total Sum_CT as soon as the unit x, is available for aggregation (units with TS_PrevTrackOut<t_{S} are already known at the start of the aggregation period hence the term pre-aggregation). When the attribute TS_TrackOut is set for a unit xᵢ ∈ X (t_{S}<TS_TrackOut≦t_{E}) then the value (TS_TrackOut−t_{E}) is added to Sum_CT. This way, for any t ∈ (t_{S}, t_{E}) the attribute Sum_CT contains the correct value necessary to calculate the average cycle time:

$$avg {CT}_{Period}^{t} = \frac{1}{N} ( Sum\_CT )$$

No post-aggregation is necessary.

The afore-calculated avgCT_{Period}^{t} gives the average length of time, the items spent in the system (during the period P^{t}:=[t_{S},t] at a specific production step and the like).

The disclosures above illustrate the possibilities of the new invention to calculate in Real Time the performance indicators for a partial period, rather than to introduce new methods of definition and calculation of the average cycle time.

Let t−t_{S} be the length of the period P^{t}:=[t_{S},t] considered within this example, and let Th_{P} be the throughput (during the period P^{t} at a specific production step and the like). Then

$$N \frac{avg {CT}_{Period}^{t}}{{t}_{E} - {t}_{S}}$$

is equal to the average WIP (Work in Process) relative to the period P^{t} considered (at a specific production step and the like). Little's Law can be applied.

Important performance indicators in order to characterize the progress of the production process during the working-shifts are calculated in Real Time. Thus performance bottlenecks of the production line can be identified even before repercussions on the production capacity occur, thereby avoiding disadvantageous effects such as loss of earnings.

### Example 5

### Calculation of the Overall Equipment Efficiency

Another example for industrial KPIs is the “Overall Equipment Efficiency” (OEE) Index. According to ISO/DIN 22400-2 the OEE Index is defined as follows:

OEE Index=Availability*Effectiveness*Quality rate, whereas
Availability=PDT/PBT (PDT: Production time/producing time of the machine, PBT: Planned busy time)
Effectiveness=PTU*PQ/PDT (PTU: Production time per unit, PQ: Produced quantity)
Quality Rate=GQ/PQ (GQ: Good quantity produced, PQ: Produced quantity)

All primary measures like PDT, PBT, etc., are composed of individual summations. In detail, the Production time PDT is composed of a summation of single Production times: PDT=PDT₁+PDT₂+PDT₃+ . . . +

Many other KPIs are defined accordingly, for example “Net Equipment Productivity” (NEE), “Uptime”/“Downtime”, “Mean Time between Failure” (MTBF), “Mean Time between Assist” (MTBA), “Mean Time to Repair” (MTTR).

### Example 6

### Real-Time Calculation Of The Process Capability Indicators Cp And Cpk

Another example is the Real-Time calculation of the process capability indicators Cp and Cpk. “Process capability analysis entails comparing the performance of a process against its specifications . . . . A process is capable if virtually all of the possible variable values fall within the specification limits”.

(http://www.itl.nist.gov/div898/handbook/ppc/section4/ppc46.htm)

Numerically, the capability is measured with a capability index Cₚ is:

$${C}_{p} = \frac{USL - LSL}{6 σ}$$

σ is the standard deviation of the normal data; USL and LSL are the upper and lower specification limits, respectively.

The only problem with the Cₚ index is that it does not account for a process that is off-center. The equation as above can be slightly modified to obtain the Cₚₖ index as follows:

$${C}_{pk} = min [ \frac{USL - μ}{3 σ} , \frac{μ - LSL}{3 σ} ]$$

μ is the mean of the normal data.

### Example 7

### Further Examples from Financial Sector

Another example from the financial sector is the “average collection period”, which is the average number of days between the day the invoice is sent out and the day the customer pays the bill. As a next example, the “Break Even Point” is calculated as: Fixed Costs/(1−Variable Costs/Sales). The “Cash Ratio” compares the company's Cash and Marketable Securities with its current Liabilities: Cash Ratio=(Cash+Marketable Securities)/Current Liabilities*100. The “Economic Profit” EP is a periodic measure based on the principles of shareholder value. EP shows if the company is creating value for the shareholder.

EP=((Net Operating Profit after Taxes/Capital)−Cost of Capital); etc.

Consequently, all of the performance indicators and the like (considered as functions) used in the various fields of technology, business, banking sector, but not restricted to the enumeration above, hold linear composing functions (for example: standard deviation; the components are calculated by summing up the partial result).

i) Interest on Interest

Another example is interest on interest (financial sector). Consider the daily calculation of the interests for a period of time (month, year, etc.) having variable daily interest rates xᵢ on day Dᵢ (for the sake of generality) for a given bank account. Let Cᵢ be the amount on the account on day Dᵢ considered for the calculation of the daily interest, and let Xᵢ:=Cᵢ□xᵢ be the interest on day Dᵢ. The amount Cᵢ for the day Dᵢ considers payments and other transactions as well as the interests Xᵢ₋₁ of the previous day. Hence, the interest X_{P} for a given period of time P can be calculated by adding up the interests Xᵢ of each day Dᵢ belonging to P as

$${X}_{P} = {\sum }_{{D}_{i} ∈ P} {X}_{i} .$$

The essence of this example is to show that the indicator “interest of interest” looks nonlinear at first glance, but in fact it can be used within the Real-Time continuous aggregation methodology of the present invention. The reason is, that the definition of this indicator composes strictly linear relationships.

ii) Methodology to Setup Linear Spaces and Corresponding Information Functions

The existence of linear models is an essential part of the methodology of the present invention. This example will clarify the methodology to correctly setup linear spaces and corresponding Information Functions. For the sake of generality, this example considers the “mean absolute deviation” as the Information Function.

Let {1, 2, 3, . . . , Nₚ} be the number of datasets over which statistical computation (mean absolute deviation) for the product p is to be computed. The mean absolute deviation for the product p is defined as:

$${D}_{p}^{m} := \frac{1}{{N}_{p}} {\sum }_{i = 1}^{{N}_{p}} \vert {x}_{i} - \overline{x} \vert$$

where Xₚ:={x₁, x₂, x₃, . . . , x_{N}_{ₚ}} are the observed values of the sample items for the product p and x̅ is the mean value of these observations.

Consider additionally the product q. Let analogously {1, 2, 3, . . . , N_{q}} be the number of datasets over which the mean absolute deviation for product q is computed. Then:

$${D}_{q}^{m} := \frac{1}{{N}_{q}} {\sum }_{i = 1}^{{N}_{q}} \vert {y}_{i} - \overline{y} \vert$$

where Y_{q}:={ y₁, y₂, y₃, . . . , y_{N}_{_{q}}} are the values of the sample items for the product q and y̅ is the mean value of these observations.

Let

Z_{p⊕q}={z₁, z₂, z₃, . . . , z_{N}_{ₚ}_{+N}_{_{q}}}:=Xₚ ⊕ Yₚ={x₁, x₂, x₃, . . . , x_{N}_{ₚ}, y₁, y², y₃, . . . y_{N}_{_{q}}}

be the values of the observations for the product p and the product q respectively. Let z̅ be the mean value of the sample items in the set Z_{p⊕q}. Define

$${D}_{p}^{m} ⊕ {D}_{q}^{m} := \frac{1}{{N}_{p} + {N}_{q}} {\sum }_{i = 1}^{{N}_{p} + {N}_{q}} \vert {z}_{i} - \overline{z} \vert$$

Set F:={0,1}. Then F is a field (with the usual addition and multiplication).

Let P be the set of all products, let <(S, ⊕, )> be the space generated by the sample items of all products r ∈ P. The symbol denotes the scalar multiplication.

Then Xₚ ∈ S and Y_{q} ∈ S.

Let <(D, ⊕, )> be the space generated by the mean absolute deviations of all products r ∈ P.

The symbol denotes the scalar multiplication. Then Dₚ^{m} ∈ D and D_{q}^{m} ∈ D.

Let MAD be the Information Function defined as follows:

MAD: <(S, ⊕, )> [symbol] <(D, ⊕, )>

$${X}_{p} := \{ {x}_{1} , {x}_{2} , {x}_{3} , … , {x}_{{N}_{p}} \} \to {D}_{p}^{m} := \frac{1}{{N}_{p}} {\sum }_{i = 1}^{{N}_{p}} \vert {x}_{i} - \overline{x} \vert$$

The linearity of the Information Function MAD follows immediately

MAD(Xₚ ⊕ Y_{q})=MAD(Xₚ) ⊕ MAD(Y_{q})

Accordingly, the present invention and corresponding methodology is consistently defined within the scope of linear spaces and corresponding linear system models.

Results and Conclusions

This analysis shows that all such performance indicators, including statistical indicators, are defined and calculated by linear compositions of certain base values (and may also include the usage of other performance indicators as input values and/or relative indicators). Given this analysis, it becomes evident that such performance indicators and measures are creating a linear space in the strict mathematical sense.

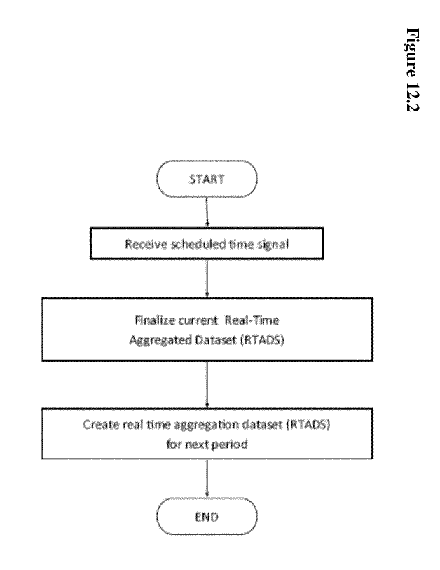

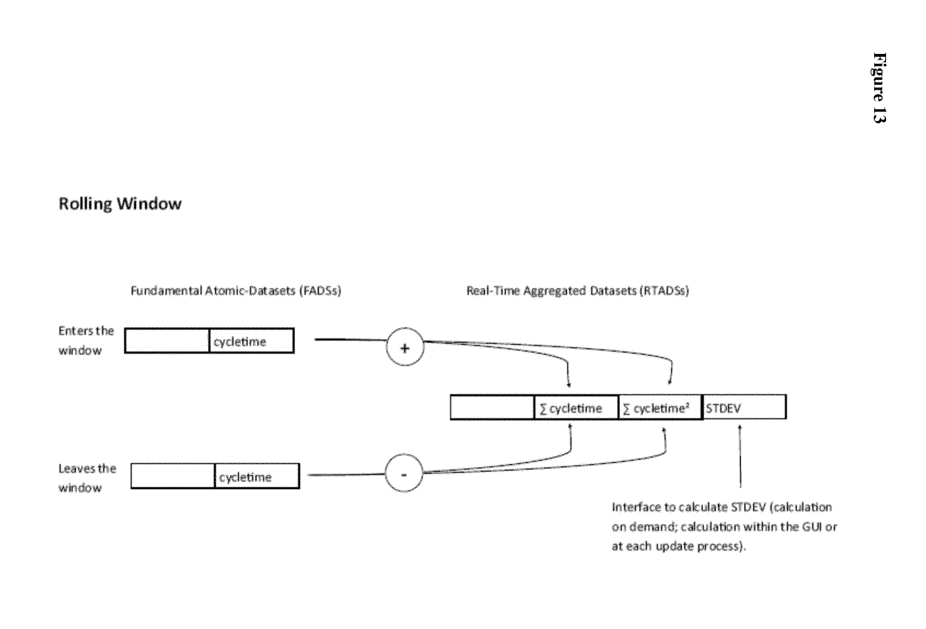

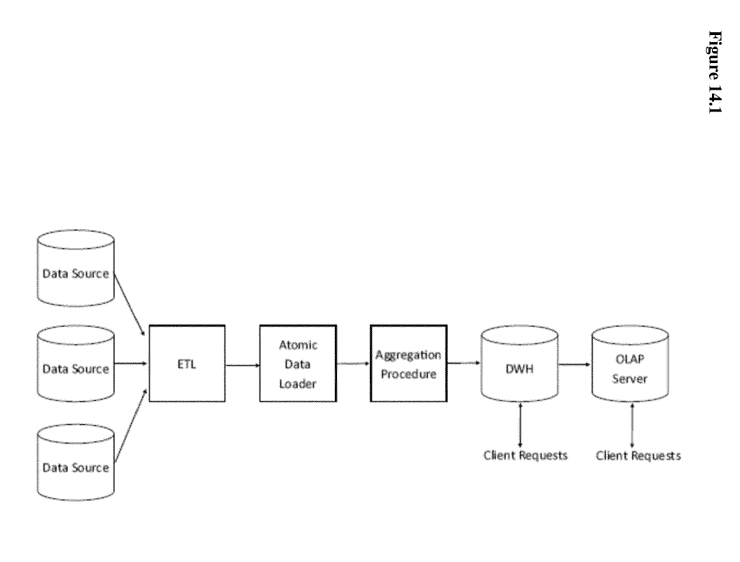

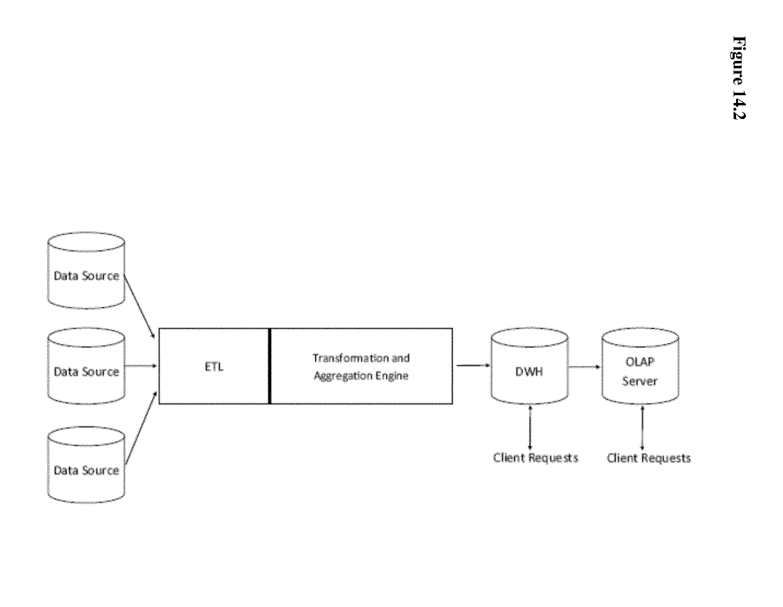

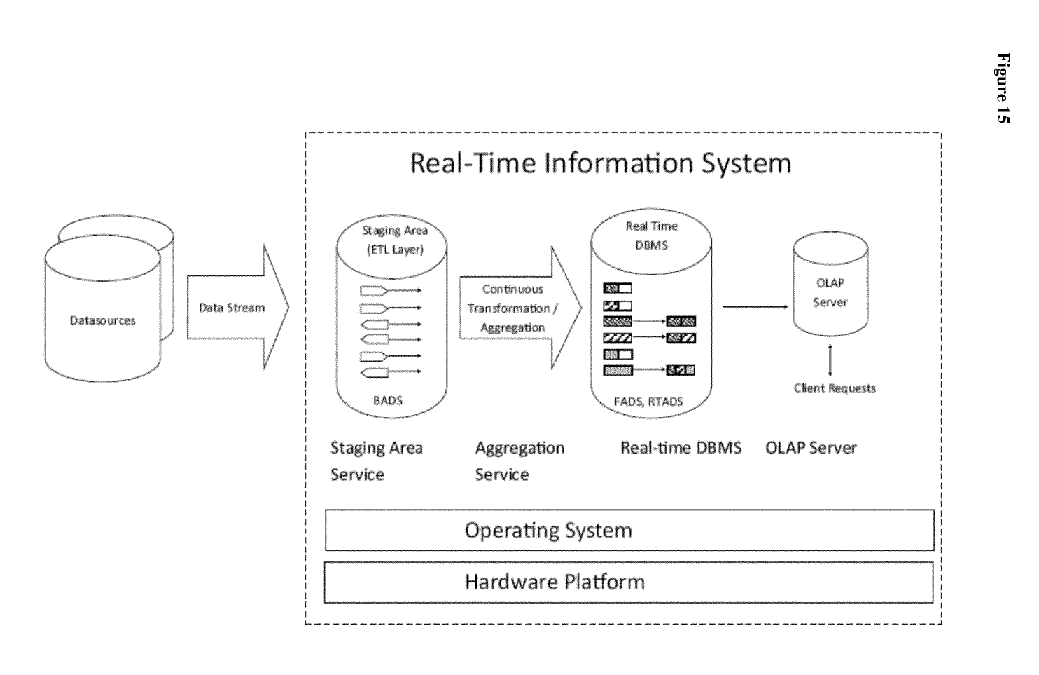

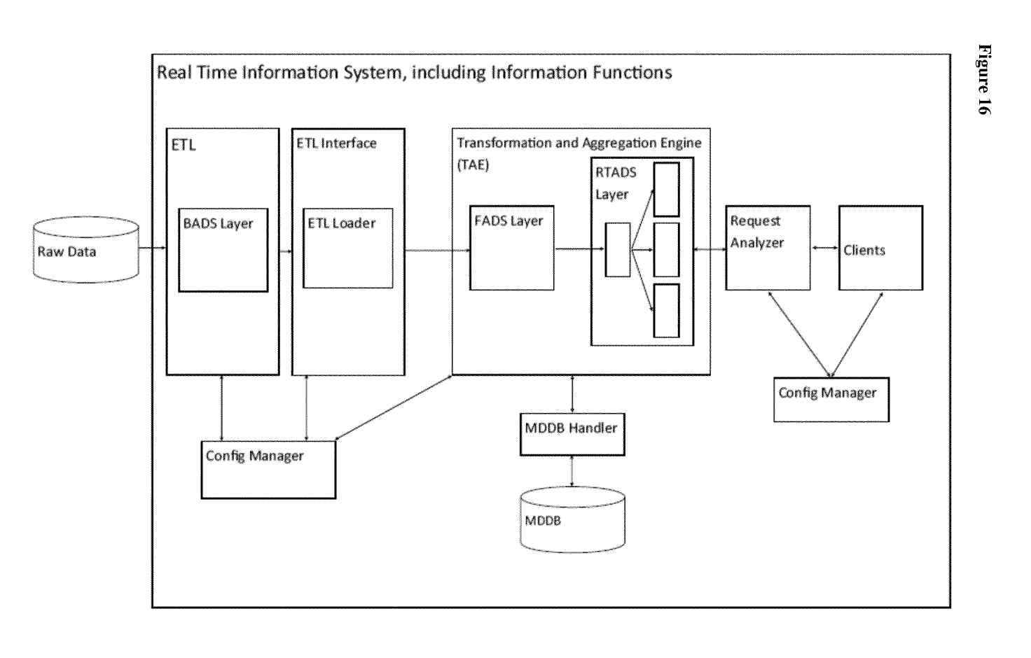

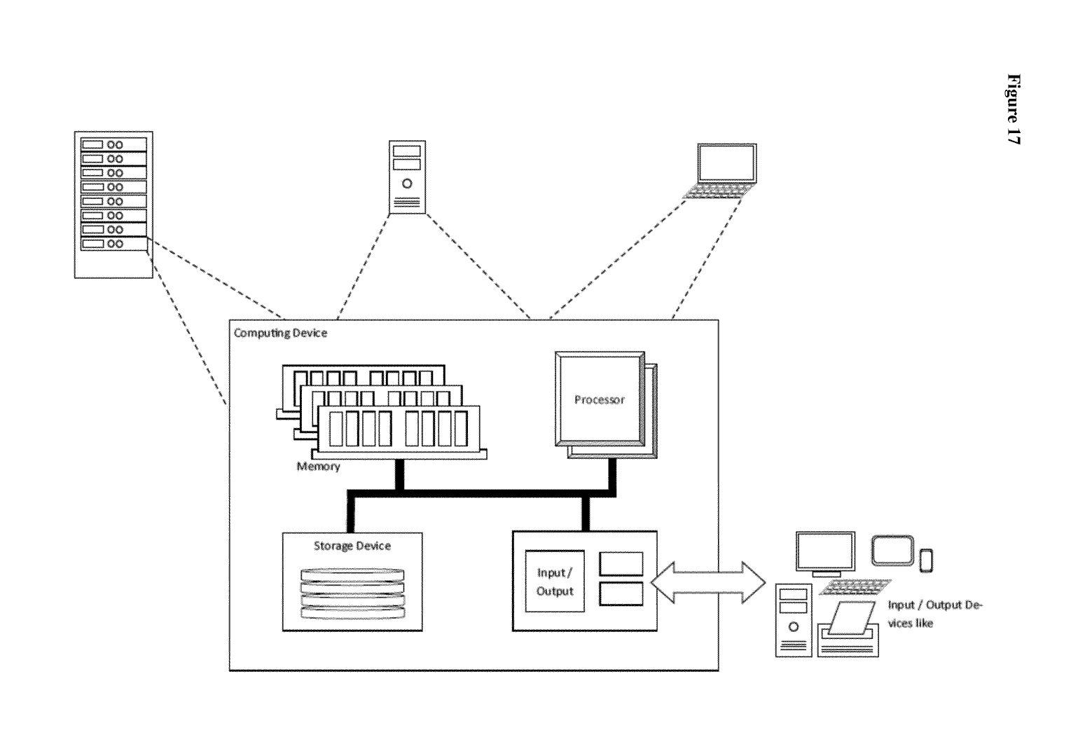

A detailed description of new design principles as based on the new methodology is given throughout the drawings, specification and claims of the present invention. These design principles are of great influence on the selection of the preferred embodiments as presented within this invention. For this reason, such design principles are now summarized in terms of guiding rules and principles. This set of rules and principles should support users in order to design iterations with regard to preferred embodiments in order to set up the envisaged Real-Time Information System.
Given are certain requirements with regard to the finest granularity the system and method should provide (that is: structure of basic atomic dataset layer). This finest granularity—in combination with the adequate data streams and data volumes—will serve as an important input in order to design the Real-Time behavior of the system and method to and the required hardware in order to properly support highly parallelized and distributed systems and methods. Thereby, in order to allow parallelization and minimum resource consumption, all required Information Functions should be analyzed—in a structured manner—with regard to linearizability, within the context of the underlying informational spaces.
Given this system design and operational model, proper hardware components are to be selected, by following the preferred software engineering process. Performance peaks—due also to variations in data volumes—should be avoided by clearly separated, parallelized task, which are uniformly distributed over the entire loading and transformation period. The present invention enables and supports the capability to design such tasks in terms of nearly identical complexity and similar content. This feature should be extensively used in order to smoothen and sustainably reduce the overall system load. Details of FIG. 3 may be used in order to design the system model.
The abstract system design should be mapped straightforward to available functionality with regard to hardware-components. Given this, overall efficiency including algorithmic efficiency of the system can be evaluated and the overall costs can be compared with the available budget. Different possible embodiments should be evaluated and compared.
In close cooperation with the users, potentially new features and functionalities may become worked out. The present invention pertains to a closer and more agile cooperation of all involved partners, including developers, users, operating staff, and management. Within this scope, software engineering evolves towards an objectively grounded methodological approach, which is capable to deliver objectively-anchored best solutions to customers.

### ABBREVIATIONS

APC Advanced process control

AVEDEV Average of the absolute deviations of data points from their mean

AVG Average

BADS Basic atomic dataset

BI Business intelligence

CIM Computer integrated manufacturing

CPU Central processing unit

CT Cycle time

CT_FP Fraction of the cycle time related to the period considered

DBMS Data base management system

EDC Engineering data collection

EI Equipment integration

ERP Enterprise resource planning

ETL Extract, transform and load

FADS Fundamental atomic data set

FF Flow factor

GUI Generic Application

HOLAP Hybrid Online Analytical Processing

I/O Input/output

IN Input

IT Information technology

KDD Knowledge discovery in databases

KPI Key performance indicator

MAX/MIN Maximum/minimum

MDDB Multi-dimensional data base

MES Manufacturing execution systems

MOLAP Multidimensional online analytical processing

MVSB-tree Multivers ion sequencially efficient B-tree

NoI Number of items

NoSQL Not only structured query language

OFE Overall factory efficiency

OLAP Online analytical processing

OLTP Online transaction processing

OUT Output

Per Period

RDBMS Relational data base management system

ROLAP Relational online analytical processing

RPT Raw process time

RTADS Real-Time aggregated dataset

RTOLAP Real-Time online analytical processing

Rw Rework transaction

SB-tree Sequencially efficient B-tree

SDD Software design description

SLA Service-level agreement

SPC Statistical Process Control

SQ Square

SQ_CT Square of the cycle time

SQL Structured query language

SRw Sum of rework transactions

STDEV Standard deviation

STr Sum of transactions

TAE Transformation and aggregation engine

TH Throughput

Tr Transaction

TS Timestamp

WEKA Waikato Environment for Knowledge Analysis

WIP Work in process

### REFERENCES

### Patent Documents

Arackarparambil, John F. et al.: “Computer Integrated Manufacturing Techniques” U.S. Pat. No. 7,174,230 B2, 2007, 2002, whole document.

Bakalash, Reuven et al.: “Method of and apparatus for data aggregation utilizing a multidimensional database and multi-stage data aggregation operations”, Pat. No.: US, 2002/0184187 A1, Dec. 5, 2002, whole document.

Bakalash, Reuven et al. : “Stand-alone cartridge style data aggregation server and method of and system for managing multi-dimensional databases using the same”, Pub. No: US, 20030018642 A1, Jan. 23, 2003, whole document

Bakalash, Reuven et al.: “Data aggregation server for managing a multi-dimensional database and database management system having data aggregation server integrated therein”, Pat. No.: 205/0065940 A1, Mar. 24, 2005, whole document.

Bakalash, Reuven et al.: “Database management system having a data aggregation module integrated therein”, Pat. No.: US, 2002/0129032 A1, Sep. 12, 2002, whole document.

Bakalash, Reuven et al.: “Relational database management system (RDBMS) employing a relational datastore and a multi-dimensional database (MDDB) for serving query statements from client machines”, U.S. Pat. No. 8,195,602 B2, Jun. 5, 2012, whole document.

Bakalash, Reuven et al.: “Enterprise-wide data-warehouse with integrated data aggregation engine”, U.S. Pat. No. 7,315,849 B2, Jan. 1, 2008, whole document.

Bakalash, Reuven et al.: “Data aggregation module supporting dynamic query responsive aggregation during the servicing of database query requests provided by one or more client machines”, U.S. Pat. No. 8,041,670 B2, Oct. 18, 2011, whole document.

Bakalash, Reuven et al.: “System with a data aggregation module generating aggregated data for responding to OLAP analysis queries in a user transparent manner”, U.S. Pat. No. 8,170,984 B2, May 1, 2012, whole document.

Bakalash, Reuven et al.: “Method of servicing query statements from a client machine using a database management system (DBMS) employing a relational datastore and a multi-dimensional database (MDDB), U.S. Pat. No. 8,321,373 B2, Nov. 27, 2012, whole document.

Callahan, Joseph M: “Event performance data aggregation, monitoring, and feedback platform”, Pat. No.: US, 2012/0290594 A1, Nov. 15, 2012, whole document.

Chkodrov, Gueorgui Bonov et al.: “Maintaining time sorted aggregation records representing aggregations of values from multiple database records using multiple partitions”, U.S. Pat. No. 7,149,736B2, Dec. 12, 2006, whole document.

Chkodrov, Gueorgui Bonov et al.: “Self-Maintaining real-time data aggregation”, Pat. No.: US, 2005/0071320 A1, Mar. 31, 2005, whole document.

Diaconu, Cristian et al.: “In-memory database system”, Pat. No.: US, 20110252000 A1, 2011, whole document.

Fedorov, Sergey: “Method and apparatus for integrating data aggregation of historical data and real-time deliverable metrics in a database reporting environment”, Pat. No.: US, 20040059701 A1, Mar. 25, 2004, whole document.

Fukuda, Etsuo et al.: “Semiconductor production System.”, U.S. Pat. No. 5,694,325, Dec. 2, 1997, whole document.

Gozzi, Andrea: “Method of calculating key performance indicators in a manufacturing execution system”, Pat. No.: US, 2009/0105981 A1, Apr. 23, 2009, whole document.

Guzik, Grzegorz at al.: “Key performance indicator system and method”, U.S. Pat. No. 7,822,662 B2, Oct. 26, 2010, whole document.

Heinrich, Claus et al.: “Computer system for providing aggregated KPI values”, Pat. No.: EP 2 487 869 A1, Aug. 31, 2010, whole document.

Hermann, Alexander et al: “In-memory processing for a data warehouse”, U.S. Pat. No. 8,412,690B2, 2013, whole document.

Hill, David Gordon: “Method and systems for data aggregation and reporting”, Pat. No.: US, 2011/0227754 A1, Sep. 22, 2011, whole document.

Luhn, Gerhard at al.: “Control system for photolithographic processes”, Pat. No.: US, 2002/0012861 A1, Jan. 31, 2002, whole document.

Netz, Amir et al.: “Centralized KPI framework systems and methods”, U.S. Pat. No. 7,716,253 B2, May 11, 2010, whole document.

Orumchian, Kim et al. : “Operating plan data aggregation system with real-time updates”, U.S. Pat. No. 7,558,784 B2, Jul. 7, 2009, whole document.

Sellers, R. Drew et al.: “Integrated Manufacturing System”, U.S. Pat. No. 5,311,438, May 10, 1994, whole document

Solimano, Marco et al.: “Method for evaluating key production indicators (KPI) in a manufacturing execution system (MES)”, Pat. No.: US, 2010/0249978 A1, Sep. 30, 2010, whole document.

Susumago, Mitsutoshi: “Plant analysis system”, Pat. No.: US, 20110166912 A1, Jul. 7, 2011, whole document.

Thier, Adam at al.: “Real-time aggregation of data within an enterprise planning environment”, U.S. Pat. No. 6,768,995 B2, Jul. 27, 2004, whole document.

### Other publications

Abe, Mari; Jeng, Jun-Jang; Li, Yinggang : “A Tool Framework for KPI Application Development” IEEE International Conference on e-Business Engineering, 2007 IEEE, DOI 10.1109/ICEBE.2007.88

An Oracle White Paper: “Best Practices for Real-time Data Warehousing” August, 2012 http://www.oracle.com/technetworldmiddleware/data-integrator/overview/best-practices-for-realtime-data-wa-132882.pdf; retrieved May 10, 2013

Atkinson, Colin; Gutheil, Matthias; Kiko, Kilian: “On the Relationship of Ontologies and Models” Lecture Notes in Informatics (LNI)—Proceedings; Series of the Gesellschaft für Informatik (GI); Volume P-96; ISBN 978-3-88579-190-4; ISSN 1617-5468; Bonn, 2006; Online: http://subs.emis.de/LNI/Proceedings/Proceedings96/GI-Proceedings-96-3.pdf; retrieved May 3, 2013

Campani, Carlos A. P.; Menezes, Paulo Blauth: “On the Application of Kolmogorov Complexity to the Characterization and Evaluation of Computational Models and Complex Systems.” CISST, 2004: 63-68

Castellanos, Malú: Dayal, Umeshwar; Miller, Renée J. (Eds.): “Enabling Real-Time Business Intelligence” Third International Workshop, BIRTE, 2009, Held at the 35th International Conference on Very Large Databases, VLDB, 2009, Lyon, France, Aug. 24, 2009, Revised Selected Papers. Lecture Notes in Business Information Processing 41 Springer, 2010, ISBN 978-3-642-14558-2

Chan, Tony F; Golub, Gene H.; LeVeque, Randall J.: “Algorithms for computing the sample variance: analysis and recommendations” 1983 Technical Report #222 http://www.cs.yale.edu/publications/techreports/tr222.pdf; retrieved Oct. 19, 2013

Chan, Tony F; Golub, Gene H.; LeVeque, Randall J.: “Updating Formulae and a Pairwise Algorithm for Computing Sample Variances.” 1979 Technical Report STAN-CS-79-773, Department of Computer Science, Stanford University ftp://reports.stanford.edu/pub/cstr/reports/cs/tr/79/773/CS-TR-79-773.pdf; retrieved Oct. 19, 2013

CISCO White Paper: “BI and ETL Process Management Pain Points” http://www.cisco.com/en/US/prod/collateral/netmgtsw/ps6505/ps 11036/ps 11092/whitepap er c11-633329.pdf; retrieved May 28, 2013

Chiou, Andy S.; Sieg, John C.: “Optimization for queries with holistic functions” Database Systems for Advanced Applications, 2001. Proceedings. Seventh International Conference 21-21 April, 2001 Hong Kong, China pp. 327-334 ISBN:0-7695-0996-7

Churchland, P. S.; Sejnowski, T. J.: “The Computational Brain;” MIT Press: Cambridge, Mass., USA, 1992

Devlin, Barry: “The Integration Dilemma” Inside Analysis is the new media arm of The Bloor Group. http://insideanalysis.com; document online retrieved: http://insideanalysis.com/2013/05/the-integration-dilemma/; retrieved Jul. 13, 2013

Davenport, Thomas: “Process Innovation: Reengineering work through information technology. “Harvard Business School Press, Boston (1993). ISBN:0-87584-366-2

Faloutsos, Christos; Megalooikonomou, Vasileios: “On data mining, compression, and Kolmogorov complexity” Data Mining and Knowledge Discovery August, 2007, Volume 15, Issue 1, pp 3-20, http://citeseerx.ist.psu.edulviewdoc/download?doi=10.1.1.69.4730&rep=repl &type=pdf; retrieved Nov. 19, 2013

Gabriel, T. J. “Measuring the manufacturing complexity created by system design” http://www.sedsi.org/2008_Conference/proc/proc/p071010027.pdf; retrieved Nov. 19, 2013

Gal-Ezer, Judith; Zur, Ela: “The efficiency of algorithms: misconceptions” (2004) Computers and Education (Elsevier) 42 (3): 215-226).

Hamlin, C., and Thornhill, N. F.: “Integration of control, manufacturing and enterprise systems, Control”, 2008 IChemE Industry Session, Manchester, Sep. 3, 2008

Hansen, Mark H.; Yu, Bin: “Model Selection and the Principle of Minimum Description Length” Journal of the American Statistical Association Vol. 96, No. 454 (June, 2001), pp. 746-774 Published by: American Statistical Association

http://cs.brown.edu/courses/archive/2006-2007/cs195-5/extras/hansen98model.pdf; retrieved Nov., 20, 2013

Harding, J. A.; Shabaz, M.; Srinivas, S.; Kusiak, A.: “Data Mining in Manufacturing: A Review” Journal of Manufacturing Science and Engineering; November, 2006, Vol. 128/pp. 969-976

Haugland, J.: “Mind Design II: Philosophy, Psychology, and Artificial Intelligence: Philosophy, Psychology, Artificial Intelligence” MIT Press: Cambridge, Mass., USA, 1997

Ho, Ching-Tien; Agrawal, Rakesh; Megiddo, Nimrod; Srikant, Ramakrishnan: “Range Queries in OLAP Data Cubes” Proceeding SIGMOD '97 Proceedings of the, 1997 ACM SIGMOD international conference on Management of data Pages 73-88 ACM New York, N.Y., USA ©1997 ISBN:0-89791-911-4 http://www.almaden.ibm.com/cs/projects/iis/hdb/Publications/papers/sigmod97 rsum.pdf; retrieved Sep. 9, 2013

Hopp, Wallace J.; Spearman, Mark L.: “Factory Physics—Foundations of Manufacturing Management.” Boston: Irwin McGraw-Hill, 2001

Jarke, Matthias; Lenzerini, Maurizio, Vassiliou, Yannis; Vassiliadis Panos: “Fundamentals of Data Warehouses” Second Edition Springer-Verlag Berlin Heidelberg, 2000, 2003 ISBN 3-540-42089-4

Jorg, Thomas; Dessloch, Stefan: “Near Real-Time Data Warehousing Using State-of-the-Art ETL Tools.” BIRTE, 2009: 100-117

Kahan, William: “Further remarks on reducing truncation errors” Communications of the ACM, Volume 8 Issue 1, January 1965 pag. 40 doi:10.1145/363707.363723

Kelly, Rainer, R.: “Introduction to Information Systems: Enabling and Transforming Business” John Wiley & Sons Jan. 11, 2012 ISBN: 978-1118063347

Ladyman, James; Lambert, James; Wiesner, Karoline : “What is a complex system?” European Journal for Philosophy of Science January, 2013, Volume 3, Issue 1, pp 33-67 http://www.maths.bristol.ac.uk/˜enxkw/Publicationsjiles/Ladyman Complex 2011.pdf; retrieved Nov., 20, 2013

Lehner, Wolfgang; Piller, Gunther (Eds.): “Innovative Unternehmensanwendungen mit In-Memory Data Management.” IMDM, 2011, 2. December, 2011, Mainz, ISBN 978-3-88579-287-1

Lewis, J. P. “Large Limits to Software Estimation” ACM Software Engineering Notes Vol. 26, No. 4 July, 2001 p. 54-59 http://scribblethink.org/Work/kcsest.pdf ;retrieved Nov., 20, 2013

Lloyd, J.: “Identifying Key Components of Business Intelligence Systems and Their Role in Managerial Decision making.”, 2011 University of Oregon, Applied Information Management, 2011 Research Project Document

Los, Rafal: “Magic Numbers—5 KPIs for Measuring SSA Program Success v1.3.2” http://de.slideshare.net/RafalLos/magic-numbers-5-kpis-for-measuring-ssa-program-success-v132 Mar. 25, 2011;retrieved Nov. 5, 2013

Luhn G.: “The Causal-Compositional Concept of Information—Part II: Information through Fairness: How Does the Relationship between Information, Fairness and Language Evolve, Stimulate the Development of (New) Computing Devices and Help to Move towards the Information Society.” Information., 2012; 3(3): 504-545

Luhn, G.: “Towards an ontology of information and succeeding fundamentals in computer science.” TripleC, 2011, 9, 444-453; Online: http://www.triple-c.at/index.php/tripleClarticle/view/297; retrieved Aug.19, 2013

Manin, Yu. I.: “Georg Cantor and his heritage” arXiv:math/0209244v1 [math.AG] 19 Sep., 2002; online: http://arxiv.org/pdf/math/0209244.pdf ; retrieved Sep. 2, 2013

Moon, Bongki; Vega Lopez, Inés Fernando; Immanuel, Vijaykumar: “Efficient Algorithms for Large-Scale Temporal Aggregation” Knowledge and Data Engineering, IEEE Transactions on (Volume: 15, Issue: 3) May-June, 2003

Müller-Merbach, Heiner: “Forschungsverbund Medientechnik Siidwest Phase II”, 2001 http://www.inue.uni-stuttgart.de/FMS/abschluss/berichte/fms13-08.pdf; retrieved Aug. 19, 2013

Nelson, Stephen L.: “Excel, 2007 Data Analysis for dummies” Pub.: Wiley Publishing Inc., 2007

Ottens, Manfred: “Grundlagen der Systemtheorie” Skript zur Lehrveranstaltung, 2008 http://prof.beuth-hochschule.de/fileadmin/user/ottens/Skripte/Grundlagen_der_Systemtheorie.pdf ; retrieved Aug. 19, 2013

Parmenter, D.: “Key Performance Indicators.” John Wiley & Sons, 2007

Peng, Wei; Sun Tong; Rose, Philip; Li, Tao: “Computation and Applications of Industrial Leading Indicators to Business Process Improvement” INTERNATIONAL JOURNAL OF INTELLIGENT CONTROL AND SYSTEMS VOL. 13, NO. 3, SEPTEMBER, 2008, 196-207

Pinedo, Michael: Scheduling: “Theory, Algorithms and Systems” Springer, Berlin, 2008

Ponniah, Paulraj: “Data Warehousing Fundamentals: A Comprehensive Guide for It Professionals.” Published May 24, 2010 by John Wiley & Sons, ISBN 0470462078

Santos, Ricardo, Jorge; Bernardino, Jorge: “Real-time data warehouse loading methodology” Proceedings of the, 2008 international symposium on Database engineering applications, 2008, S. 49-58.

Sematech Technology Transfer 93061697J-ENG, Computer Integrated Manufacturing (CIM) Framework Specification Version 2.0; SEMATECH Technology Transfer, 2706 Montopolis Drive, Austin, Tex. 78741, 1998

Selmeci, A.; Orosz, I; Gyorok, Gy; Orosz, T: “Key Performance Indicators used in ERP performance measurement applications” SISY, 2012, 2012 IEEE 10th Jubilee International Symposium on Intelligent Systems and Informatics, Sep., 20-22, 2012, Subotica, Serbia

Simon, H.: “The Architecture of Complexity” Proceedings of the American Philosophical Society. Vol. 106(6) 1962

Sommerville, Ian: “Software engineering” Pearson, Inc., Publishing as Addison-Wesley, 9th revised edition. (19. Feb., 2010) ISBN 978-0137053469

Stefan, Veronica; Duica, Mircea; Coman, Marius; Radu Valentin: “Enterprise Performance Management with Business Intelligence Solution” ISBN: 978-960-474-161-8 http://www.wseas.usle-library/conferences/2010/Cambridge/ICBA/ICBA-32.pdf; retrieved Aug. 19, 2013

Stonebraker, Michael; Bear, Chuck; Cetintemel, Ugur; Cherniack, Mitch; Ge, Tingjian; Hachem Nabil; Harizopoulos, Stavros; Lifter, John; Rogers, Jennie; and Zdonik, Stan: “One size fits all? Part 2: Benchmarking Results.” Third Biennal Conference on Innovative Data Systems Research (CIDR, 2007), pages 173-184, 2007.

Stonebraker, Michael and Cetintemel, Ugur: “One Size Fits All: An Idea Whose Time has Come and Gone.” Proceedings of the International Conference on Data Engineering (ICDE), 2005

Thiele, Maik; Lehner, Wolfgang: “Evaluation of Load Scheduling Strategies for Real-Time Data Warehouse Environments.” Proceedings of the 3^{rd} International Workshop on Business Intelligence for the Real-Time Enterprise, BIRTE, 2009, Lyon, France, August 24, 2009, S. 1-14.

Thiele, Maik; Lehner, Wolfgang; Habich, Dirk: “Data-Warehousing 3.0—Die Rolle von Data-Warehouse-Systemen auf Basis von In-Memory Technologie.” IMDM, 2011: 57-68

Vollmer, G.: “Das Alte Gehirn und die Neuen Probleme.” In G. Vollmer (Ed.), Was können wir wissen?” Band 1. Die Natur der Erkenntnis. Stuttgart: Hirzel, 1985

Wand, Y.; Weber, R.: “Toward a theory of the deep structure of information systems.” Information Systems Journal. Volume 5, Issue 3, pages, 2013-223, July, 1995; Online: http://purao.ist.psu.edu/532/Readings/WandWeber1990.pdf; retrieved May. 3, 2013

Weber, Jürgen: “Einführung in das Controlling.” 8., aktual. und erw. Auflage. Stuttgart: Schäffer-Poeschel, 1999, pp. 217 (Introduction into Controlling; German DE)

Yang, Jun; Widom, Jennifer: “Incremental computation and maintenance of temporal aggregates.” VLDB Journal, 12:262-283, 2003

Zhang, Jie “Spatio-Temporal Aggregation over Streaming Geosptial Image Data” June, 2007 doctoral dissertation University of California http://www.cs.ucdavis.edu/research/tech-reports/2007/CSE-2007-29.pdf; retrieved Aug.29, 2013

1. A method for operating a data processing system, comprising data structures, transformation and aggregation processes and corresponding multidimensional databases, characterized in that the transformation and aggregation is based on homomorphic processing, which is grounded on a linear decompositional base system model, wherein said linear decompositional base system model preserves the linearity of the data structures.

2. The method according to claim 1, wherein said method enables Real-Time information processing.

3. The method according to any one of claim 1 or 2, comprising a base data structure and a corresponding layering, comprising a basic atomic dataset (BADS) layer, fundamental atomic datasets (FADS) layer, Real-Time aggregated dataset (RTADS) layer and a Real-Time OLAP (RTOLAP) layer, wherein said layers are constituted by one or more linear spaces.

4. The method according to claim 3, wherein Information Functions are providing calculated information, based on aggregations and/or compositions of said data sets on said layers.

5. The method according to claim 4, wherein Information Functions are providing calculated information, based on multiple aggregations and/or compositions of said datasets on said layers.

6. The method according to claim 4 or 5, wherein said Information Functions have a three-fold structure, consisting of
(i) the name,
(ii) the definition, and
(iii) the formula and/or algorithm to compute the Information Function.

7. The method according to any one of claims of claims 1 to 6, comprising Real-Time transformation and aggregation processes based on data components, such as BADSs, FADSs, RTADSs, RTOLAPs, and corresponding Information Functions, wherein the raw data, which are loaded from the data sources, are transformed, aggregated and further processed in at least one information system.

8. The method according to claim 7, wherein said at least one information system is deployed on data management systems, such as relational databases or other database management systems, including non-relational databases.

9. The method according to claim 7 or 8, wherein said Real-Time aggregation processes are based on continuous component-wise transformations and aggregations within the linear space.

10. The method according to any one of claims 7 to 9, wherein said Real-Time aggregation processes are enabled as soon as the corresponding raw data enters the at least one information system.

11. The method according to any one of claims 4 to 10, wherein the representations of the Information Functions, including e.g. statistical functions, are adapted and/or transformed such that linearity is achieved.

12. The method according to claim 11, wherein the adaption and/or transformation of the Information Functions includes rules and mechanisms in terms of mathematical functions, wherein the adaption and/or transformation is enabled by the structure-immanent linearity of any Information Function.

13. The method according to any of claims 4 to 12, wherein the Information Functions are materialized as performance indicators.

14. The method according to any one of claims 3 to 13, comprising homomorphic maps from the fundamental atomic dataset layer (FADS layer) into the Real-Time aggregated dataset layer (RTADS-layer), wherein the linearity of the underlying layers is preserved.

15. The method according to any one of claims 7 to 14, comprising a continuous transformation and aggregation strategy.

16. The method according to claim 15, wherein all operations and/or data manipulations are performed using said continuous transformation and aggregation strategy.

17. The method according to claim 15 or 16, wherein the amount of memory needed for computation is minimum.

18. The method according to claim 15 or 16, wherein the amount of resources required for storage and/or retrieval operations (e.g. hard disk, SDDs, etc.) and the associated I/O requirements are minimum.

19. The method according to claim 15 or 16, wherein the CPU usage needed for computation is minimal, including the usage of multiple CPUs and CPU cores.

20. The method according to claim 19, wherein all operations and/or data manipulations map to desired computer instruction sets and/or operations and/or to other infrastructure components (e.g. databases, middleware, computer hardware and the like).

21. The method according to claim 20, wherein the resource usages are further minimized, wherein calculated values of sparse data or values, which are only needed sporadically, are calculated on demand.

22. The method according to claim 21, further comprising an interface to an OLAP server, wherein a Real-Time OLAP system, a Real-Time Data Mart and/or the like is realized, wherein the OLAP system(s) and Data Mart(s) are freed from performing aggregation operations.

23. The method of claim 22, providing an interface to OLAP systems (e.g. MOLAP, ROLAP, HOLAP) and further client systems, which may connect to said OLAP systems to provide Real-Time OLAP analysis functionality as requested by the user through the client system.

24. The method of claim 23, comprising a higher degree of flexibility than classical ROLAP or MOLAP technology, due to the possibility of flexible data grouping, wherein ROLAP structures are bound to a hierarchical tree model.

25. The method of claim 22, providing an interface to Data Marts and client systems, which may connect to said Data Marts to provide Real-Time analysis functionality as requested by the user through the client system.

26. The method of claim 9, comprising an interface to a client, which may connect to the base informational structure of the system (BADSs, FADSs, RTADSs, RTOLAPs), and which enables the client to process ad-hoc analysis in Real Time, based on the structurally immanent Real-Time capability and fast feedback of the system, wherein said ad-hoc analysis consists of the capability to define and execute unplanned queries against the data store (such as SQL queries and the like), including the capability to create newly composed structures out of the existing structures and apply further transformations and/or aggregations via corresponding Information Functions such as performance indicators; and including the capability to store and manage the newly derived information.

27. The method of claim 26, comprising a base informational structure to support and enable Real Time knowledge discovery in databases (KDD), based on the structurally immanent Real-Time capability and fast feedback of the system, and including a data catalog functionality in order to search, prepare and select all required data types for further KDD analysis, wherein said KDD consists of the capability to define and execute data mining functions against the data store (e.g. using data mining tools such as RapidMiner, WEKA, and the like), and including the capability for the desired preparation process, as well as the further interpretation of the results, via corresponding Information Functions, such as performance indicators.

28. A computer program product adapted to perform the method according to any one of claims 1 to 27.

29. The computer program product according to claim 28, comprising software code to perform the method according to any one of claims 1 to 27.

30. The computer program product according to claim 28 or 29 comprising software code to perform the method according to any one of claims 1 to 27, when executed on a data processing apparatus.

31. A computer-readable storage medium comprising a computer program product adapted to perform the method according to any one of claims 1 to 27.

32. The computer-readable storage medium according to claim 31, which is a non-transitory computer-readable storage medium.

33. The computer-readable storage medium according to claim 31 or 32, coupled to one or more processors and having instructions stored thereon, which—when executed by the one or more processors—cause the one or more processors to perform operations for providing at least one transformation and aggregation process and corresponding grouped, multidimensional datastore process.

34. The computer-readable storage medium according to claim 33, wherein the said transformation and aggregation is based on homomorphic processing, which is grounded on a linear decompositional base system model and thereby preserves the linearity of the underlying data structures.

35. The computer-readable storage medium according to claim 34, which enables Real-Time information processing.

36. A data processing system comprising means for carrying out the method according to any of claims 1 to 27.

37. The data processing system according to claim 36, comprising a computing device and a computer-readable storage device coupled to the computing device and having instructions stored thereon, which—when executed by the one or more processors—cause the one or more processors to perform operations for providing at least one transformation and aggregation process and corresponding grouped, multidimensional datastore process.

38. The data processing system according to claim 37, wherein said transformation and aggregation is based on homomorphic processing, which is grounded on a linear decompositional base system model and thereby preserves the linearity of the underlying data structures.

39. The data processing system according to claim 38, which enables Real-Time information processing.

40. The data processing system according to any one of claims 36 to 39, comprising an aggregation server and a transformation and aggregation engine, wherein the transformation and aggregation engine supports high-performance aggregation (such as data roll-up) processes to maximize query performance of large data volumes and/or to reduce the time of ad-hoc interrogations.

41. The data processing system according to any one of claims 36 to 39, comprising scalable aggregation server and a transformation and aggregation engine, wherein the transformation and aggregation engine distributes the aggregation process uniformly over the entire data loading period.

42. The data processing system according to claim 41, which enables an optimized usage of all server components (e.g. CPUs, Memory, Disks, etc.).

43. The data processing system according to any one of claims 36 to 39, comprising a scalable aggregation server for use in OLAP operations, wherein the scalability of the aggregation server enables the speed of the aggregation processes carried out therewithin is substantially increased by distributing the computationally intensive tasks associated with the data aggregation among multiple processors.

44. The data processing system according to any one of claims 36 to 39, comprising a scalable aggregation server with a uniform load balancing among processors for high efficiency and best performance, wherein said scalability is achieved by adding processors.

45. The data processing system according to any one of claims 41 to 44, wherein said scalable aggregation server supports OLAP systems (including MOLAP, ROLAP) with improved aggregation capabilities and similar system architecture.

46. The data processing system according to any one of claims 41 to 44, wherein said scalable aggregation server is used as a complementary aggregation plug-in to existing OLAP (including MOLAP, ROLAP) and similar system architectures.

47. The data processing system according to any one of claims 41 to 46, wherein said scalable aggregation server uses the continuous Real-Time aggregation method according to any one of claims 2 to 27.

48. The data processing system according to any one of claims 41 to 47, comprising an integrated MDDB and aggregation engine and which carries out full pre-aggregation and/or on-demand aggregation processes within the MDDB on the RTADS layer.

49. The data processing system according to any one of claims 41 to 48, comprising a scalable aggregation engine, which replaces the batch-type aggregations by uniformly distributed continuous Real-Time aggregation.

50. The data processing system according to any one of claims 36 to 49 for transforming large-scale aggregation into continuous Real-Time aggregation, wherein a significant increase in the overall system performance (e.g. decreased aggregation and/or computation time) is achieved and/or overall energy consumption is reduced and/or new functionalities at the same time are enabled.
